(19) United States
(12) Patent Application Publication
(10) Pub. No.: US 2010/0184614 A1
(43) Pub. Date: Jul. 22, 2010

(54) MICROARRAY SYSTEMS AND METHODS FOR IDENTIFYING DNA-BINDING PROTEINS

(76) Inventors: Zheng Ye, Portland, OR (US); William Mathers, Lake Oswego, OR (US)

Correspondence Address: KLARQUIST SPARKMAN, LLP, 121 SW SALMON STREET, SUITE 1600, PORTLAND, OR, 97204, US

(21) Appl. No.: 12/601,190

(22) PCT Filed: May 22, 2008
(86) PCT No.: PCT/US2008/064561

§ 371 Date: Nov. 20, 2009

Related U.S. Application Data
(60) Provisional application No. 60/939,826, filed on May 23, 2007.

(51) Int. Cl. C40B 30/04; C40B 40/06

(52) U.S. Cl. 506/9; 506/16

(57) ABSTRACT

Disclosed are methods for identifying double-stranded nucleic acid protein binding sites and double-stranded nucleic acid binding proteins. The method can include contacting a sample with at least one partially double-stranded nucleic acid probe under conditions that permit binding of double-stranded binding proteins and partially double-stranded nucleic acid probes. In particular examples, the partially double-stranded nucleic acid probes include a first portion of single-stranded nucleic acid at least about 15 nucleotides in length with a unique index sequence and a second portion of double-stranded nucleic acid greater than about 8 base pairs in length with a potential binding site for a double-stranded nucleic acid binding protein. The protein bound partially double-stranded nucleic acid probe can then be isolated and detected by hybridization to a nucleic acid indexing probe. Also disclosed are kits and devices for carrying out the methods.

### CROSS REFERENCE TO RELATED APPLICATION

This application claims the benefit of U.S. Provisional Application 60/939,826, filed May 23, 2007, which is incorporated by reference herein in its entirety.

### FIELD

This disclosure relates to double-stranded nucleic acid binding proteins and methods of identifying such proteins as well as methods of identifying the nucleic acid sequences to which double-stranded nucleic acid binding proteins bind.

### BACKGROUND

Regulation of gene expression is the cellular control of the amount and timing of appearance of the functional product of a gene. Gene regulation provides cells control over structure and function, and is the basis for cellular differentiation, morphogenesis and the versatility and adaptability of any organism. Living organisms use nucleic acids (such as DNA and RNA) to encode the genes that make up the genome for that organism. Although a functional gene product can be RNA or a protein, the majority of the known mechanisms regulate the expression of protein-coding genes. Any step of gene expression can be modulated, from the DNA-RNA transcription step to post-translational modification of a protein. Gene expression, for example in a eukaryotic organism, can be modulated by the binding of double-stranded DNA proteins, such as transcription factors, to the organism's genomic DNA.

Transcription factors, a subset of double-stranded DNA binding proteins, modulate gene expression, replication, and recombination and are involved in many biological processes, such as cell growth and differentiation. Alterations in transcription factor function are associated with many human diseases. A challenge is to understand the varied and complex mechanisms governing the regulation of gene expression, for example the identification of binding sites in DNA for the factors involved in regulation of expression of specific genes. The systems that regulate gene expression respond to a wide variety of developmental and environmental stimuli, thus allowing each cell type to express a unique and characteristic subset of its genes, and to adjust the dosage of particular gene products as needed. The importance of dosage control is underscored by the fact that targeted disruption of key regulatory molecules in mice often results in a drastic phenotype, just as inherited or acquired defects in the function of genetic regulatory mechanisms contribute broadly to human disease.

Inhibition and stimulation of transcription factor binding to DNA is of interest in the identification of potential targets for new drugs. Such identification can be assisted by high throughput discovery of the transcription factors involved in human diseases, and the measurement of their activities in a variety of disease or compound-treated samples.

However, the analysis of non-coding regions in eukaryotic genomes to identify regulatory elements is difficult. For example, the binding of multiple interacting transcription factors often plays a role in the regulation of a single gene.

In addition, a single transcription factor may recognize and bind to variable DNA sequences. Furthermore, the regulatory elements for a specific gene may be located quite far from the corresponding coding region, either upstream or downstream or even in the introns of the gene.

There is a need for tools to analyze transcription factors and analogous double-stranded DNA binding proteins. Of particular interest are methods to detect one or more transcription factors in a single sample, for example a cellular or nuclear extract.

### SUMMARY

The present disclosure provides methods for identifying double-stranded nucleic acid protein binding sites and double-stranded nucleic acid binding proteins bound to such sites. Using unique sets of partially double-stranded nucleic acid probes and cognate indexing probes, the present disclosure provides versatile methods for unraveling the complex machinery of gene expression.

Embodiments of the disclosed methods include methods for identifying double-stranded nucleic acid protein binding sites and double-stranded nucleic acid binding proteins. In particular examples, methods can include contacting a sample with at least one partially double-stranded nucleic acid probe under conditions that permit binding of double-stranded binding proteins in the sample and partially double-stranded nucleic acid probes. The protein-bound partially double-stranded nucleic acid probe is isolated (for example using gel electrophoresis) and detected by hybridization to a nucleic acid indexing probe. In some embodiments, the double-stranded nucleic acid binding protein is identified, for example using an antibody and/or by mass spectrometry techniques or other methods known in the art.

The versatility of the disclosed methods is demonstrated by the fact that the methods can be used for such diverse activities as identifying one or more transcription factor binding sites, screening for compounds that modulate (such as increase or decrease) the activity of double-stranded binding proteins (such as transcription factors) and monitoring and/or diagnosing disease or predisposition to disease.

The partially double-stranded nucleic acid probes disclosed herein can include a first portion of single-stranded nucleic acid at least about 15 nucleotides in length with a unique index sequence complementary to a unique indexing probe and a second portion of double-stranded nucleic acid at least about 8 base pairs in length with a potential binding site for a double-stranded nucleic acid binding protein. Kits for carrying out the subject methods also are disclosed. Such kits can include at least one partially double-stranded nucleic acid probe and a nucleic acid indexing probe with a nucleotide sequence complementary to the unique index sequence present in single-stranded region of the partially double-stranded nucleic acid probe. In addition, indexing arrays for carrying out the disclosed methods also are disclosed.

The foregoing and other objects and features of the disclosure will become more apparent from the following detailed description, which proceeds with reference to the accompanying figures.

### BRIEF DESCRIPTION OF THE DRAWINGS

FIG. 1A is a schematic representation of a partially double-stranded nucleic acid probe and indexing probe pair.

FIG. 1B is a schematic representation an exemplary partially double-stranded nucleic acid probe.

FIG. 1C is a schematic representation an exemplary partially double-stranded nucleic acid probe.

FIG. 1D is a schematic representation an exemplary partially double-stranded nucleic acid probe constructed of a single nucleic acid with a nucleic acid hairpin.

FIG. 2A is a schematic representation of an exemplary procedure for detecting a partially double-stranded nucleic acid probe using an indexing probe.

FIG. 2B is a schematic representation of an exemplary procedure for detecting a partially double-stranded nucleic acid probe with bound double-stranded nucleic acid binding protein using an indexing probe.

FIG. 3A is a schematic representation of an array of indexing probes bound to a solid support.

FIG. 3B is a schematic representation of an array of indexing probes with a partially double-stranded nucleic acid probe bound to its cognate indexing probe.

FIG. 3C is a is a schematic representation of an array of indexing probes with a partially double-stranded nucleic acid probe bound to its cognate indexing probe, wherein the partially double-stranded nucleic acid probe is bound by a double-stranded nucleic acid binding protein.

FIG. 4A is a schematic representation of a set of two partially double-stranded nucleic acid probes differing by a mutation.

FIG. 4B is a schematic representation of partially double-stranded nucleic acid probes with multiple binding sites for double-stranded binding proteins.

FIG. 4C is a schematic representation of a set of two partially double-stranded nucleic acid probes differing by mutations in different binding sites.

FIG. 5 is a schematic representation of a set of partially double-stranded nucleic acid probes sequentially spanning the sequence of a promoter of interest.

FIG. 6 is a digital image of a gel showing the gel shift induced the binding of a partially double-stranded nucleic acid probe by the transcription factor Nfκb.

FIG. 7 is a digital image of a gel showing the gel shift induced the binding of a partially double-stranded nucleic acid probe by the transcription factor ER alpha.

FIG. 8 is a digital image of a gel showing the gel shift induced the binding of a partially double-stranded nucleic acid probe by the transcription factor SP-1.

FIG. 9 is a digital image showing a gel shift analysis in which recombinant Sp1 protein binds to its specific probe YZ9, where the probe is labeled with IR Dye 700.

FIG. 10 is a digital image showing a column gel in which recombinant ER-alpha protein is mixed with its specific probe labeled with IR Dye 700, and in which the sample is loaded on a column gel and run for 30 minutes.

### DETAILED DESCRIPTION

### I. Terms

Unless otherwise noted, technical terms are used according to conventional usage. Definitions of common terms in molecular biology may be found in Benjamin Lewin, Genes VII, published by Oxford University Press, 2000 (ISBN 019879276X); Kendrew et al. (eds.), The Encyclopedia of Molecular Biology, published by Blackwell Publishers, 1994 (ISBN 0632021829); Robert A. Meyers (ed.), Molecular Biology and Biotechnology: a Comprehensive Desk Reference, published by Wiley, John & Sons, Inc., 1995 (ISBN 0471186341); and George P. Rédei, Encyclopedic Dictionary of Genetics, Genomics, and Proteomics, 2nd Edition, 2003 (ISBN: 0-471-26821-6).

The following explanations of terms and methods are provided to better describe the present disclosure and to guide those of ordinary skill in the art in the practice of the present disclosure. The singular forms “a,” “an,” and “the” refer to one or more than one, unless the context clearly dictates otherwise. For example, the term “comprising a probe” includes single or plural probes and is considered equivalent to the phrase “comprising at least one probe.” The term “or” refers to a single element of stated alternative elements or a combination of two or more elements, unless the context clearly indicates otherwise. As used herein, “comprises” means “includes.” Thus, “comprising A or B,” means “including A, B, or A and B,” without excluding additional elements.

Although methods and materials similar or equivalent to those described herein can be used in the practice or testing of the present disclosure, suitable methods and materials are described below. The materials, methods, and examples are illustrative only and not intended to be limiting.

To facilitate review of the various embodiments of this disclosure, the following explanations of specific terms are provided:

Antibody: A polypeptide ligand that includes at least a light chain or heavy chain immunoglobulin variable region and specifically binds an epitope of an antigen. Antibodies can include monoclonal antibodies, polyclonal antibodies, or fragments of antibodies.

The term “specifically binds” refers to, with respect to an antigen, the preferential association of an antibody or other ligand, in whole or part, with a specific polypeptide, such as a specific double-stranded DNA binding protein, for example a transcription factor, such as an activated transcription factor. A specific binding agent binds substantially only to a defined target. It is recognized that a minor degree of non-specific interaction may occur between a molecule, such as a specific binding agent, and a non-target polypeptide. Nevertheless, specific binding can be distinguished as mediated through specific recognition of the antigen. Although selectively reactive antibodies bind antigen, they can do so with low affinity. Specific binding typically results in greater than 2-fold, such as greater than 5-fold, greater than 10-fold, or greater than 100-fold increase in amount of bound antibody or other ligand (per unit time) to a target polypeptide, such as compared to a non-target polypeptide. A variety of immunoassay formats are appropriate for selecting antibodies specifically immunoreactive with a particular protein. For example, solid-phase ELISA immunoassays are routinely used to select monoclonal antibodies specifically immunoreactive with a protein. See Harlow & Lane, Antibodies, A Laboratory Manual, Cold Spring Harbor Publications, New York (1988), for a description of immunoassay formats and conditions that can be used to determine specific immunoreactivity.

Antibodies are composed of a heavy and a light chain, each of which has a variable region, termed the variable heavy (VH) region and the variable light (VL) region. Together, the VH region and the VL region are responsible for binding the antigen recognized by the antibody. This includes intact immunoglobulins and the variants and portions of them well known in the art, such as Fab′ fragments, F(ab)′2 fragments, single chain Fv proteins (“scFv”), and disulfide stabilized Fv proteins (“dsFv”). A scFv protein is a fusion protein in which a light chain variable region of an immunoglobulin and a heavy chain variable region of an immunoglobulin are bound by a linker, while in dsFvs, the chains have been mutated to introduce a disulfide bond to stabilize the association of the chains. The term also includes recombinant forms such as chimeric antibodies (for example, humanized murine antibodies), heteroconjugate antibodies (such as bispecific antibodies). See also, Pierce Catalog and Handbook, 1994-1995 (Pierce Chemical Co., Rockford, Ill.); Kuby, Immunology, 3rd Ed., W.H. Freeman & Co., New York, 1997.

A “monoclonal antibody” is an antibody produced by a single clone of B-lymphocytes or by a cell into which the light and heavy chain genes of a single antibody have been transfected. Monoclonal antibodies are produced by methods known to those of skill in the art, for instance by making hybrid antibody-forming cells from a fusion of myeloma cells with immune spleen cells. These fused cells and their progeny are termed “hybridomas.” Monoclonal antibodies include humanized monoclonal antibodies.

Array: An arrangement of molecules, such as biological macromolecules (for example nucleic acid molecules, such as the indexing probes described herein), in addressable locations on or in a substrate. A nucleic acid array is an arrangement of nucleic acids (such as DNA or RNA, for example indexing probes disclosed herein) in assigned locations on a matrix, such as that found in oligonucleotide arrays. A “microarray” is an array that is miniaturized so as to require or be aided by microscopic examination for evaluation or analysis. Arrays are sometimes called DNA chips or biochips.

The array of molecules (some times referred to as “features”) makes it possible to carry out a very large number of analyses on a sample at one time. In certain example arrays, one or more molecules (such as an oligonucleotide indexing probe) will occur on the array a plurality of times (such as twice), for instance to provide internal controls. The number of addressable locations on the array can vary, for example from at least four, to at least 10, at least 20, at least 30, at least 50, at least 75, at least 100, at least 150, at least 200, at least 300, at least 500, least 550, at least 600, at least 800, at least 1000, at least 10,000, or even more. In particular examples, an array includes nucleic acid molecules, such as oligonucleotide sequences that are at least 15 nucleotides in length, such as about 15-60, 15-100, 15-150, or event greater than 150 nucleotides in length. In particular examples, an array includes oligonucleotide probes (for example indexing probes), which can be used to detect a partially double-stranded nucleic acid probe, such as the partially double-stranded nucleic acid probes disclosed herein.

Within an array, each arrayed sample is addressable, in that its location can be reliably and consistently determined within at least two dimensions of the array.

The feature application location on an array can assume different shapes. For example, the array can be regular (such as arranged in uniform rows and columns) or irregular. Thus, in ordered arrays, the location of each sample is assigned to the sample at the time when it is applied to the array, and a key can be provided in order to correlate each location with the appropriate target or feature position. Often, ordered arrays are arranged in a symmetrical grid pattern, but samples could be arranged in other patterns (such as in radially distributed lines, spiral lines, or ordered clusters). Addressable arrays usually are computer readable, in that a computer can be programmed to correlate a particular address on the array with information about the sample at that position (such as hybridization or binding data, including for instance signal intensity). In some examples of computer readable formats, the individual features in the array are arranged regularly, for instance in a Cartesian grid pattern, which can be correlated to address information by a computer.

Binding or stable binding: An association between two substances or molecules, such as the hybridization of one nucleic acid molecule to another or itself (for example an indexing probe and a partially double-stranded nucleic acid probe), the association of an antibody with a peptide, or the association of a protein with another protein (for example the binding of a transcription factor to a cofactor) or nucleic acid molecule (for example the binding of a transcription factor to a partially double-stranded nucleic acid probe). An oligonucleotide probe, such as an indexing probe, binds or stably binds to a target nucleic acid molecule, such as a partially double-stranded nucleic acid probe, if a sufficient amount of the oligonucleotide probe forms base pairs or is hybridized to its target nucleic acid molecule, to permit detection of that binding.

Binding can be detected by any procedure known to one skilled in the art, such as by physical or functional properties of the target:oligonucleotide complex.

For example, binding can be detected functionally by determining whether binding has an observable effect upon a biosynthetic process such as expression of a gene, DNA replication, transcription, translation, and the like.

Physical methods of detecting the binding of complementary strands of nucleic acid molecules, include but are not limited to, such methods as DNase I or chemical footprinting, gel shift and affinity cleavage assays, Northern blotting, dot blotting and light absorption detection procedures. For example, can involve detecting a signal, such as a detectable label, present on one or both nucleic acid molecules (or antibody or protein as appropriate).

The binding between an oligomer and its target nucleic acid is frequently characterized by the temperature (Tₘ) at which 50% of the oligomer is melted from its target. A higher (Tₘ) means a stronger or more stable complex relative to a complex with a lower (Tₘ).

Binding site: A region on a protein, DNA, or RNA to which other molecules stably bind. In one example, a binding site is the site on a DNA molecule, such as a partially double-stranded nucleic acid probe, that a double-stranded DNA binding protein, such as a transcription factor, binds (referred to as a transcription factor binding site).

Cancer: A malignant disease characterized by the abnormal growth and differentiation of cells. “Metastatic disease” refers to cancer cells that have left the original tumor site and migrate to other parts of the body for example via the bloodstream or lymph system.

Examples of hematological tumors include leukemias, including acute leukemias (such as acute lymphocytic leukemia, acute myelocytic leukemia, acute myelogenous leukemia and myeloblastic, promyelocytic, myelomonocytic, monocytic and erythroleukemia), chronic leukemias (such as chronic myelocytic (granulocytic) leukemia, chronic myelogenous leukemia, and chronic lymphocytic leukemia), polycythemia vera, lymphoma, Hodgkin's disease, non-Hodgkin's lymphoma (indolent and high grade forms), multiple myeloma, Waldenstrom's macroglobulinemia, heavy chain disease, myelodysplastic syndrome, hairy cell leukemia, and myelodysplasia.

Examples of solid tumors, such as sarcomas and carcinomas, include fibrosarcoma, myxosarcoma, liposarcoma, chondrosarcoma, osteogenic sarcoma, and other sarcomas, synovioma, mesothelioma, Ewing's tumor, leiomyo sarcoma, rhabdomyosarcoma, colon carcinoma, lymphoid malignancy, pancreatic cancer, breast cancer (such as adenocarcinoma), lung cancers, gynecological cancers (such as, cancers of the uterus (e.g., endometrial carcinoma), cervix (e.g., cervical carcinoma, pre-tumor cervical dysplasia), ovaries (e.g., ovarian carcinoma, serous cystadenocarcinoma, mucinous cystadenocarcinoma, endometrioid tumors, celioblastoma, clear cell carcinoma, unclassified carcinoma, granulosa-thecal cell tumors, Sertoli-Leydig cell tumors, dysgerminoma, malignant teratoma), vulva (e.g., squamous cell carcinoma, intraepithelial carcinoma, adenocarcinoma, fibrosarcoma, melanoma), vagina (e.g., clear cell carcinoma, squamous cell carcinoma, botryoid sarcoma), embryonal rhabdomyosarcoma, and fallopian tubes (e.g., carcinoma)), prostate cancer, hepatocellular carcinoma, squamous cell carcinoma, basal cell carcinoma, adenocarcinoma, sweat gland carcinoma, medullary thyroid carcinoma, papillary thyroid carcinoma, pheochromocytomas sebaceous gland carcinoma, papillary carcinoma, papillary adenocarcinomas, medullary carcinoma, bronchogenic carcinoma, renal cell carcinoma, hepatoma, bile duct carcinoma, choriocarcinoma, Wilms' tumor, cervical cancer, testicular tumor, seminoma, bladder carcinoma, and CNS tumors (such as a glioma, astrocytoma, medulloblastoma, craniopharyogioma, ependymoma, pinealoma, hemangioblastoma, acoustic neuroma, oligodendroglioma, menangioma, melanoma, neuroblastoma and retinoblastoma), and skin cancer (such as melanoma and non-melonoma).

Change: To become different in some way, for example to be altered, such as increased or decreased. A detectable change is one that can be detected, such as a change in the intensity, frequency, or presence of an electromagnetic signal, such as fluorescence. In some examples, the detectable change is a reduction in fluorescence intensity. In some examples, the detectable change is an increase in fluorescence intensity.

Chemotherapeutic agents: Any chemical agent with therapeutic usefulness in the treatment of diseases characterized by abnormal cell growth. Such diseases include tumors, neoplasms, and cancer as well as diseases characterized by hyperplastic growth such as psoriasis. In one embodiment, a chemotherapeutic agent is a radioactive compound. Chemotherapeutic agents are described for example in Slapak and Kufe, Principles of Cancer Therapy, Chapter 86 in Harrison's Principles of Internal Medicine, 14th edition; Perry et al., Chemotherapy, Ch. 17 in Abeloff, Clinical Oncology 2nd ed., 2000 Churchill Livingstone, Inc; Baltzer and Berkery. (eds): Oncology Pocket Guide to Chemotherapy, 2nd ed. St. Louis, Mosby-Year Book, 1995; Fischer Knobf, and Durivage (eds): The Cancer Chemotherapy Handbook, 4th ed. St. Louis, Mosby-Year Book, 1993. Combination chemotherapy is the administration of more than one agent to treat cancer. Chromatography: The process of separating a mixture. It involves passing a mixture through a stationary phase, which separates molecules of interest from other molecules in the mixture and allows one or more molecules of interest to be isolated. Examples of methods of chromatographic separation include capillary-action chromatography, such as paper chromatography, thin layer chromatography (TLC), column chromatography, fast protein liquid chromatography (FPLC), nano-reversed phase liquid chromatography, ion exchange chromatography, gel chromatography, such as gel filtration chromatography, size exclusion chromatography, affinity chromatography, high performance liquid chromatography (HPLC), and reverse phase high performance liquid chromatography (RP-HPLC) among others.

Complementarity and percentage complementarity: A double-stranded DNA or RNA strand includes of two complementary strands of base pairs (or one strand with a hairpin). Complementary binding occurs when the base of one nucleic acid molecule forms a hydrogen bond to the base of another nucleic acid molecule. Normally, the base adenine (A) is complementary to thymidine (T) and uracil (U), while cytosine (C) is complementary to guanine (G). For example, the sequence 5′-ATCG-3′ of one ssDNA molecule can bond to 3′-TAGC-5′ of another ssDNA to form a dsDNA. In this example, the sequence 5′-ATCG-3′ is the reverse complement of 3′-TAGC-5′.

Nucleic acid molecules can be complementary to each other even without complete hydrogen-bonding of all bases of each molecule. For example, hybridization with a complementary nucleic acid sequence can occur under conditions of differing stringency in which a complement will bind at some but not all nucleotide positions.

Molecules with complementary nucleic acids form a stable duplex or triplex when the strands bind, (hybridize), to each other by forming Watson-Crick, Hoogsteen or reverse Hoogsteen base pairs. Stable binding occurs when an oligonucleotide molecule remains detectably bound to a target nucleic acid sequence under the required conditions.

Complementarity is the degree to which bases in one nucleic acid strand base pair with the bases in a second nucleic acid strand. Complementarity is conveniently described by percentage, that is, the proportion of nucleotides that form base pairs between two strands or within a specific region or domain of two strands. For example, if 10 nucleotides of a 15-nucleotide oligonucleotide form base pairs with a targeted region of a DNA molecule, that oligonucleotide is said to have 66.67% complementarity to the region of DNA targeted.

In the present disclosure, “sufficient complementarity” means that a sufficient number of base pairs exist between an oligonucleotide molecule and a target nucleic acid sequence (such between an indexing probe and a partially double-stranded nucleic acid probe) to achieve detectable binding. When expressed or measured by percentage of base pairs formed, the percentage complementarity that fulfills this goal can range from as little as about 50% complementarity to full (100%) complementary. In general, sufficient complementarity is at least about 50%, for example at least about 75% complementarity, at least about 90% complementarity, at least about 95% complementarity, at least about 98% complementarity, or even at least about 100% complementarity.

A thorough treatment of the qualitative and quantitative considerations involved in establishing binding conditions that allow one skilled in the art to design appropriate oligonucleotides for use under the desired conditions is provided by Beltz et al. Methods Enzymol. 100:266-285, 1983, and by Sambrook et al. (ed.), Molecular Cloning: A Laboratory Manual, 2nd ed., vol. 1-3, Cold Spring Harbor Laboratory Press, Cold Spring Harbor, N.Y., 1989.

Contacting: Placement in direct physical association, for example both in solid form and/or in liquid form (for example the placement of a probe in contact with a sample). Contacting can occur in vitro with isolated cells or substantially cell-free extracts, such as nuclear extracts, or in vivo by administering to a subject. “Administrating” to a subject includes methods used in the art such as topical, parenteral, oral, intravenous, intra-muscular, sub-cutaneous, transdermal, inhalational, nasal, or intra-articular administration, among others.

Control: A reference standard. A control can be a known value or range of values indicative of basal binding or a control sample (such as a normal cell not incubated under test conditions or a cell not treated with an agent), for example the binding on a transcription factor to a region of double-stranded DNA, such as is found on a partially double-stranded nucleic acids probe. A difference between a test sample and a control can be an increase or conversely a decrease. The difference can be a qualitative difference or a quantitative difference, for example a statistically significant difference. In some examples, a difference is an increase or decrease, relative to a control, of at least about 10%, such as at least about 20%, at least about 30%, at least about 40%, at least about 50%, at least about 60%, at least about 70%, at least about 80%, at least about 90%, at least about 100%, at least about 150%, at least about 200%, at least about 250%, at least about 300%, at least about 350%, at least about 400%, at least about 500%, or greater than 500%.

Corresponding: The term “corresponding” is a relative term indicating similarity in position, purpose, or structure. For example, a nucleic acid sequence corresponding to a gene promoter indicates that the nucleic acid sequence is similar to the promoter found in an organism.

Covalently linked: Refers to a covalent linkage between atoms by the formation of a covalent bond characterized by the sharing of pairs of electrons between atoms. In one example, a covalent link is a bond between an oxygen and a phosphorous, such as phosphodiester bonds in the backbone of a nucleic acid strand, such as the nucleic acid strands that form the indexing probes and partially double-stranded nucleic acid probes disclosed herein.

Detect: To determine if an agent (such as a signal or particular nucleotide, nucleic acid probe, amino acid, or protein) is present or absent. In some examples, this can further include quantification. For example, use of the disclosed indexing probes in particular examples permits detection of a fluorophore, for example detection of a signal from an acceptor fluorophore, such as an acceptor fluorophore present on a partially double-stranded nucleic acid probe, which can be used to determine if a particular probe is present.

Double-stranded nucleic acid binding protein: A protein that specifically binds to regions of double-stranded nucleic acids, such as duplex DNA, for example the double-stranded region of a partially double-stranded nucleic acid probe. Transcription factors are particular examples of double-stranded nucleic acid binding proteins, as are sigma factors in prokaryotic organisms.

Downregulated or inactivation: When used in reference to the expression of a nucleic acid molecule, such as a gene, refers to any process which results in a decrease in production of a gene product. A gene product can be RNA (such as mRNA, rRNA, tRNA, and structural RNA) or protein. Therefore, gene downregulation or deactivation includes processes that decrease transcription of a gene or translation of mRNA.

Examples of processes that decrease transcription include those that facilitate degradation of a transcription initiation complex, those that decrease transcription initiation rate, those that decrease transcription elongation rate, those that decrease processivity of transcription, and those that increase transcriptional repression. Gene downregulation can include reduction of expression above an existing level. Examples of processes that decrease translation include those that decrease translational initiation, those that decrease translational elongation, and those that decrease mRNA stability.

Gene downregulation includes any detectable decrease in the production of a gene product. In certain examples, production of a gene product decreases by at least 2-fold, for example at least 3-fold or at least 4-fold, as compared to a control (such an amount of gene expression in a normal cell).

Electrophoresis: The process of separating a mixture of charged molecules based on the different mobility of these charged molecules in response to an applied electric current. A particular type of electrophoresis is gel electrophoresis. The mobility of a molecule is generally related to the characteristics of the charged molecule, such as size, shape, and surface charge among others. The mobility of a molecule also is influenced by the electrophoretic medium, for example the composition of the electrophoresis gel. For example, when the electrophoretic medium is cross-linked acrylamide (polyacrylamide) increasing the percentage if acrylamide in the gel reduces the size of the resulting pores in the gel and retards the mobility of a molecule relative to a gel with a lower percentage of acrylamide (larger pore size). Gel electrophoresis can be performed for analytical purposes, but can also be used as a preparative technique to partially purify molecules prior to use of other methods, such as mass spectrometry, PCR, cloning, DNA sequencing, array analysis, and immuno-blotting.

Electromagnetic radiation: A series of electromagnetic waves that are propagated by simultaneous periodic variations of electric and magnetic field intensity, and that includes radio waves, infrared, visible light, ultraviolet light, X-rays and gamma rays. In particular examples, electromagnetic radiation is emitted by a laser, which can possess properties of monochromaticity, directionality, coherence, polarization, and intensity. Lasers are capable of emitting light at a particular wavelength (or across a relatively narrow range of wavelengths), for example such that energy from the laser can excite a donor but not an acceptor fluorophore.

Emission or emission signal: The light of a particular wavelength generated from a source. In particular examples, an emission signal is emitted from a fluorophore after the fluorophore absorbs light at its excitation wavelengths.

Excitation or excitation signal: The light of a particular wavelength necessary and/or sufficient to excite an electron transition to a higher energy level. In particular examples, an excitation is the light of a particular wavelength necessary and/or sufficient to excite a fluorophore to a state such that the fluorophore will emit a different (such as a longer) wavelength of light then the wavelength of light from the excitation signal.

Fluorophore: A chemical compound, which when excited by exposure to a particular stimulus, such as a defined wavelength of light, emits light (fluoresces), for example at a different wavelength (such as a longer wavelength of light).

Fluorophores are part of the larger class of luminescent compounds. Luminescent compounds include chemiluminescent molecules, which do not require a particular wavelength of light to luminesce, but rather use a chemical source of energy. Therefore, the use of chemiluminescent molecules (such as aequorin) can eliminate the need for an external source of electromagnetic radiation, such as a laser.

Examples of particular fluorophores that can be used in the probes and primers disclosed herein are provided in U.S. Pat. No. 5,866,366 to Nazarenko et al., such as 4-acetamido-4′-isothiocyanatostilbene-2,2′disulfonic acid, acridine and derivatives such as acridine and acridine isothiocyanate, 5-(2′-aminoethyl)aminonaphthalene-1-sulfonic acid (EDANS), 4-amino-N-[3-vinylsulfonyl)phenyl]naphthalimide-3,5 disulfonate (Lucifer Yellow VS), N-(4-anilino-1-naphthyl)maleimide, anthranilamide, Brilliant Yellow, coumarin and derivatives such as coumarin, 7-amino-4-methylcoumarin (AMC, Coumarin 120), 7-amino-4-trifluoromethylcouluarin (Coumaran 151); cyanosine; 4′, 6-diaminidino-2-phenylindole (DAPI); 5′,5″-dibromopyrogallol-sulfonephthalein (Bromopyrogallol Red); 7-diethylamino-3-(4′-isothiocyanatophenyl)-4-methylcoumarin; diethylenetriamine pentaacetate; 4,4′-diisothiocyanatodihydro-stilbene-2,2′-disulfonic acid; 4,4′-diisothiocyanatostilbene-2,2′-disulfonic acid; 5-[dimethylamino]naphthalene-1-sulfonyl chloride (DNS, dansyl chloride); 4-dimethylaminophenylazophenyl-4′-isothiocyanate (DABITC); eosin and derivatives such as eosin and eosin isothiocyanate; erythrosin and derivatives such as erythrosin B and erythrosin isothiocyanate; ethidium; fluorescein and derivatives such as 5-carboxyfluorescein (FAM), 5-(4,6-dichlorotriazin-2-yl)aminofluorescein (DTAF), 2′7′-dimethoxy-4′5′-dichloro-6-carboxyfluorescein (JOE), fluorescein, fluorescein isothiocyanate (FITC), and QFITC (XRITC); fluorescamine; IR144; IR1446; Malachite Green isothiocyanate; 4-methylumbelliferone; ortho cresolphthalein; nitrotyrosine; pararosaniline; Phenol Red; B-phycoerythrin; o-phthaldialdehyde; pyrene and derivatives such as pyrene, pyrene butyrate and succinimidyl 1-pyrene butyrate; Reactive Red 4 (Cibacron™ Brilliant Red 3B-A); rhodamine and derivatives such as 6-carboxy-X-rhodamine (ROX), 6-carboxyrhodamine (R6G), lissamine rhodamine B sulfonyl chloride, rhodamine (Rhod), rhodamine B, rhodamine 123, rhodamine X isothiocyanate, sulforhodamine B, sulforhodamine 101 and sulfonyl chloride derivative of sulforhodamine 101 (Texas Red); N,N,N′,N′-tetramethyl-6-carboxyrhodamine (TAMRA); tetramethyl rhodamine; tetramethyl rhodamine isothiocyanate (TRITC); riboflavin; rosolic acid and terbium chelate derivatives; LightCycler Red 640; Cy5.5; and Cy56-carboxyfluorescein; 5-carboxyfluorescein (5-FAM); boron dipyrromethene difluoride (BODIPY); N,N,N′,N′-tetramethyl-6-carboxyrhodamine (TAMRA); acridine, stilbene, -6-carboxy-fluorescein (HEX), TET (Tetramethyl fluorescein), 6-carboxy-X-rhodamine (ROX), Texas Red, 2′,7′-dimethoxy-4′,5′-dichloro-6-carboxyfluorescein (JOE), Cy3, CyS, VIC® (Applied Biosystems), LC Red 640, LC Red 705, Yakima yellow amongst others.

Other suitable fluorophores include those known to those skilled in the art, for example those available from Molecular Probes (Eugene, Oreg.). In particular examples, a fluorophore is used as a donor fluorophore or as an acceptor fluorophore.

“Acceptor fluorophores” are fluorophores which absorb energy from a donor fluorophore, for example in the range of about 400 to 900 nm (such as in the range of about 500 to 800 nm). Acceptor fluorophores generally absorb light at a wavelength which is usually at least 10 nm higher (such as at least 20 nm higher), than the maximum absorbance wavelength of the donor fluorophore, and have a fluorescence emission maximum at a wavelength ranging from about 400 to 900 nm. Acceptor fluorophores have an excitation spectrum overlapping with the emission of the donor fluorophore, such that energy emitted by the donor can excite the acceptor. Ideally, an acceptor fluorophore is capable of being attached to a nucleic acid molecule.

In a particular example, an acceptor fluorophore is a dark quencher, such as, Dabcyl, QSY7 (Molecular Probes), QSY33 (Molecular Probes), BLACK HOLE QUENCHERS™ (Glen Research), ECLIPSE™ Dark Quencher (Epoch Biosciences), IOWA BLACK™ (Integrated DNA Technologies). A quencher can reduce or quench the emission of a donor fluorophore. In such an example, instead5 of detecting an increase in emission signal from the acceptor fluorophore when in sufficient proximity to the donor fluorophore (or detecting a decrease in emission signal from the acceptor fluorophore when a significant distance from the donor fluorophore), an increase in the emission signal from the donor fluorophore can be detected when the quencher is a significant distance from the donor fluorophore (or a decrease in emission signal from the donor fluorophore when in sufficient proximity to the quencher acceptor fluorophore).

“Donor Fluorophores” are fluorophores or luminescent molecules capable of transferring energy to an acceptor fluorophore, thereby generating a detectable fluorescent signal from the acceptor. Donor fluorophores are generally compounds that absorb in the range of about 300 to 900 nm, for example about 350 to 800 nm. Donor fluorophores have a strong molar absorbance coefficient at the desired excitation wavelength, for example greater than about 10³ M⁻¹cm⁻¹.

Fluorescence Resonance Energy Transfer (FRET): A spectroscopic process by which energy is passed between an initially excited donor to an acceptor molecule separated by 10-100 Å. The donor molecules typically emit at shorter wavelengths that overlap with the absorption of the acceptor molecule. The efficiency of energy transfer is proportional to the inverse sixth power of the distance (R) between the donor and acceptor (1/R⁶) fluorophores and occurs without emission of a photon. In applications using FRET, the donor and acceptor dyes are different, in which case FRET can be detected either by the appearance of sensitized fluorescence of the acceptor or by quenching of donor fluorescence. For example, if the donor's fluorescence is quenched it indicates the donor and acceptor molecules are within the Forster radius (the distance where FRET has 50% efficiency, about 20-60 Å), whereas if the donor fluoresces at its characteristic wavelength, it denotes that the distance between the donor and acceptor molecules has increased beyond the Förster radius. In another example, energy is transferred via FRET between two different fluorophores such that the acceptor molecule can emit light at its characteristic wavelength, which is always longer than the emission wavelength of the donor molecule.

Fragment peptide: A peptide generated by proteolytic cleavage of a protein with a protein cleavage agent, for example in a protein digest. Such proteolytic peptides include peptides produced by treatment of a protein with one or more endoproteases, such as trypsin, chymotrypsin, endoprotease ArgC, endoprotease aspN, endoprotease gluC, and endoprotease lysC, as well as peptides produced by cleavage using chemical agents, such as cyanogen bromide, formic acid, and thiotrifluoroacetic acid. One or more cleavage peptides from a particular protein can be mass identifiers for the protein.

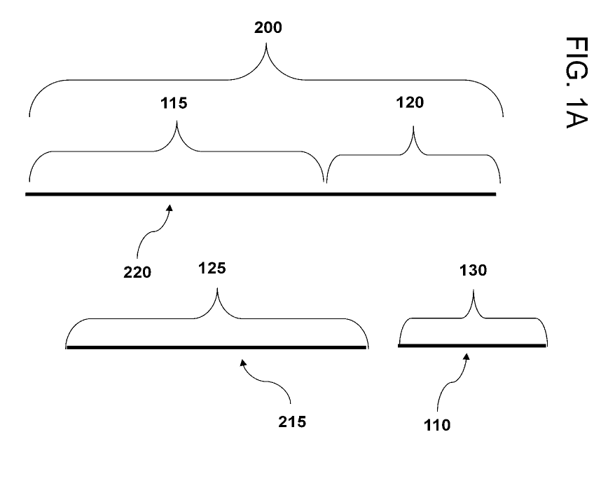

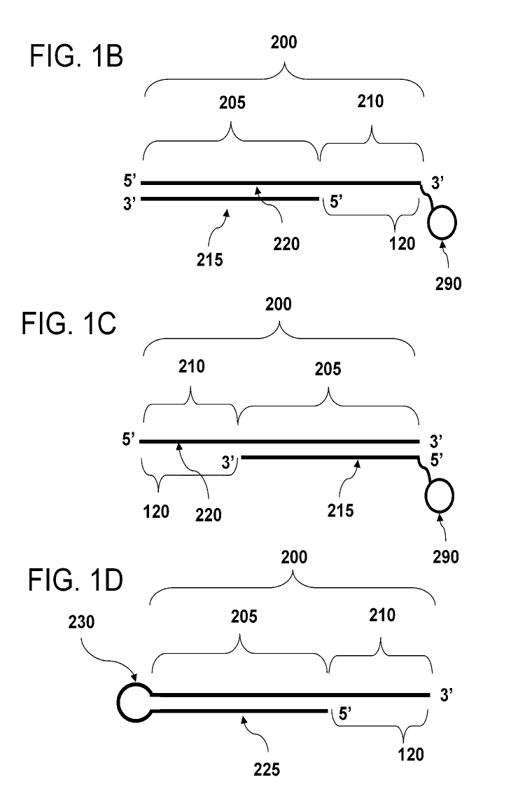

Hairpin or nucleic acid hairpin: A nucleic acid structure formed from a single strand of nucleic acid. The strand exhibits self-complementarity, such that the nucleic acid hybridizes with itself, forming a loop at one end. A schematic representation of a nucleic acid hairpin is shown in FIG. 1D.

High throughput technique: Through a combination of robotics, data processing and control software, liquid handling devices, and detectors, high throughput techniques allows the rapid screening of potential pharmaceutical agents in a short period of time, for example in less than 24, less than 12, less than 6 hours, or even less than 1 hour. Through this process, one can rapidly identify active compounds, antibodies, or genes affecting a particular binding event, for example the binding of a transcription factor to a particular DNA sequence.

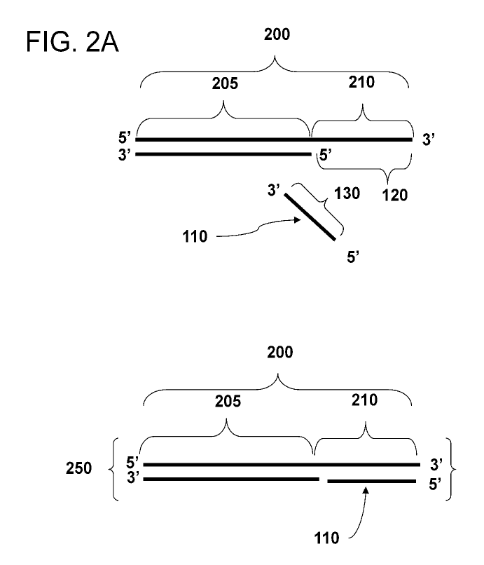

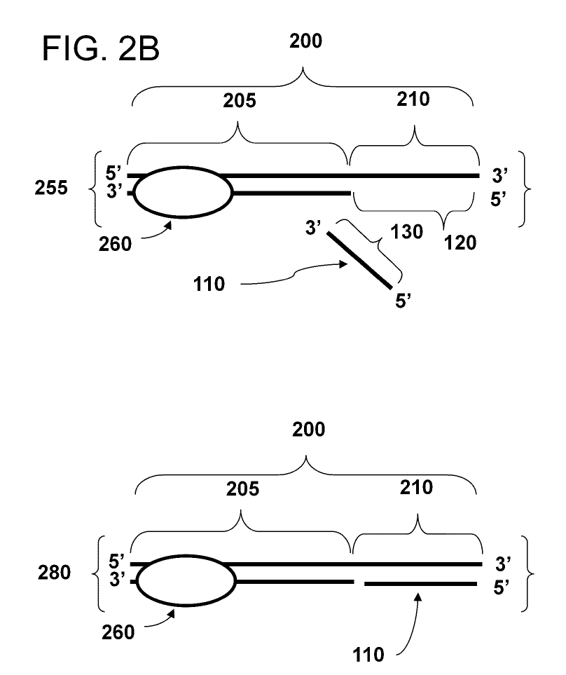

Hybridization: The ability of complementary single-stranded DNA or RNA to form a duplex molecule (also referred to as a hybridization complex). Nucleic acid hybridization techniques can be used to form hybridization complexes between a probe, such as the single-stranded portion of a partially double-stranded nucleic acid probe and an indexing probe. Hybridization that occurs between the single-stranded portion of a partially double-stranded nucleic acid probe 120 and an indexing probe 130 is illustrated in FIG. 2A.

Hybridization conditions resulting in particular degrees of stringency will vary depending upon the nature of the hybridization method and the composition and length of the hybridizing nucleic acid sequences. Generally, the temperature of hybridization and the ionic strength (such as the Na+ concentration) of the hybridization buffer will determine the stringency of hybridization. Calculations regarding hybridization conditions for attaining particular degrees of stringency are discussed in Sambrook et al., (1989) Molecular Cloning, second edition, Cold Spring Harbor Laboratory, Plainview, N.Y. (chapters 9 and 11). The following is an exemplary set of hybridization conditions and is not limiting:

Very High Stringency (Detects Sequences that Share at Least 90% Identity)
Hybridization: 5×SSC at 65° C. for 16 hours
Wash twice: 2×SSC at room temperature (RT) for 15 minutes each
Wash twice: 0.5×SSC at 65° C. for 20 minutes each
   High Stringency (Detects Sequences that Share at Least 80% Identity)
Hybridization: 5×-6×SSC at 65° C.-70° C. for 16-20 hours
Wash twice: 2×SSC at RT for 5-20 minutes each
Wash twice: 1×SSC at 55° C.-70° C. for 30 minutes each
   Low Stringency (Detects Sequences that Share at Least 50% Identity)
Hybridization: 6×SSC at RT to 55° C. for 16-20 hours
Wash at least twice: 2×-3×SSC at RT to 55° C. for 20-30 minutes each.
   Probes, such as the indexing probes and partially double-stranded nucleic acid probes disclosed herein, can hybridize under a variety of conditions, such as low stringency, high stringency, and very high stringency conditions.

Isolated: An “isolated” biological component (such as a protein, a nucleic acid probe, such as the probes described herein, or nuclear extract) has been substantially separated or purified away from other biological components in the cell of the organism in which the component naturally occurs, for example, extra-chromatin DNA and RNA, proteins and organelles. Proteins that have been “isolated” include proteins purified by standard purification methods, for example using gel electrophoresis and/or the use of an antibody. Nucleic acids and proteins that have been “isolated” include nucleic acids and proteins purified by standard purification methods. The term also embraces nucleic acids and proteins prepared by recombinant expression in a host cell as well as chemically synthesized nucleic acids. It is understood that the term “isolated” does not imply that the biological component is free of trace contamination, and can include nucleic acid molecules that are at least 50% isolated, such as at least 75%, 80%, 90%, 95%, 98%, 99%, or even 100% isolated.

Label: An agent capable of detection, for example by ELISA, spectrophotometry, flow cytometry, or microscopy. For example, a label can be attached to a nucleic acid molecule (such as the probes disclosed herein) or to a protein, thereby permitting detection of the nucleic acid molecule or protein. Examples of labels include, but are not limited to, radioactive isotopes, enzyme substrates, co-factors, ligands, chemiluminescent agents, fluorophores, haptens, enzymes, and combinations thereof. Methods for labeling and guidance in the choice of labels appropriate for various purposes are discussed for example in Sambrook et al. (Molecular Cloning: A Laboratory Manual, Cold Spring Harbor, New York, 1989) and Ausubel et al. (In Current Protocols in Molecular Biology, John Wiley & Sons, New York, 1998).

Nucleic acid (molecule or sequence): A deoxyribonucleotide or ribonucleotide polymer including without limitation, cDNA, mRNA, genomic DNA, and synthetic (such as chemically synthesized) DNA or RNA. The nucleic acid can be double-stranded (ds) or single-stranded (ss). Where single-stranded, the nucleic acid can be the sense strand or the antisense strand. Nucleic acids can include natural nucleotides (such as A, T/U, C, and G), and can also include analogs of natural nucleotides, such as labeled nucleotides. Some examples of nucleic acids include the probes disclosed herein, such as the indexing probes and partially double-stranded probes. Nucleic acid molecules include DNA (deoxyribonucleic acid). DNA is a long chain polymer which comprises the genetic material of most living organisms (some viruses have genes comprising ribonucleic acid (RNA)). The repeating units in DNA polymers are four different nucleotides, each of which comprises one of the four bases, adenine, guanine, cytosine, and thymine bound to a deoxyribose sugar to which a phosphate group is attached. However, modified nucleotides can also be used. Triplets of nucleotides (referred to as codons) code for each amino acid in a polypeptide, or for a stop signal. The term codon also is used for the corresponding (and complementary) sequences of three nucleotides in the mRNA into which the DNA sequence is transcribed.

Unless otherwise specified, any reference to a DNA molecule is intended to include the reverse complement of that DNA molecule. DNA molecules, though written to depict only a single strand, encompass both strands of a double-stranded DNA molecule.

Nucleotide: The fundamental unit of nucleic acid molecules. A nucleotide includes a nitrogen-containing base attached to a pentose monosaccharide with one, two, or three phosphate groups attached by ester linkages to the saccharide moiety.

The major nucleotides of DNA are deoxyadenosine 5′-triphosphate (dATP or A), deoxyguanosine 5′-triphosphate (dGTP or G), deoxycytidine 5′-triphosphate (dCTP or C) and deoxythymidine 5′-triphosphate (dTTP or T). The major nucleotides of RNA are adenosine 5′-triphosphate (ATP or A), guanosine 5′-triphosphate (GTP or G), cytidine 5′-triphosphate (CTP or C) and uridine 5′-triphosphate (UTP or U).

Nucleotides include those nucleotides containing modified bases, modified sugar moieties, and modified phosphate backbones, for example as described in U.S. Pat. No. 5,866,336 to Nazarenko et al.

Examples of modified base moieties which can be used to modify nucleotides at any position on its structure include, but are not limited to: 5-fluorouracil, 5-bromouracil, 5-chlorouracil, 5-iodouracil, hypoxanthine, xanthine, acetylcytosine, 5-(carboxyhydroxylmethyl)uracil, 5-carboxymethylaminomethyl-2-thiouridine, 5-carboxymethylaminomethyluracil, dihydrouracil, beta-D-galactosylqueosine, inosine, N˜6-sopentenyladenine, 1-methylguanine, 1-methylinosine, 2,2-dimethylguanine, 2-methyladenine, 2-methylguanine, 3-methylcytosine, 5-methylcytosine, N6-adenine, 7-methylguanine, 5-methylaminomethyluracil, methoxyarninomethyl-2-thiouracil, beta-D-mannosylqueosine, 5′-methoxycarboxymethyluracil, 5-methoxyuracil, 2-methylthio-N6-isopentenyladenine, uracil-5-oxyacetic acid, pseudouracil, queosine, 2-thiocytosine, 5-methyl-2-thiouracil, 2-thiouracil, 4-thiouracil, 5-methyluracil, uracil-5-oxyacetic acid methylester, uracil-S-oxyacetic acid, 5-methyl-2-thiouracil, 3-(3-amino-3-N-2-carboxypropyl)uracil, and 2,6-diaminopurine amongst others.

Examples of modified sugar moieties which may be used to modify nucleotides at any position on its structure include, but are not limited to arabinose, 2-fluoroarabinose, xylose, and hexose, or a modified component of the phosphate backbone, such as phosphorothioate, a phosphorodithioate, a phosphoramidothioate, a phosphoramidate, a phosphordiamidate, a methylphosphonate, an alkyl phosphotriester, or a formacetal or analog thereof.

Mass spectrometry: A method wherein a sample is analyzed by generating gas phase ions from the sample, which are then separated according to their mass-to-charge ratio (m/z) and detected. Methods of generating gas phase ions from a sample include electrospray ionization (ESI), matrix-assisted laser desorption-ionization (MALDI), surface-enhanced laser desorption-ionization (SELDI), chemical ionization, and electron-impact ionization (EI). Separation of ions according to their m/z ratio can be accomplished with any type of mass analyzer, including quadrupole mass analyzers (Q), time-of-flight (TOF) mass analyzers, magnetic sector mass analyzers, 3D and linear ion traps (IT), Fourier-transform ion cyclotron resonance (FT-ICR) analyzers, and combinations thereof (for example, a quadrupole-time-of-flight analyzer, or Q-TOF analyzer). Prior to separation, the sample can be subjected to one or more dimensions of chromatographic separation, for example, one or more dimensions of liquid or size exclusion chromatography.

Mutation: A change of the DNA sequence, for example in a promoter of a gene. In some instances, a mutation will alter a characteristic of the DNA sequence, for example the binding of a double-stranded binding protein to the DNA sequence. Mutations include base substitution point mutations, deletions, and insertions. Mutations can be introduced, for example by molecular biological techniques. In some examples, a mutation, such as a mutation in the promoter sequence of a gene, is introduced during synthesis of an oligonucleotide, such as an oligonucleotide that is part of a partially double-stranded nucleic acid probe, such as a partially double-stranded nucleic acid probe disclosed herein.

Nuclear extract: A biological sample that includes the soluble components of a cell nucleus, such as the soluble proteins (for example transcription factors). Methods for obtaining a nuclear extract are well known in the art and exemplary procedures can be found in Dignam, Nucleic Acids Res 11(5):1475-89 1983, which is incorporated herein by reference to the extent that it teaches methods for obtaining a nuclear extract.

Oligonucleotide or “oligo”: Multiple nucleotides (that is, molecules including a sugar (for example, ribose or deoxyribose) linked to a phosphate group and to an exchangeable organic base, which is either a substituted pyrimidine (Py) (for example, cytosine (C), thymine (T) or uracil (U)) or a substituted purine (Pu) (for example, adenine (A) or guanine (G)). The term “oligonucleotide” as used herein refers to both oligoribonucleotides and oligodeoxyribonucleotides. Oligonucleotides can be obtained from existing nucleic acid sources (for example, genomic or cDNA), but are preferably synthetic (that is, produced by oligonucleotide synthesis).

Partially double-stranded nucleic acid probe: A nucleic acid probe that includes both a region that is single-stranded and a region or portion that is double-stranded. FIGS. 1A-1D depict exemplary partially double-stranded nucleic acid probes. With reference to FIG. 1B, partially double-stranded nucleic acid probe 200 has a double-stranded portion 205 and a single-stranded portion 210, wherein the double-stranded and single-stranded portions are connected, for example covalently linked. In some examples, the double-stranded portion includes a binding site for a double-stranded nucleic acid binding protein, such as a transcription factor. In some examples disclosed herein, the single-stranded portion includes a nucleotide sequence capable of hybridizing with an indexing probe, such as those disclosed herein.

Peptide/Protein/Polypeptide: All of these terms refer to a polymer of amino acids and/or amino acid analogs that are joined by peptide bonds or peptide bond mimetics. The twenty naturally occurring amino acids and their single-letter and three-letter designations known in the art.

Promoter: An array of nucleic acid control sequences, which directs transcription of a nucleic acid. Typically, a eukaryotic a promoter includes necessary nucleic acid sequences near the start site of transcription, such as, in the case of a polymerase II type promoter, a TATA element. A promoter also optionally includes distal enhancer or repressor elements, which can be located as much as several thousand base pairs from the start site of transcription, such as specific DNA sequences that are recognized by proteins known as transcription factors.

In prokaryotes, a promoter is recognized by RNA polymerase and an associated sigma factor, which in turn are brought to the promoter DNA by an activator protein binding to its own DNA sequence nearby.

Protease or proteolytic enzymes: An enzyme that catalyses the hydrolysis of peptide bonds, for example peptide bonds in a protein. Examples of proteolytic enzymes include endoproteases, such as trypsin, chymotrypsin, endoprotease ArgC, endoprotease aspN, endoprotease gluC, and endoprotease lysC. Examples of chemical protein cleavage agents include cyanogen bromide, formic acid, and thiotrifluoroacetic acid. The specific bonds cleaved by an endoprotease or a chemical protein cleavage agents may be more specifically referred to as “endoprotease cleavage sites” and “chemical protein cleavage agent sites,” respectively. Proteins typically contain one or more intrinsic protein cleavage agent sites recognized by one or more protein cleavage agents by virtue of the amino acid sequence of the protein.

Sample: A sample, such as a biological sample, that includes biological materials (such as nucleic acid and proteins, for example double-stranded nucleic acid binding proteins) obtained from an organism or a part thereof, such as a plant, animal, bacteria, and the like. In particular embodiments, the biological sample is obtained from an animal subject, such as a human subject. A biological sample is any solid or fluid sample obtained from, excreted by or secreted by any living organism, including without limitation, single celled organisms, such as bacteria, yeast, protozoans, and amebas among others, multicellular organisms (such as plants or animals, including samples from a healthy or apparently healthy human subject or a human patient affected by a condition or disease to be diagnosed or investigated, such as cancer). For example, a biological sample can be a biological fluid obtained from, for example, blood, plasma, serum, urine, bile, ascites, saliva, cerebrospinal fluid, aqueous or vitreous humor, or any bodily secretion, a transudate, an exudate (for example, fluid obtained from an abscess or any other site of infection or inflammation), or fluid obtained from a joint (for example, a normal joint or a joint affected by disease, such as a rheumatoid arthritis, osteoarthritis, gout or septic arthritis). A biological sample can also be a sample obtained from any organ or tissue (including a biopsy or autopsy specimen, such as a tumor biopsy) or can include a cell (whether a primary cell or cultured cell) or medium conditioned by any cell, tissue or organ. In some examples, a biological sample is a nuclear extract. In some examples, a biological sample is bacterial cytoplasm.

Sequence identity/similarity: The identity/similarity between two or more nucleic acid sequences, or two or more amino acid sequences, is expressed in terms of the identity or similarity between the sequences. Sequence identity can be measured in terms of percentage identity; the higher the percentage, the more identical the sequences are. Homologs or orthologs of nucleic acid or amino acid sequences possess a relatively high degree of sequence identity/similarity when aligned using standard methods.

Methods of alignment of sequences for comparison are well known in the art. Various programs and alignment algorithms are described in: Smith & Waterman, Adv. Appl. Math. 2:482, 1981; Needleman & Wunsch, J. Mol. Biol. 48:443, 1970; Pearson & Lipman, Proc. Natl. Acad. Sci. USA 85:2444, 1988; Higgins & Sharp, Gene, 73:237-44, 1988; Higgins & Sharp, CABIOS 5:151-3, 1989; Corpet et al., Nuc. Acids Res. 16:10881-90, 1988; Huang et al. Computer Appls. in the Biosciences 8, 155-65, 1992; and Pearson et al., Meth. Mol. Bio. 24:307-31, 1994. Altschul et al., J. Mol. Biol. 215:403-10, 1990, presents a detailed consideration of sequence alignment methods and homology calculations.

The NCBI Basic Local Alignment Search Tool (BLAST) (Altschul et al., J. Mol. Biol. 215:403-10, 1990) is available from several sources, including the National Center for Biological Information (NCBI, National Library of Medicine, Building 38A, Room 8N805, Bethesda, Md. 20894) and on the Internet, for use in connection with the sequence analysis programs blastp, blastn, blastx, tblastn, and tblastx. Blastn is used to compare nucleic acid sequences, while blastp is used to compare amino acid sequences. Additional information can be found at the NCBI web site.

Once aligned, the number of matches is determined by counting the number of positions where an identical nucleotide or amino acid residue is presented in both sequences. The percent sequence identity is determined by dividing the number of matches either by the length of the sequence set forth in the identified sequence, or by an articulated length (such as 100 consecutive nucleotides or amino acid residues from a sequence set forth in an identified sequence), followed by multiplying the resulting value by 100. For example, a nucleic acid sequence that has 1166 matches when aligned with a test sequence having 1554 nucleotides is 75.0 percent identical to the test sequence (1166÷1554*100=75.0). The percent sequence identity value is rounded to the nearest tenth. For example, 75.11, 75.12, 75.13, and 75.14 are rounded down to 75.1, while 75.15, 75.16, 75.17, 75.18, and 75.19 are rounded up to 75.2. The length value will always be an integer. In another example, a target sequence containing a 20-nucleotide region that aligns with 20 consecutive nucleotides from an identified sequence as follows contains a region that shares 75 percent sequence identity to that identified sequence (i.e., 15±20*100=75).

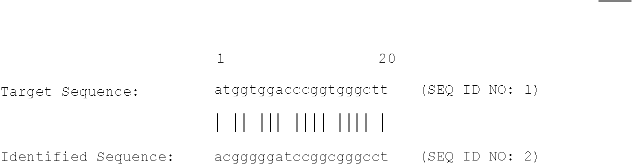

One indication that two nucleic acid molecules are closely related is that the two molecules hybridize to each other under stringent conditions. Stringent conditions are sequence-dependent and are different under different environmental parameters.

Sigma factor (a factor): A prokaryotic transcription factor that is part of RNA polymerase (RNAP) for specific binding to promoter sites on DNA. Different sigma factors are activated in response to different environmental conditions, for example environmental stresses such as starvation, heat shock, and challenge with antibiotics. A molecule of RNA polymerase (RNAP) can contain one sigma factor subunit. E. coli has at least eight sigma factors; the number of sigma factors varies between bacterial species. Typically, sigma factors are distinguished by their characteristic molecular weights, for example, σ70 refers to the sigma factor with a molecular weight of 70 kDa.

Signal: A detectable change or impulse in a physical property that provides information. In the context of the disclosed methods, examples include electromagnetic signals, such as light, for example light of a particular quantity or wavelength. In certain examples, the signal is the disappearance of a physical event, such as quenching of light.

Subject: Living multi-cellular vertebrate organisms, a category that includes human and non-human mammals.

Test agent: Any agent that that is tested for its effects, for example its effects on a cell and/or the binding of double-stranded binding protein, such as a transcription factor. In some embodiments, a test agent is a chemical compound, such as a chemotherapeutic agent, antibiotic, or even an agent with unknown biological properties.

Transcription factor: A protein that regulates transcription. In particular, transcription factors regulate the binding of RNA polymerase and the initiation of transcription. A transcription factor binds upstream or downstream to either enhance or repress transcription of a gene by assisting or blocking RNA polymerase binding. The term transcription factor includes both inactive and activated transcription factors.

Transcription factors are typically modular proteins that affect regulation of gene expression. Exemplary transcription factors include but are not limited to AAF, ab1, ADA2, ADA-NF1, AF-1, AFP1, AhR, AIIN3, ALL-1, alpha-CBF, alpha-CP1, alpha-CP2a, alpha-CP2b, alphaHo, alphaH2-alphaH3, Alx-4, aMEF-2, AML1, AML1a, AML1b, AML1c, AML1DeltaN, AML2, AML3, AML3a, AML3b, AMY-1L, A-Myb, ANF, AP-1, AP-2alphaA, AP-2alphaB, AP-2beta, AP-2gamma, AP-3 (1), AP-3 (2), AP-4, AP-5, APC, AR, AREB6, Arnt, Arnt (774 M form), ARP-1, ATBF1-A, ATBF1-B, ATF, ATF-1, ATF-2, ATF-3, ATF-3deltaZIP, ATF-a, ATF-adelta, ATPF1, Barhl1, Barhl2, Barx1, Barx2, Bcl-3, BCL-6, BD73, beta-catenin, Bin1, B-Myb, BP1, BP2, brahma, BRCA1, Brn-3a, Brn-3b, Brn-4, BTEB, BTEB2, B-TFIID, C/EBPalpha, C/EBPbeta, C/EBPdelta, CACCbinding factor, Cart-1, CBF (4), CBF (5), CBP, CCAAT-binding factor, CCMT-binding factor, CCF, CCG1, CCK-1a, CCK-1b, CD28RC, cdk2, cdk9, Cdx-1, CDX2, Cdx-4, CFF, Chx10, CLIM1, CLIM2, CNBP, CoS, COUP, CP1, CP1A, CP1C, CP2, CPBP, CPE binding protein, CREB, CREB-2, CRE-BP1, CRE-BPa, CREMalpha, CRF, Crx, CSBP-1, CTCF, CTF, CTF-1, CTF-2, CTF-3, CTF-5, CTF-7, CUP, CUTL1, Cx, cyclin A, cyclin T1, cyclin T2, cyclin T2a, cyclin T2b, DAP, DAX1, DB1, DBF4, DBP, DbpA, DbpAv, DbpB, DDB, DDB-1, DDB-2, DEF, deltaCREB, deltaMax, DF-1, DF-2, DF-3, Dlx-1, Dlx-2, Dlx-3, DIx4 (long isoform), Dlx-4 (short isoform, Dlx-5, Dlx-6, DP-1, DP-2, DSIF, DSIF-p14, DSIF-p160, DTF, DUX1, DUX2, DUX3, DUX4, E, E12, E2F, E2F+E4, E2F+p107, E2F-1, E2F-2, E2F-3, E2F-4, E2F-5, E2F-6, E47, E4BP4, E4F, E4F1, E4TF2, EAR2, EBP-80, EC2, EF1, EF-C, EGR1, EGR2, EGR3, EIIaE-A, EIIaE-B, EIIaE-Calpha, EIIaE-Cbeta, EivF, EIf-1, EIk-1, Emx-1, Emx-2, Emx-2, En-1, En-2, ENH-bind. prot., ENKTF-1, EPAS1, epsilonF1, ER, Erg-1, Erg-2, ERR1, ERR2, ETF, Ets-1, Ets-1 deltaVil, Ets-2, Evx-1, F2F, factor 2, Factor name, FBP, f-EBP, FKBP59, FKHL18, FKHRL1P2, Fli-1, Fos, FOXB1, FOXC1, FOXC2, FOXD1, FOXD2, FOXD3, FOXD4, FOXE1, FOXE3, FOXF1, FOXF2, FOXG1a, FOXG1b, FOXG1c, FOXH1, FOXI1, FOXJ1a, FOXJ1b, FOXJ2 (long isoform), FOXJ2 (short isoform), FOXJ3, FOXK1a, FOXK1b, FOXK1c, FOXL1, FOXM1a, FOXM1b, FOXM1c, FOXN1, FOXN2, FOXN3, FOX01a, FOX01b, FOXO2, FOXO3a, FOXO3b, FOXO4, FOXP1, FOXP3, Fra-1, Fra-2, FTF, FTS, G factor, G6 factor, GABP, GABP-alpha, GABP-beta1, GABP-beta2, GADD 153, GAF, gammaCMT, gammaCAC1, gammaCAC2, GATA-1, GATA-2, GATA-3, GATA-4, GATA-5, GATA-6, Gbx-1, Gbx-2, GCF, GCMa, GCNS, GF1, GLI, GLI3, GR alpha, GR beta, GRF-1, Gsc, Gscl, GT-IC, GT-IIA, GT-IIBalpha, GT-IIBbeta, H1TF1, H1TF2, H2RIIBP, H4TF-1, H4TF-2, HAND1, HAND2, HB9, HDAC1, HDAC2, HDAC3, hDaxx, heat-induced factor, HEB, HEB1-p67, HEB1-p94, HEF-1 B, HEF-1T, HEF-4C, HEN1, HEN2, Hesxl, Hex, HIF-1, HIF-1alpha, HIF-1beta, HiNF-A, HiNF-B, HINF-C, HINF-D, HiNF-D3, HiNF-E, HiNF-P, HIP1, HIV-EP2, Hlf, HLTF, HLTF (Met123), HLX, HMBP, HMG I, HMG I(Y), HMG Y, HMGI-C, HNF-1A, HNF-1B, HNF-1C, HNF-3, HNF-3alpha, HNF-3beta, HNF-3gamma, HNF4, HNF-4alpha, HNF4alpha1, HNF-4alpha2, HNF-4alpha3, HNF-4alpha4, HNF4gamma, HNF-6alpha, hnRNP K, HOX11, HOXA1, HOXA10, HOXA10 PL2, HOXA11, HOXA13, HOXA2, HOXA3, HOXA4, HOXA5, HOXA6, HOXA7, HOXA9A, HOXA9B, HOXB-1, HOXB13, HOXB2, HOXB3, HOXB4, HOXBS, HOXB6, HOXA5, HOXB7, HOXB8, HOXB9, HOXC10, HOXC11, HOXC12, HOXC13, HOXC4, HOXC5, HOXC6, HOXC8, HOXC9, HOXD10, HOXD11, HOXD12, HOXD13, HOXD3, HOXD4, HOXD8, HOXD9, Hp55, Hp65, HPX42B, HrpF, HSF, HSF1 (long), HSF1 (short), HSF2, hsp56, Hsp90, IBP-1, ICER-II, ICER-ligamma, ICSBP, Id1, Id1 H′, Id2, Id3, Id3/Heir-1, IF1, IgPE-1, IgPE-2, IgPE-3, IkappaB, IkappaB-alpha, IkappaB-beta, IkappaBR, II-1 RF, IL-6 RE-BP, 11-6 RF, INSAF, IPF1, IRF-1, IRF-2, irlB, IRX2a, Irx-3, Irx-4, ISGF-1, ISGF-3, ISGF3alpha, ISGF-3gamma, lst-1, ITF, ITF-1, ITF-2, JRF, Jun, JunB, JunD, kappay factor, KBP-1, KER1, KER-1, Kox1, KRF-1, Ku autoantigen, KUP, LBP-1, LBP-1a, LBX1, LCR-F1, LEF-1, LEF-1B, LF-A1, LHX1, LHX2, LHX3a, LHX3b, LHXS, LHX6.1a, LHX6.1b, LIT-1, Lmo1, Lmo2, LMX1A, LMX1B, L-My1 (long form), L-My1 (short form), L-My2, LSF, LXRalpha, LyF-1, LyI-1, M factor, Mad1, MASH-1, Max1, Max2, MAZ, MAZ1, MB67, MBF1, MBF2, MBF3, MBP-1 (1), MBP-1 (2), MBP-2, MDBP, MEF-2, MEF-2B, MEF-2C (433 AA form), MEF-2C (465 AA form), MEF-2C (473 M form), MEF-2C/delta32 (441 AA form), MEF-2D00, MEF-2D0B, MEF-2DA0, MEF-2DA′0, MEF-2DAB, MEF-2DA′B, Meis-1, Meis-2a, Meis-2b, Meis-2c, Meis-2d, Meis-2e, Meis3, Meox1, Meox1a, Meox2, MHox (K-2), Mi, MIF-1, Miz-1, MM-1, MOP3, MR, Msx-1, Msx-2, MTB-Zf, MTF-1, mtTF1, Mxi1, Myb, Myc, Myc 1, Myf-3, Myf-4, Myf-5, Myf-6, MyoD, MZF-1, NC1, NC2, NCX, NELF, NER1, Net, NF III-a, NF NF NF-1, NF-1A, NF-1B, NF-1X, NF-4FA, NF-4FB, NF-4FC, NF-A, NF-AB, NFAT-1, NF-AT3, NF-Atc, NF-Atp, NF-Atx, NfbetaA, NF-CLE0a, NF-CLE0b, NFdeltaE3A, NFdeltaE3B, NFdeltaE3C, NFdeltaE4A, NFdeltaE4B, NFdeltaE4C, Nfe, NF-E, NF-E2, NF-E2 p45, NF-E3, NFE-6, NF-Gma, NF-GMb, NF-IL-2A, NF-IL-2B, NF-jun, NF-kappaB, NF-kappaB(-like), NF-kappaB1, NF-kappaB1, precursor, NF-kappaB2, NF-kappaB2 (p49), NF-kappaB2 precursor, NF-kappaE1, NF-kappaE2, NF-kappaE3, NF-MHCIIA, NF-MHCIIB, NF-muE1, NF-muE2, NF-muE3, NF-S, NF-X, NF-X1, NF-X2, NF-X3, NF-Xc, NF-YA, NF-Zc, NF-Zz, NHP-1, NHP-2, NHP3, NHP4, NKX2-5, NKX2B, NKX2C, NKX2G, NKX3A, NKX3A vl, NKX3A v2, NKX3A v3, NKX3A v4, NKX3B, NKX6A, Nmi, N-Myc, N-Oct-2alpha, N-Oct-2beta, N-Oct-3, N-Oct-4, N-Oct-5a, N-Oct-5b, NP-TCII, NR2E3, NR4A2, Nrf1, Nrf-1, Nrf2, NRF-2beta1, NRF-2gamma1, NRL, NRSF form 1, NRSF form 2, NTF, 02, OCA-B, Oct-1, Oct-2, Oct-2.1, Oct-2B, Oct-2C, Oct-4A, Oct4B, Oct-5, Oct-6, Octa-factor, octamer-binding factor, oct-B2, oct-B3, Otx1, Otx2, OZF, p107, p130, p28 modulator, p300, p38erg, p45, p49erg,-p53, p55, p55erg, p65delta, p67, Pax-1, Pax-2, Pax-3, Pax-3A, Pax-3B, Pax-4, Pax-5, Pax-6, Pax-6/Pd-5a, Pax-7, Pax-8, Pax-8a, Pax-8b, Pax-8c, Pax-8d, Pax-8e, Pax-8f, Pax-9, Pbx-1a, Pbx-1b, Pbx-2, Pbx-3a, Pbx-3b, PC2, PC4, PC5, PEA3, PEBP2alpha, PEBP2beta, Pit-1, PITX1, PITX2, PITX3, PKNOX1, PLZF, PO-B, Pontin52, PPARalpha, PPARbeta, PPARgamma1, PPARgamma2, PPUR, PR, PR A, pRb, PRD1-BF1, PRDI-BFc, Prop-1, PSE1, P-TEFb, PTF, PTFalpha, PTFbeta, PTFdelta, PTFgamma, Pu box binding factor, Pu box binding factor (BJA-B), PU.1, PuF, Pur factor, R1, R2, RAR-alpha1, RAR-beta, RAR-beta2, RAR-gamma, RAR-gamma1, RBP60, RBP-Jkappa, Rel, RelA, RelB, RFX, RFX1, RFX2, RFX3, RFXS, RF-Y, RORalpha1, RORalpha2, RORalpha3, RORbeta, RORgamma, Rox, RPF1, RPGalpha, RREB-1, RSRFC4, RSRFC9, RVF, RXR-alpha, RXR-beta, SAP-1a, SAP1b, SF-1, SHOX2a, SHOX2b, SHOXa, SHOXb, SHP, SIII-p110, SIII-p15, SIII-p18, SIM', Six-1, Six-2, Six-3, Six-4, Six-5, Six-6, SMAD-1, SMAD-2, SMAD-3, SMAD-4, SMAD-5, SOX-11, SOX-12, Sox-4, Sox-5, SOX-9, Sp1, Sp2, Sp3, Sp4, Sph factor, Spi-B, SPIN, SRCAP, SREBP-1a, SREBP-1b, SREBP-1c, SREBP-2, SRE-ZBP, SRF, SRY, SRP1, Staf-50, STAT1alpha, STAT1beta, STAT2, STAT3, STAT4, STAT6, T3R, T3R-alpha1, T3R-alpha2, T3R-beta, TAF(I)110, TAF(I)48, TAF(I)63, TAF(II)100, TAF(II)125, TAF(II)135, TAF(II)170, TAF(II)18, TAF(II)20, TAF(II)250, TAF(II)250Delta, TAF(II)28, TAF(II)30, TAF(II)31, TAF(II)55, TAF(II)70-alpha, TAF(II)70-beta, TAF(II)70-gamma, TAF-I, TAF-II, TAF-L, Tal-1, Tal-1beta, Tal-2, TAR factor, TBP, TBX1A, TBX1B, TBX2, TBX4, TBXS (long isoform), TBXS (short isoform), TCF, TCF-1, TCF-1A, TCF-1B, TCF-1C, TCF-1D, TCF-1E, TCF-1F, TCF-1G, TCF-2alpha, TCF-3, TCF-4, TCF-4(K), TCF-4B, TCF-4E, TCFbeta1, TEF-1, TEF-2, tel, TFE3, TFEB, TFIIA, TFIIA-alpha/beta precursor, TFIIA-alpha/beta precursor, TFIIA-gamma, TFIIB, TFIID, TFIIE, TFIIE-alpha, TFIIE-beta, TFIIF, TFIIF-alpha, TFIIF-beta, TFIIH, TFIIH*, TFIIH-CAK, TFIIH-cyclin H, TFIIH-ERCC2/CAK, TFIIH-MAT1, TFIIH-MO15, TFIIH-p34, TFIIH-p44, TFIIH-p62, TFIIH-p80, TFIIH-p90, TFII-I, Tf-LF1, Tf-LF2, TGIF, TGIF2, TGT3, THRA1, TIF2, TLE1, TLX3, TMF, TR2, TR2-11, TR2-9, TR3, TR4, TRAP, TREB-1, TREB-2, TREB-3, TREF1, TREF2, TRF (2), TTF-1, TXRE BP, TxREF, UBF, UBP-1, UEF-1, UEF-2, UEF-3, UEF-4, USF1, USF2, USF2b, Vav, Vax-2, VDR, vHNF-1A, vHNF-1B, vHNF-1C, VITF, WSTF, WT1, WT1I, WT1 I-KTS, WT1 I-de12, WT1-KTS, WT1-de12, X2BP, XBP-1, XW-V, XX, YAF2, YB-1, YEBP, YY1, ZEB, ZF1, ZF2, ZFX, ZHX1, ZIC2, ZID, ZNF174, amongst others.

An activated transcription factor is a transcription factor that has been activated by a stimulus resulting in a measurable change in the state of the transcription factor, for example a post-translational modification, such as phosphorylation, methylation, and the like. Activation of a transcription factor can result in a change in the affinity for a particular DNA sequence or of a particular protein, such as another transcription factor and/or cofactor.

Under conditions that permit binding: A phrase used to describe any environment that permits the desired activity, for example conditions under which two or more molecules, such as nucleic acid molecules and/or protein molecules, can bind. Such conditions can include specific concentrations of salts and/or other chemicals that facilitate the binding of molecules. In some examples, conditions that permit binding are similar to the conditions found in the nucleus of a cell, for example a eukaryotic cell or the cytoplasm of a prokaryotic cell. Such conditions can be simulated, for example by using a nuclear extract.

### II. Overview of Several Embodiments

The present disclosure relates to methods for identifying the binding sites of double strand nucleic acid binding proteins (such as double-stranded DNA binding proteins, for example transcription factors, such as activated transcription factors) on double-stranded nucleic acids, such as double-stranded DNA. The disclosed methods also relate to identifying double-stranded nucleic acid binding proteins (such as double-stranded DNA binding proteins, for example, transcription factors, such as activated transcription factors) that bind to specific sequences of double-stranded nucleic acids, such as double-stranded DNA, for example the binding sites present in the promoter of a gene, such as a gene of interest, or mutations thereof.

The disclosed methods use partially double-stranded nucleic acid probes that have a double-stranded portion capable of binding double-stranded nucleic acid binding proteins, such as transcription factors. As schematically represented in FIGS. 1B-1D, double-stranded portion 205 of partially double-stranded nucleic acid probe 200 is linked to single-stranded portion 210 that caries a unique indexing sequence capable of identification by an indexing probe having a sequence complimentary to the indexing sequence present in the single-stranded region of the partially double-stranded nucleic acid probe. A schematic outline of partially double-stranded nucleic acid probe 200 hybridizing to indexing probe 110 is shown in FIG. 2A. In some examples, using partially double-stranded nucleic acid probe 200 that is not attached to a solid surface, such as an array, mitigates surface effects, such as molecular crowding that may affect the binding of certain double-stranded binding proteins. Therefore, double-stranded portion 205 of partially double-stranded nucleic acid probe 200 can be of almost any length and contain multiple binding sites without interfering with identification of the partially double-stranded nucleic acid probe. In addition, by employing an indexing probe, the hybridization conditions of the indexing probe and the partially double-stranded nucleic acid probe can be optimized, for example to substantially exclude non-specific hybridization and/or establishing substantially identical duplex melting temperatures across a set of indexing probes, for example by controlling the CG content, and length amongst other factors, such that the individual indexing probe partially double-stranded nucleic acid probe pairs have similar melting temperatures and/or hybridization conditions.

### Partially Double-Stranded Nucleic Acid Probes

The methods disclosed herein employ partially double-stranded nucleic acid probes (such as partially double-stranded DNA probes, for example probes made from one or more DNA oligos) for the identification of double-stranded nucleic acid protein binding sites and/or for the identification of proteins capable of binding double-stranded nucleic acid sequences, for example transcription factors, such as activated transcription factors. Accordingly, partially double-stranded nucleic acid probes are disclosed. It will be appreciated that partially double-stranded nucleic acid probed can be constructed from DNA, RNA, or a combination thereof. With reference to FIG. 1A, in some examples, partially double-stranded nucleic acid probe 200 is constructed from two nucleic acid strands 215, 220 that include complementary sequences 115, 125 that are hybridized together to form partially double-stranded nucleic acid probe 200. Partially double-stranded nucleic acid probe 200 includes index sequence 120, such as but not limited to the index sequences shown in Table 16, that hybridizes with the complementary sequence 130 present on indexing probe 110. FIGS. 1B and 1C show two of the many possible arrangements of a partially double-stranded nucleic acid probe.

In some examples, with reference to FIG. 1B, partially double-stranded nucleic acid probe 200 includes two portions, double-stranded portion 205 and single-stranded portion 210. Single-stranded portion 210 and includes a nucleotide sequence corresponding to an index sequence, such as but not limited to the index sequences shown in Table 16. With reference to FIG. 1B, two strands 215, 220 are hybridized to form partially double-stranded nucleic acid probe 200 in which index sequence 120 is present in a 3′ overhang. Alternatively, with reference to FIG. 1C, two strands 215, 220 are hybridized to form partially double-stranded nucleic acid probe 200 in which index sequence 120 is present in a 5′ overhang. FIG. 1D depicts another example, wherein partially double-stranded nucleic acid probe 200 is formed from single nucleotide strand 225 by the formation of nucleic acid hairpin 230. While a 3′ overhang is shown, one of ordinary skill in the art will appreciate that hairpin 230 can be formed with a 5′ overhang.

The second portion of partially double-stranded nucleic acid probe 200 is double-stranded portion 205 and is selected such that it contains one or more potential binding sites for double-stranded nucleic acid binding proteins, such as transcription factors, for example a partially double-stranded nucleic acid probe can contain 1, 2, 3, 4, 5, 6, 7, 8, 9, 10, or even more potential binding sites for double-stranded nucleic acid binding proteins, such as transcription factors, for example activated transcription factors. The double-stranded portion of the disclosed partially double-stranded nucleic acid probes are typically greater than about 8 nucleotide base pairs in length such as greater than about 8, about 9, about 10, about 11, about 12, about 13, about 14, about 15, about 20, about 25, about 30, about 35, about 40 , about 45, about 50, about 60 , about 70 , about 80, about 90, about 100, about 120, about 140, about 160, about 180, about 200, about 250, about 300, or even greater than about 350 base pairs in length such as 8-50 nucleotides, 8-100 nucleotides, 8-200 nucleotides, 8-300 nucleotides, 8-500 nucleotides, or even greater than 500 nucleotides in length.

With reference to FIG. 1A, the disclosed partially double-stranded nucleic acid probes 200 include a unique index sequence 120. Index sequence 120 is generally chosen such that it does not contain any known binding sites for double-stranded nucleic acid binding proteins, such as transcription factor binding sites. This reduces the possibility of a transcription factor or other double-stranded nucleic acid binding protein binding to a duplex formed by the index sequence, for example, formed from an indexing probe 110 and partially double-stranded nucleic acid probe 200. The index sequences are also chosen such that when multiple partially double-stranded nucleic acid probes are employed (for example, each with a different index sequence) there is no significant hybridization between the different partially double-stranded nucleic acid probes. In addition, the index sequences are chosen such that the partially double-stranded nucleic acid probes only bind to one indexing probe, which has a nucleic acid sequence complementary to the sequence present in the partially double-stranded nucleic acid probe. The index sequence present on the probes can be chosen to have desired properties, for example a specific melting temperature, length, and/or GC content. The disclosed methods provide the ability to select an index sequence with specific properties, which allows multiple index sequences to be selected with the same properties. In some embodiments, the index sequence is selected such that it contains about 30% to about 70% guanine and cytosine, such as about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, or about 70% guanine and cytosine, such as 30-70% guanine and cytosine, 30-60% guanine and cytosine, 30-50% guanine and cytosine, or 30-40% guanine and cytosine. The index sequence present on the partially double-stranded nucleic acids probes disclosed herein is generally at least about 15 nucleotides in length, such as at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least 40, at least 41, at least 42, at least 43, at least 44, at least 45, at least 46, at least 47, at least 48, at least 49, at least 50, at least 51, at least 52, at least 53, at least 54, at least 55, at least 56, at least 57, at least 58, at least 59, at least 60, or more contiguous nucleotides, such as 15-60 nucleotides, 15-50 nucleotides, 15-40 nucleotides, or 15-30 nucleotides.

Index sequences can be selected by any method that allows for the selection of a nucleotide sequence with the desirable features such as GC content and/or length. For example, the indexing sequences can be designed de novo for example by hand, or with the use of a computer program, such as OLIGO® (Molecular Biology Insights, Inc). In another example, the sequences available from GENBANK®, such as genomic sequences, can be screened for regions of sequence that have the desirable characteristics. By way of example, this can be done by searching oligos specific for human genes through oligodb database maintained on line (Mrowka et al., Bioinformatics 18(12):1686-7, 2002). Then the oligos are sorted according to their Tₘ value. A set of oligos with similar Tₘs can be identified synthesized and used as the unique indexing sequences present in a partially double-stranded nucleic acid probe. The complementary sequence can be used in the construction of an indexing probe. Where multiple partially double-stranded probes are used (each with a unique index sequence) the index sequnces of the partially double-stranded nucleic acid probes can be chosen such that all of the index sequnces have the same length and GC content.

For the detection and/or isolation of a partially double-stranded nucleic acid probe, a partially double-stranded nucleic acid probe can include a label. For example, with reference to FIGS. 1B and 1C partially double-stranded nucleic acid probe 200 can include label 290. While particular examples of the location of the label 290 are shown, one of ordinary skill in the art would understand that label 290 can be placed any where in partially double-stranded nucleic acid probe 200. Thus, in some embodiments, the partially double-stranded nucleic acid probe is detectably labeled, either with an isotopic or non-isotopic label. Non-isotopic labels can, for instance, include a fluorescent or luminescent molecule, biotin, an enzyme or enzyme substrate or a chemical. Such labels are preferentially chosen such that the hybridization of the partially double-stranded nucleic acid probe with the indexing probe can be detected. In some examples, the partially double-stranded nucleic acid probe is labeled with a fluorophore. Examples of suitable fluorophore labels are given above. In some examples, the fluorophore is a donor fluorophore. In other examples, the fluorophore is an accepter fluorophore, such as a fluorescence quencher. Appropriate donor/acceptor fluorophore pairs can be selected using routine methods. In one example, the donor emission wavelength is one that can significantly excite the acceptor, thereby generating a detectable emission from the acceptor. For example the partially double-stranded nucleic acid probe can be labeled with a donor fluorophore and the indexing probe labeled with an acceptor flourophore, such that when the indexing the partially double-stranded nucleic acid probe are in close proximity, for example because of hybridization, FRET occurs between the donor and acceptor and an emission can be detected. One of ordinary skill in the art can readily appreciate that the relative positions of the donor/acceptor fluorophore pair can be swapped.

### Indexing Probes

The disclosed double-stranded nucleic acid probes are identifiable by the unique index sequence present in the probe. For example, with reference to FIG. 2A partially double-stranded nucleic acid probe 200 that includes index sequence 120 on single-stranded portion 210 can be recognized by hybridization to a nucleic acid molecule have substantial complementarity to this unique index sequence 120, such as complementary sequence 130 present on indexing probe 110, for example by forming hybridization complex 250. Accordingly, indexing probes are disclosed. It will be appreciated that indexing probes can be constructed from DNA, RNA, or a combination thereof. The disclosed indexing probes have substantial complementarity to the indexing sequence present on the partially double-stranded nucleic acid probe that they recognize, for example, greater than about 95% complementarity, such as greater than about 95%, greater than about 96%, greater than about 97%, greater than about 98%, greater than about 99%, or even 100% complementarity, although typically 100% identity is preferred, for example to reduce any cross hybridization.

The disclosed indexing probes are single-stranded and contain a nucleic acid sequence (such as a DNA sequence) complementary to the indexing sequence present in a partially double-stranded nucleic acid probe. Each indexing probe has a sequence that is unique to that indexing probe. In other words, the indexing probes all have different indexing sequences. The disclosed indexing probes are generally at least 15 nucleotides in length, such as at least 15, at least 16, at least 17, at least 18, at least 19, at least 20, at least 21, at least 22, at least 23, at least 24, at least 25, at least 26, at least 27, at least 28, at least 29, at least 30, at least 31, at least 32, at least 33, at least 34, at least 35, at least 36, at least 37, at least 38, at least 39, at least 40, at least 41, at least 42, at least 43, at least 44, at least 45, at least 46, at least 47, at least 48, at least 49, at least 50 at least 51, at least 52, at least 53, at least 54, at least 55, at least 56, at least 57, at least 58, at least 59, at least 60, or more contiguous nucleotides, such as 15-60 nucleotides, 15-50 nucleotides, 15-40 nucleotides, or 15-30 nucleotides.

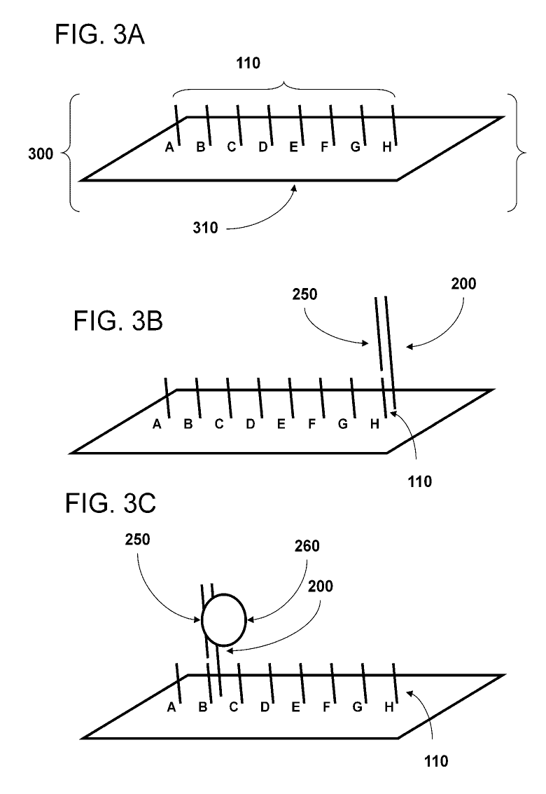

In some examples, as illustrated in FIG. 3A, indexing probe 110 disclosed herein can be attached to solid support 310, such as indexing array 300. In some embodiments, the indexing probe is labeled with a detectable label, such as radioactive isotopes, enzyme substrates, co-factors, ligands, chemiluminescent or fluorescent agents, haptens, and enzymes. In particular examples, an indexing probe includes at least one fluorophore, such as an acceptor fluorophore or donor fluorophore. For example, a fluorophore can be attached at the 5′- or 3′-end of the probe. In specific examples, the fluorophore is attached to the base at the 5′-end of the probe, the base at its 3′-end, the phosphate group at its 5′-end or a modified base, such as a T internal to the probe. Methods for labeling and guidance in the choice of labels appropriate for various purposes are discussed, for example, in Sambrook et al., Molecular Cloning: A Laboratory Manual, Cold Spring Harbor Laboratory Press (1989) and Ausubel et al., Current Protocols in Molecular Biology, Greene Publishing Associates and Wiley-Intersciences (1987). In some examples, the indexing probe includes nucleotides in addition to the indexing sequence, for example to improve binding to the solid support, such as to provide a spacer between the indexing sequence present on the probe and the solid support. For example, the indexing probe can include additional nucleotides 5′ of the indexing sequence, 3′ of the indexing sequence, or both 5′ and 3′ of the indexing sequence.

### Identification of Protein Binding Sites in Double-Stranded DNA

The methods disclosed herein are particularly suited to identifying the sequence requirements of double-stranded binding proteins, such as transcription factors. Accordingly, aspects of this disclosure relate to methods for identifying a double-stranded nucleic acid protein binding site, such as a double-stranded DNA protein binding site, for example the binding site of a transcription factor, such as an activated transcription factor.

The disclosed methods include contacting a sample including double-stranded nucleic acid binding proteins, such as transcription factors, with at least one partially double-stranded nucleic acid probe under conditions that permit binding between double-stranded binding proteins and partially double-stranded nucleic acid probes. The partially double-stranded nucleic acid probes disclosed herein include a first portion linked to a second portion. The first portion includes a single-stranded nucleic acid region of at least about 15 nucleotides in length with a unique index sequence, such as one of the unique indexing sequences as set forth in Table 16. The second portion of the partially double-stranded nucleic acid probe includes a double-stranded region at least about 8 nucleotide base pairs in length that includes at least one potential binding site for at least one double-stranded nucleic acid binding protein, such as a transcription factor, for example an activated transcription factor.

With reference to FIG. 2B, after binding between partially double-stranded nucleic acid probe 200 and the double-stranded binding protein 260, hybridization complex 255 of partially double-stranded nucleic acid probe 200 bound by at least one double-stranded nucleic acid binding protein 260 is isolated using gel electrophoresis, for example using the methods disclosed in U.S. Provisional Patent Application 61/033,331, filed Mar. 3, 2008, which is incorporated herein by reference in its entirety, or other suitable gel electrophoresis technique. The isolated partially double-stranded nucleic acid probe 200 is then hybridized to a nucleic acid indexing probe 110 that includes a nucleic acid sequence complementary to the unique index sequence present in the single-stranded region of the partially double-stranded nucleic acid probe 200, for example an indexing probe including the indexing sequence set forth in Table 16. Detection of hybridization, for example hybridization complex 250 (FIG. 2A) or protein bound hybridization complex 280 (FIG. 2A), between the indexing probe and the partially double-stranded nucleic acid probe identifies the double-stranded nucleic sequence present in the probe as one that binds double-stranded nucleic acid binding proteins.

One of ordinary skill in the art would recognize that the methods disclosed herein are equally applicable multiple partially double-stranded nucleic acid probes, for example with each probe having a unique indexing sequence, for example an indexing sequence according to one of the indexing sequences from Table 16.

A further application of the disclosed methods is the rapid and efficient determination of the sequence binding requirements for a given double-stranded nucleic acid binding protein, such as a double-stranded DNA binding protein, for example a transcription factor, such as an activated transcription factor. For example, by constructing a library of different double-stranded sequences and determining which sequences a particular transcription factor binds to, the disclosed method makes it possible to rapidly identify the sequence requirements for a given transcription factor in a high throughput manner. Similarly, the binding requirements for other double-stranded nucleic acid binding proteins can be determined. In some embodiments, the double-stranded portion is selected to correspond to a mutant form of known or predicted binding site of a double-stranded nucleic acid binding protein.

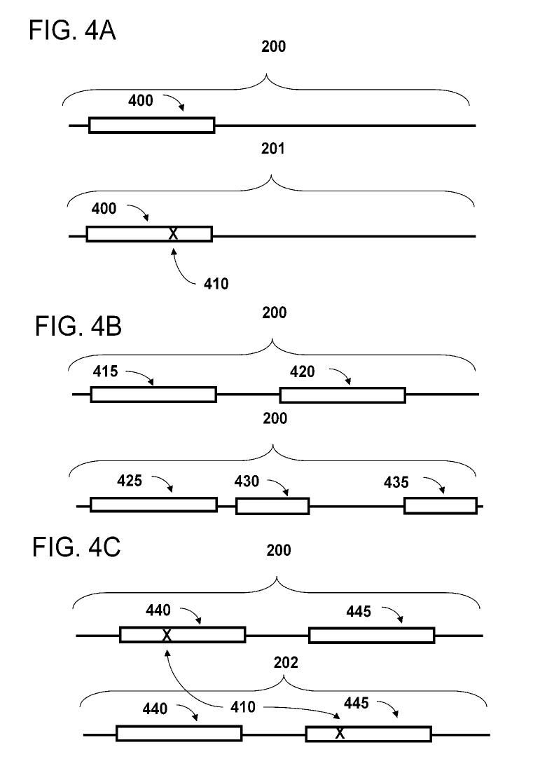

This situation is graphically depicted in FIG. 4A, wherein first partially double-stranded nucleic acid probe 200 represents the idealized binding sequence 400 (such as the native binding sequence) and partially double-stranded nucleic acid probe 201 includes mutation 410 of idealized binding sequence 400. While only a single site of mutation is shown, it is envisioned that multiple sites can be mutated either individually or in combination and these mutations can include point mutations, insertion, deletions, or a combination thereof. It also is envisioned that a library of such mutants can be made and contacted with one or more samples simultaneously. The double-stranded sequences used in the library can be variations on a sequence to which the double-stranded nucleic acid binding protein is known to bind, or alternatively, the sequences used in the library can be selected without knowledge of the binding specificity of the double-stranded nucleic acid binding protein. For example, using a library, a single sample could be screened to determine the sequence requirement of a specific double-stranded nucleic acid binding protein, such as a transcription factor. The identification of the sequence requirements of a double-stranded nucleic acid binding protein can include several factors such as the identification of an optimal binding sequence for the double-stranded nucleic acid binding protein, and/or the minimal sequence required for binding. Canonical sequences for double-stranded nucleic acid binding proteins, such as transcription factors, are well known in the art and can be found for example in the TRANSFAC® database of eukaryotic transcription factors.

Conventional methods for determining the binding sites of transcription factors, such as nucleic acid foot printing and any method that relies on the use of nucleases to digest unbound probes, can have undesirable effects, such as high background, for example due to incomplete digestion or the probes. To overcome the problems associated with conventional nuclease based methods, the methods disclosed herein use gel electrophoresis to separate the bound probes from the unbound probes, for example as disclosed in U.S. Provisional Patent Application 61/033,331, filed Mar. 3, 2008, which is incorporated herein by reference in its entirety, or other suitable gel electrophoresis technique. By isolating the bound probes from the unbound probes, the problems associated with the use of nucleases to “footprint” the binding of the transcription factors is minimized, if not eliminated. Furthermore, because the bound probes are isolated using gel electrophoresis, the separation of the bound probes can be visualized directly, for example on or in a gel, such as the electrophoresis gel used to separate the bound partially double-stranded probes from the unbound double-stranded probes. Thus, in some embodiments of the methods disclosed herein, the isolated probes are visualized in the electrophoresis gel, for example before hybridizing the partially double-stranded nucleic acid probe to a nucleic acid indexing probe. In some embodiments, the bound probes that are isolated by gel electrophoresis are at least 50% pure, such as at least 50%, at least 60%, at least 70%, at least 80% at least 90% at least 95%, or even at least 99% pure.

In addition, techniques that rely on enzymatic digestion to determine the binding sites of transcription factors suffer from the fact that the transcription factor binding reactions must be carried out in conditions suitable for nuclease digestion. Such conditions may not represent the natural in vivo conditions in which the transcription factors bind their binding sequences. Thus, the conditions used for enzymatic digestion may actually perturb the system such it may not be possible to determine the transcription factors present in a sample or the transcription factor binding sites with a high degree of accuracy. Thus, in some embodiments of the methods disclosed herein, a sample comprising a partially double-stranded nucleic acid probe is not contacted with an exogenous nuclease, for example the sample is not contacted with an exogenous exonuclease or a endonuclease. Thus, in some embodiments, the unbound probes are not digested with a nuclease, for example before hybridizing the partially double-stranded nucleic acid probe to a nucleic acid indexing probe.

### Identification of Double-Stranded DNA Binding Proteins

The disclosed methods are also suited for determining which double-stranded nucleic acid binding proteins are present in a sample, such as transcription factors and in particular activated transcription factors. In certain applications of the disclosed methods, a nucleic acid sequence is selected that a particular double-stranded nucleic acid binding protein is known to bind to, for example to determine if the double-stranded DNA binding protein is present in the sample, for example to determine if a particular transcription factor is expressed and/or activated such that it is capable of binding a particular sequence. Such a situation could be useful for diagnostic purposes and/or the screening of agents as double-stranded nucleic acid protein modulators. For example, the methods disclosed herein can be effectively used to screen for drugs that have a mechanism of action directly related to the expression and/or activation of transcription factors. Thus, in some embodiments, the double-stranded portion is selected to correspond to the known or predicted binding site of a double-stranded nucleic acid binding protein (sometimes referred to as the canonical binding site) such as a transcription factor, for example an activated transcription factor. By selecting a nucleic acid sequence specific for a particular double-stranded binding protein, such as a transcription factor, the sample can be assayed for the presence of the specific transcription factor, for example by detecting binding to the partially double-stranded nucleic acid probe with the specific binding site for the double-stranded nucleic acid binding protein.

The disclosed methods include contacting a sample including double-stranded nucleic acid binding proteins, such as transcription factors, with at least one partially double-stranded nucleic acid probe under conditions that permit binding between double-stranded binding proteins and partially double-stranded nucleic acid probes. The partially double-stranded nucleic acid probes disclosed herein include a first portion linked to a second portion. The first portion includes a single-stranded nucleic acid region of at least about 15 nucleotides in length with a unique index sequence, such as one of the unique indexing sequences as set forth in Table 16. The second portion of the partially double-stranded nucleic acid probe includes a double-stranded region of at least about 8 nucleotide base pairs in length that includes at least one binding site selected to bind a double-stranded nucleic acid binding protein, such as a transcription factor, for example an activated transcription factor.

After binding between the partially double-stranded nucleic acid probe and the double-stranded binding proteins, the partially double-stranded nucleic acid probe bound by at least one double-stranded nucleic acid binding protein is isolated using gel electrophoresis, for example using the methods disclosed in U.S. Provisional Patent Application 61/033,331, filed Mar. 3, 2008, which is incorporated herein by reference in its entirety, or other suitable gel electrophoresis technique. The isolated partially double-stranded nucleic acid probe is then hybridized to a nucleic acid indexing probe that includes a nucleic acid sequence complementary to the unique index sequence present in the single-stranded region of the partially double-stranded nucleic acid probe, for example an indexing probe including the indexing sequence set forth in Table 16. Detection of hybridization between the indexing probe and the partially double-stranded nucleic acid probe identifies the double-stranded nucleic binding protein present in the sample. In some embodiments of the methods disclosed herein, a sample comprising a partially double-stranded nucleic acid probe is not contacted with an exogenous nuclease. In some embodiments, the isolated partially double stranded nucleic acid probes are visualized in the electrophoresis gel, for example before hybridizing the partially double-stranded nucleic acid probe to a nucleic acid indexing probe. In some embodiments, the bound probes that are isolated by gel electrophoresis are at least 50% pure, such as at least 50%, at least 60%, at least 70%, at least 80% at least 90% at least 95%, or even at least 99% pure.

### Evaluation of Gene Promoters

The mechanisms underlying gene expression are complex and in some situations require the maneuvering of multiple double-stranded binding proteins to facilitate the expression of a single gene. This maneuvering can include the binding of transcription factors and cofactors, as well as the dissociation of other factors from gene promoters. The methods disclosed herein offer a unique opportunity to study the complex machinery of gene expression. For example, the double-stranded portion of the partially double-stranded nucleic acid probe can be selected to include multiple potential binding sites for double-stranded nucleic acid binding proteins, such as transcription factors. For example, the double-stranded portion can be selected to include more than one potential binding site such as 2, 3, 4, 5, 6, 7, 8, 9, 10, 11, 12, 13, 14, 15, or even more binding sites. With reference to FIG. 3B, partially double-stranded probe 200 can have two binding sites 415, 420, three binding sites 425, 430, 435, or more.

In some examples, the double-stranded protein is selected to correspond to the promoter of a known gene. Methods for identifying promoters are well known in the art and the sequences of promoters can be found in the Transcriptional Regulatory Element Database (TRED) maintained at Cold Spring Harbor Laboratory, USA. The potential binding sites can further be mutated to disable, partially or completely, the binding of double-stranded nucleic acid binding proteins that would normally bind to that site. Multiple versions can include mutating a binding site in several ways with different mutations, and/or mutating various combinations of the sites present on this portion of double-stranded nucleic acid. FIG. 3C shows one example, where different partially double-stranded probes 200, 202 are constructed to contain two binding sites 440, 445 and various mutations 410 are introduced to examine the effect of these mutations. This will enable exploration and identification of the binding properties of nuclear proteins that can interact with or influence each other or can bind differently depending on the properties of the surrounding double-stranded nucleic acid. In some examples, the promoter region is mutated to correspond to a naturally occurring single nucleotide polymorphism, for example a polymorphism shown to correspond to a particular disease or condition and/or a predisposition to a particular disease or condition, to determine the affect of the SNP on the binding of double-stranded binding proteins, such as transcription factors.

### Activity Maps of Transcription Factor Bind Sites

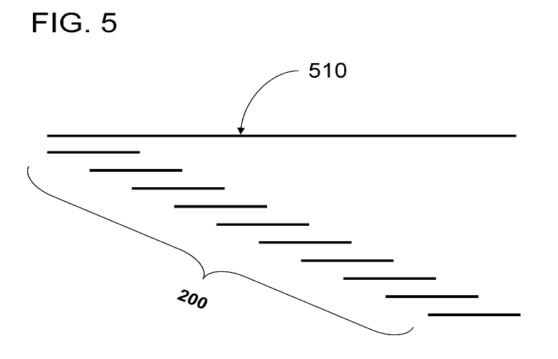

The disclosed methods can also be used to generate activity maps of transcription factor bind sites (AMTFBS). While it is believed that most double-stranded binding proteins responsible for transcriptional regulation bind to regions of DNA classified as promoters, additional proteins involved in transcriptional regulation bind outside of these regions, for example some known binding sites lie inside transcribed regions of genes or also as much as 10 kilobases from known promoter regions. With reference to FIG. 5, by selecting promoter 510 of a gene, or a group of genes, and constructing partially double-stranded nucleic acid probes 200 that effectively tile across the selected sequence, wherein double-stranded portion 205 corresponds to portions of promoter 510 it is possible to map the transcription factor binding sites throughout the entire promoter and beyond, for example by tiling past the boundaries of the promoter. Using such analysis, the active binding sites in the promoter area of selected genes can be identified. In addition, identification of transcription factors bound to such sites will determine which transcription factors may be involved in the regulation of the selected genes. AMTFBS will help to unfold the mechanisms and processes of diseases, classify disease states, and identify new or novel therapies that might arise through a better understanding and control of transcription factor activity. In one example, 40 base pair probes with 20 base pair overlap are designed to tile across a promoter of interest. This method can be used to identify proteins binding to double-stranded DNA regardless of the origin of the DNA, for example prokaryotic DNA, eukaryotic, and artificially created DNA.

### Correlation of Double-Stranded Binding Proteins to Disease States

The disclosed methods are also particularly suited to monitoring disease states, such as disease state in an organism, for example a plant or an animal subject, such as a mammalian subject, for example a human subject. It is understood by those of ordinary skill in the art that certain disease states may be caused by an unusual activity of double-stranded nucleic acid binding proteins, such as transcription factors. Certain disease states may be caused and/or characterized by the presence and/or activation of certain double-stranded DNA binding proteins, such as transcription factors. For example, certain double-stranded DNA binding proteins, such as transcription factors may be expressed in a diseased cell but not in a normal cell. In other examples, certain double-stranded DNA binding proteins, such as transcription factors may be expressed in a normal cell but not in diseased cell. Thus, using the disclosed methods a profile of the double-stranded DNA binding proteins present in a sample can be correlated with a disease state. Accordingly, aspects of the disclosed methods relate to correlating the presence of double-stranded nucleic acid binding proteins (such as transcription factors (for example activated transcription factors), or sigma factors) with a disease state, for example cancer, or an infection, such as a viral or bacterial infection. It is understood that a correlation to a disease state could be made for any organism, including without limitation plants, and animals, such as humans.

The methods for correlation of double-stranded proteins to a disease state include identifying a plurality of double-stranded binding proteins, such as transcription factors and/or sigma factor in a sample (such as a sample of diseased tissue, for example a sample of cells indicative of a disease state) using a library of partially double-stranded nucleic acid probes with different double-stranded binding protein binding sites, such as different transcription factor binding sites, sigma factor binding sites, or both; isolating the partially double-stranded nucleic acid probes from the library which form complexes with double-stranded binding protein from the sample; detecting the isolated partially double-stranded nucleic acid probes using indexing probes; and correlating the presence of a disease state based on which double-stranded binding protein are activated in the sample as identified by which partially double-stranded nucleic acid probes are isolated. In some embodiments, the profile obtained of double-stranded DNA biding proteins present in a sample is compared to a control, such as a normal cell, such as a cell from the same tissue type, or a standard indicative of basal levels of double-stranded DNA binding proteins.

The profile of double-stranded DNA binding proteins correlated with a disease can be used as a “fingerprint” to identify and/or diagnose a disease in a cell, by virtue of having a similar double-stranded DNA binding protein “fingerprint.” The profile of double-stranded DNA binding proteins can be used to identify binding proteins that are relevant in a disease state such as cancer, for example to identify particular double-stranded nucleic acid binding proteins as potential diagnostic and/or therapeutic targets. In addition, the profile of double-stranded DNA binding proteins can be used to monitor a disease state, for example to monitor the response to a therapy, disease progression and/or make treatment decisions for subjects.

### Diagnoses of Disease States

The ability to obtain a profile of double-stranded DNA biding proteins correlated with a disease state allows for the diagnosis of a disease state, for example by comparison of the profile of double-stranded DNA binding proteins, such as transcription factors, for example activated transcription factors, present in a sample with the with the profile of transcription factors correlated with a specific disease state, wherein a similarity in profile indicates a particular disease state. Accordingly, aspects of the disclosed methods relate to diagnosing a disease state based on the presence of double-stranded nucleic acid binding proteins (such as transcription factors, for example activated transcription factors, or sigma factors) that are correlated with a disease state, for example cancer, an inherited or an infection, such as a viral or bacterial infection. It is understood that a diagnosis of a disease state could be made for any organism, including without limitation plants, and animals, such as humans.

The methods include identifying a plurality of double-stranded binding proteins, such as transcription factors and/or sigma factor in the sample using a library of partially double-stranded nucleic acid probes with different double-stranded binding protein binding sites, such as different transcription factor binding sites, sigma factor binding sites, or both; isolating the partially double-stranded nucleic acid probes from the library which form complexes with double-stranded binding protein from the sample; detecting the isolated partially double-stranded nucleic acid probes using indexing probes; and diagnosing the disease state based on a correlation between the presence of a disease state and which double-stranded binding proteins are in the sample as identified by which partially double-stranded nucleic acid probes are isolated.

### Environmental Effects on Double-Stranded Binding Proteins

Aspects of the present disclosure relate to the correlation of an environmental stress with the presence of double-stranded nucleic acid binding proteins, for example a whole organism, or a sample, such as a sample of cells, for example a culture of cells, can be exposed to an environmental stress, such as but not limited to heat shock, osmolarity, hypoxia, cold, oxidative stress, radiation, starvation, a chemical (for example a therapeutic agent or potential therapeutic agent) and the like. After the stress is applied, a representative sample can be subjected to analysis of the double-stranded nucleic acid binding proteins present in the sample, for example at various time points, and compared to a control, such as a sample from an organism or cell, for example a cell from an organism, or a standard value indicative of basal levels of double-stranded nucleic acid binding proteins, such as transcription factors. The methods include identifying a plurality of double-stranded binding proteins, such as transcription factors and/or sigma factor in the sample using a library of partially double-stranded nucleic acid probes with different double-stranded binding protein binding sites, such as different transcription factor binding sites, sigma factor binding sites, or both; isolating the partially double-stranded nucleic acid probes from the library which form complexes with double-stranded binding protein from the sample; detecting the isolated partially double-stranded nucleic acid probes using indexing probes; and correlating the environmental stress with the presence of double-stranded binding proteins in the sample as identified by which partially double-stranded nucleic acid probes are isolated. In one example, the stress response of the lacrimal gland is determined.

### Screening for Modulators of Double-Stranded Nucleic Acid Binding Proteins

Because of the biological importance of double-stranded nucleic acid binding proteins (such as transcription factors, for example activated transcription factors, and sigma factors), they represent potential targets for therapies, such as drug therapies. The methods disclosed herein can be used to identify agents that modulate the activity of one or more double-stranded binding proteins, such as transcription factors, for example several different transcription factors. For example, the disclosed methods can be used to screen chemical libraries for agents that modulate one or more of several different transcription factors. In another example, the disclosed methods can be used to screen chemical libraries for agents that modulate one or more of several different sigma factors. By exposing cells, or fractions thereof (such as nuclear extract), tissues, or even whole animals, to different members of the chemical libraries, and performing the methods described herein, different members of a chemical library can be screened for their effect on multiple different double-stranded nucleic acid binding proteins simultaneously in a relatively short amount of time, for example using a high throughput method, such as the microarrays disclosed herein. By being able to screen multiple different double-stranded nucleic acid binding proteins (such as multiple different transcription factors) at the same time, is it possible to screen a large number of potential transcription modulators and to screen any potential transcription modulator relative to a large number of different double-stranded nucleic acid binding proteins (such as multiple different transcription factors). The ability to screen multiple different double-stranded nucleic acid binding proteins (such as multiple different transcription factors) at the same time enhances the high throughput capabilities of the disclosed method.

The ability to monitor multiple different double-stranded nucleic acid binding proteins (such as multiple different transcription factors) at the same time provides methods for rapidly screening for compounds that affect transcription factor activity, for example either by inhibiting or inducing a double-stranded nucleic acid binding proteins (such as transcription factors and/or sigma factors) to bind to a particular double-stranded DNA sequence, such as a sequence present in the promoter of a gene, for example to modulate the expression of that gene. Accordingly, methods are disclosed herein for identifying double-stranded nucleic acid binding protein modulators, for example transcription factor modulators. The disclosed methods include contacting a sample containing a least one double-stranded nucleic acid binding protein, such as a transcription factor, with a test agent and contacting the sample with at least one partially double-stranded nucleic acid probe under conditions that permit binding of double-stranded binding proteins and partially double-stranded nucleic acid probe. The partially double-stranded nucleic acid probe bound by at least one double-stranded nucleic acid binding protein is isolated using gel electrophoresis (for example using the methods disclosed in U.S. Provisional Patent Application 61/033,331 filed Mar. 3, 2008, which is incorporated herein by reference in its entirety) or other suitable gel electrophoresis technique, and the isolated partially double-stranded nucleic acid probe is hybridized to a nucleic acid indexing probe, such as an indexing probe that includes a nucleic acid sequence complementary to the unique index sequence present in the single-stranded region of the partially double-stranded nucleic acid probe. Detection of hybridization between the indexing probe and the partially double-stranded nucleic acid probe identifies double-stranded nucleic acid binding protein, such as a transcription factor, present in the sample and comparing the identified double-stranded nucleic acid binding protein present in the sample with a control, wherein a difference between the identified double-stranded nucleic acid binding protein present in the sample and the control identifies the test agent as a double-stranded nucleic acid binding protein modulator. A control can be a standard value, or alternatively a sample not treated with the agent.

As used herein, the term “double-stranded nucleic acid protein modulator” refers to any molecule or complex of more than one molecule that affects the regulatory region, for example synthetic small molecule, chemical compounds, chemical complexes, and salts thereof as well as screens for natural products, such as plant extracts or materials obtained from fermentation broths. In some embodiments, an agent is screening for desired or undesired effects on double-stranded nucleic acid proteins.

### Test Agents

In some embodiments, screening of test agents involves testing a combinatorial library containing a large number of potential modulator compounds. A combinatorial chemical library may be a collection of diverse chemical compounds generated by either chemical synthesis or biological synthesis, by combining a number of chemical “building blocks” such as reagents. For example, a linear combinatorial chemical library, such as a polypeptide library, is formed by combining a set of chemical building blocks (amino acids) in every possible way for a given compound length (for example the number of amino acids in a polypeptide compound). Millions of chemical compounds can be synthesized through such combinatorial mixing of chemical building blocks.

Appropriate agents can be contained in libraries, for example, synthetic or natural compounds in a combinatorial library. Numerous libraries are commercially available or can be readily produced; means for random and directed synthesis of a wide variety of organic compounds and biomolecules, including expression of randomized oligonucleotides, such as antisense oligonucleotides and oligopeptides, also are known. Alternatively, libraries of natural compounds in the form of bacterial, fungal, plant and animal extracts are available or can be readily produced. Additionally, natural or synthetically produced libraries and compounds are readily modified through conventional chemical, physical and biochemical means, and may be used to produce combinatorial libraries. Such libraries are useful for the screening of a large number of different compounds.

Preparation and screening of combinatorial libraries is well known to those of skill in the art. Libraries (such as combinatorial chemical libraries) useful in the disclosed methods include, but are not limited to, peptide libraries (see, e.g., U.S. Pat. No. 5,010,175; Furka, Int. J. Pept. Prot. Res., 37:487-493, 1991; Houghton et al., Nature, 354:84-88, 1991; PCT Publication No. WO 91/19735), (see, e.g., Lam et al., Nature, 354:82-84, 1991; Houghten et al., Nature, 354:84-86, 1991), and combinatorial chemistry-derived molecular library made of D-and/or L-configuration amino acids, phosphopeptides (including, but not limited to, members of random or partially degenerate, directed phosphopeptide libraries; see, e.g., Songyang et al., Cell, 72:767-778, 1993), antibodies (including, but not limited to, polyclonal, monoclonal, humanized, anti-idiotypic, chimeric or single chain antibodies, and Fab, F(ab′)₂ and Fab expression library fragments, and epitope-binding fragments thereof), small organic or inorganic molecules (such as, so-called natural products or members of chemical combinatorial libraries), molecular complexes (such as protein complexes), or nucleic acids, encoded peptides (e.g., PCT Publication WO 93/20242), random bio-oligomers (e.g., PCT Publication No. WO 92/00091), benzodiazepines (e.g., U.S. Pat. No. 5,288,514), diversomers such as hydantoins, benzodiazepines and dipeptides (Hobbs et al., Proc. Natl. Acad. Sci. USA, 90:6909-6913, 1993), vinylogous polypeptides (Hagihara et al., J. Am. Chem. Soc., 114:6568, 1992), nonpeptidal peptidomimetics with glucose scaffolding (Hirschmann et al., J. Am. Chem. Soc., 114:9217-9218, 1992), analogous organic syntheses of small compound libraries (Chen et al., J. Am. Chem. Soc., 116:2661, 1994), oligocarbamates (Cho et al., Science, 261:1303, 1003), and/or peptidyl phosphonates (Campbell et al., J. Org. Chem., 59:658, 1994), nucleic acid libraries (see Sambrook et al. Molecular Cloning, A Laboratory Manual, Cold Springs Harbor Press, N.Y., 1989; Ausubel et al., Current Protocols in Molecular Biology, Green Publishing Associates and Wiley Interscience, N.Y., 1989), peptide nucleic acid libraries (see, e.g., U.S. Pat. No. 5,539,083), antibody libraries (see, e.g., Vaughn et al., Nat. Biotechnol., 14:309-314, 1996; PCT App. No. PCT/US96/10287), carbohydrate libraries (see, e.g., Liang et al., Science, 274:1520-1522, 1996; U.S. Pat. No. 5,593,853), small organic molecule libraries (see, e.g., benzodiazepines, Baum, C&EN, January 18, page 33, 1993; isoprenoids, U.S. Pat. No. 5,569,588; thiazolidionones and methathiazones, U.S. Pat. No. 5,549,974; pyrrolidines, U.S. Pat. Nos. 5,525,735 and 5,519,134; morpholino compounds, U.S. Pat. No. 5,506,337; benzodiazepines, U.S. Pat. No. 5,288,514) and the like.

Libraries useful for the disclosed screening methods can be produced in a variety of manners including, but not limited to, spatially arrayed multipin peptide synthesis (Geysen, et al., Proc. Natl. Acad. Sci., 81(13):3998-4002, 1984), “tea bag” peptide synthesis (Houghten, Proc. Natl. Acad. Sci., 82(15):5131-5135, 1985), phage display (Scott and Smith, Science, 249:386-390, 1990), spot or disc synthesis (Dittrich et al., Bioorg. Med. Chem. Lett., 8(17):2351-2356, 1998), or split and mix solid phase synthesis on beads (Furka et al., Int. J. Pept. Protein Res., 37(6):487-493, 1991; Lam et al., Chem. Rev., 97(2):411-448, 1997).

Devices for the preparation of combinatorial libraries are also commercially available (see, e.g., 357 MPS, 390 MPS, Advanced Chem Tech, Louisville Ky., Symphony, Rainin, Woburn, Mass., 433A Applied Biosystems, Foster City, Calif., 9050 Plus, Millipore, Bedford, Mass.). In addition, numerous combinatorial libraries are themselves commercially available (see, for example, ComGenex, Princeton, N.J., Asinex, Moscow, Ru, Tripos, Inc., St. Louis, Mo., ChemStar, Ltd, Moscow, RU, 3D Pharmaceuticals, Exton, Pa., Martek Biosciences, Columbia, Md., etc.).

Libraries can include a varying number of compositions (members), such as up to about 100 members, such as up to about 1000 members, such as up to about 5000 members, such as up to about 10,000 members, such as up to about 100,000 members, such as up to about 500,000 members, or even more than 500,000 members.

In one example, the methods can involve providing a combinatorial chemical or peptide library containing a large number of potential therapeutic compounds. Such combinatorial libraries are then screened by the methods disclosed herein to identify those library members (particularly chemical species or subclasses) that display a desired characteristic activity.

The compounds identified using the methods disclosed herein can serve as conventional “lead compounds” or can themselves be used as potential or actual therapeutics. In some instances, pools of candidate agents can be identified and further screened to determine which individual or subpools of agents in the collective have a desired activity.

Control reactions can be performed in combination with the libraries. Such optional control reactions are appropriate and can increase the reliability of the screening. Accordingly, disclosed methods can include such a control reaction. The control reaction may be a negative control reaction that measures the transcription factor activity independent of a transcription modulator. The control reaction may also be a positive control reaction that measures transcription factor activity in view of a known transcription modulator.

Compounds identified by the disclosed methods can be used as therapeutics or lead compounds for drug development for a variety of conditions. Because gene expression is fundamental in all biological processes, including cell division, growth, replication, differentiation, repair, infection of cells, etc., the ability to monitor transcription factor activity and identify compounds which modulator their activity can be used to identify drug leads for a variety of conditions, including neoplasia, inflammation, allergic hypersensitivity, metabolic disease, genetic disease, viral infection, bacterial infection, fungal infection, or the like. In addition, compounds identified that specifically target transcription factors in undesired organisms, such as viruses, fungi, agricultural pests, or the like, can serve as fungicides, bactericides, herbicides, insecticides, and the like. Thus, the range of conditions that are related to transcription factor activity includes conditions in humans and other animals, and in plants, such as agricultural applications.

### Samples

Appropriate samples for use in the methods disclosed herein include any conventional biological sample for which information about double-stranded nucleic acid binding proteins is desired. Samples include those obtained from, excreted by or secreted by any living organism, such as a prokaryotic organism or a eukaryotic organism including without limitation, multicellular organisms (such as plants and animals, including samples from a healthy or apparently healthy human subject or a human patient affected by a condition or disease to be diagnosed or investigated, such as cancer), clinical samples obtained from a human or veterinary subject, for instance blood or blood-fractions, biopsied tissue. Standard techniques for acquisition of such samples are available. See, for example Schluger et al., J. Exp. Med. 176:1327-33 (1992); Bigby et al., Am. Rev. Respir. Dis. 133:515-18 (1986); Kovacs et al., NEJM 318:589-93 (1988); and Ognibene et al., Am. Rev. Respir. Dis. 129:929-32 (1984). Biological samples can be obtained from any organ or tissue (including a biopsy or autopsy specimen, such as a tumor biopsy) or can comprise a cell (whether a primary cell or cultured cell) or medium conditioned by any cell, tissue or organ. In some embodiments, a biological sample is a nuclear extract. Nuclear extract contains many of the proteins contained in the nucleus of a cell, and includes for example transcription factors, such as activated transcription factors. Methods for obtaining a nuclear extract are well known in the art and can be found for example in Dignam, Nucleic Acids Res., 11(5):1475-89 1983.

### Isolation of Protein Nucleic Acid Complexes

One of ordinary skill in the art will appreciate that any gel electrophoresis technique can be employed to isolate a partially double-stranded nucleic acid probe bound by at least one double-stranded nucleic acid binding protein so long as the bound partially double-stranded nucleic acid probes can be separated from unbound partially double-stranded nucleic acid probes. Isolation of the protein bound partially double-stranded nucleic acid probe does not require absolute purity, for example isolated does not imply that the biological component is free of trace contamination, and can include at least 50% isolated, such as at least 75%, 80%, 90%, 95%, 98%, 99%, or even 100% isolated.

Techniques for the isolation of protein-nucleic acid complexes, such as protein bound partially double-stranded nucleic acid probes, are well known in the art. Examples of techniques that can be used with the disclosed methods include without limitation, gel separation techniques, such as gel electrophoresis, for example polyacrylamide gel electrophoresis, agarose gel electrophoresis, or a combination thereof, capillary electrophoresis, and chromatography techniques such as column chromatography, ion exchange chromatography, gel chromatography, such as gel filtration chromatography, size exclusion chromatography, affinity chromatography and the like. In some examples, a bound partially double-stranded nucleic acid probe is isolated using polyacrylamide gel electrophoresis. In some examples, a partially double-stranded nucleic acid probe bound by at least one double-stranded nucleic acid binding protein is isolated the methods disclosed in U.S. Provisional Patent Application 61/033,331 filed Mar. 3, 2008, which is incorporated herein by reference in its entirety.

In some embodiments, the partially double-stranded nucleic acid probe with bound protein is isolated using an antibody, for example an antibody that specifically binds a double-stranded nucleic acid binding protein, such as a transcription factor. By way of example, a protein bound partially double-stranded nucleic acid probe can be contacted with an antibody that recognizes a transcription factor of interest and isolated using routine methods. The isolated double-stranded nucleic acid probes can be analyzed, thereby determining the sequences bound by the transcription factor of interest.

### Identification of Proteins

Some embodiments of the disclosed methods involve determining the identity of the double-stranded nucleic acid binding proteins bound to the isolated double-stranded nucleic acid probe and determining the identity of the isolated double-stranded binding protein. For example, the double-stranded DNA binding protein can be identified by any method that allows for the detection and/or identification of proteins. Exemplary methods include identifying double-stranded binding proteins using a specific binding agent, such as an antibody, for example by detecting a complex between the isolated double-stranded binding protein and an antibody. Other methods for the detection and identification of a protein, such as a double-stranded binding protein, include mass spectrometric methods.

The application of mass spectrometric techniques to identify proteins in biological samples is known in the art and is described for example in Akhilesh et al., Nature, 405:837-846, 2000; Dutt et al., Curr. Opin. Biotechnol., 11:176-179, 2000; Gygi et al., Curr. Opin. Chem. Biol., 4 (5): 489-94, 2000; Gygi et al., Anal. Chem., 72 (6): 1112-8, 2000; and Anderson et al., Curr. Opin. Biotechnol., 11:408-412, 2000.

Enzymatic digestion of complex mixtures of proteins followed by mass spectrometric based analysis of the digest is well known in the art (see for example, U.S. Pat. No. 6,940,065 and J. Protein Chem., 16: 495-497, 1997). Typically, the sample containing isolated double-stranded DNA binding proteins is subjected to proteolytic digestion, such as enzymatic digestion for example digestion with a serine protease such as trypsin amongst others to generate fragment peptides. In certain embodiments, the double-stranded binding proteins are detected with mass spectrometry, for example with tandem mass spectrometry. It some embodiments, the double-stranded binding proteins are detected by detection of ion fragments generated from the double-stranded binding proteins (for example by collision using tandem mass spectrometry).

Mass spectrometers generate gas phase ions from a sample (such as a sample containing double-stranded binding proteins, for example transcription factors such as activated transcription factors). The gas phase ions are then separated according to their mass-to-charge ratio (m/z) and detected. Suitable techniques for producing vapor phase ions for use in the disclosed methods include without limitation electrospray ionization (ESI), matrix-assisted laser desorption-ionization (MALDI), surface-enhanced laser desorption-ionization (SELDI), chemical ionization, and electron-impact ionization (EI).

Separation of ions according to their m/z ratio can be accomplished with any type of mass analyzer, including quadrupole mass analyzers (Q), time-of-flight (TOF) mass analyzers (for example linear or reflecting) analyzers, magnetic sector mass analyzers, 3D and linear ion traps (IT), Fourier-transform ion cyclotron resonance (FT-ICR) analyzers, and combinations thereof (for example, a quadrupole-time-of-flight analyzer, or Q-TOF analyzer).

In some embodiments, the mass spectrometric technique is tandem mass spectrometry (MS/MS) and the presence of peptide fragment from a double-stranded-DNA binding protein derived is detected, for example a fragment generated from an enzymatic digestion. Typically, in tandem mass spectrometry a fragment peptide entering the tandem mass spectrometer is selected and subjected to collision induced dissociation (CID). The spectra of the resulting fragment ion is recorded in the second stage of the mass spectrometry, as a so-called CID spectrum. Because the CID process usually causes fragmentation at peptide bonds and different amino acids for the most part yield peaks of different masses, a CID spectrum alone often provides enough information to determine the presence of a peptide. Suitable mass spectrometer systems for MS/MS include an ion fragmentor and one, two, or more mass spectrometers, such as those described above. Examples of suitable ion fragmentors include, but are not limited to, collision cells (in which ions are fragmented by causing them to collide with neutral gas molecules), photo dissociation cells (in which ions are fragmented by irradiating them with a beam of photons), and surface dissociation fragmentor (in which ions are fragmented by colliding them with a solid or a liquid surface). Suitable mass spectrometer systems can also include ion reflectors.

Prior to mass spectrometry, the sample can be subjected to one or more dimensions of chromatographic separation, for example, one or more dimensions of liquid or size exclusion chromatography. Representative examples of chromatographic separation include paper chromatography, thin layer chromatography (TLC), liquid chromatography, column chromatography, fast protein liquid chromatography (FPLC), ion exchange chromatography, size exclusion chromatography, affinity chromatography, high performance liquid chromatography (HPLC), nano-reverse phase liquid chromatography (nano-RPLC), poly acrylamide gel electrophoresis (PAGE), capillary electrophoresis (CE), reverse phase high performance liquid chromatography (RP-HPLC) or other suitable chromatographic techniques. Thus, in some embodiments, the mass spectrometric technique is directly or indirectly coupled with a liquid chromatography technique, such as column chromatography, fast protein liquid chromatography (FPLC), ion exchange chromatography, size exclusion chromatography, affinity chromatography, high performance liquid chromatography (HPLC), nano-reverse phase liquid chromatography (nano-RPLC), poly acrylamide gel electrophoresis (PAGE), capillary electrophoresis (CE) or reverse phase high performance liquid chromatography (RP-HPLC).

### Double-Stranded Nucleic Acid Binding Proteins

Double-stranded nucleic acid binding proteins, such a double-stranded DNA binding proteins, are proteins capable of binding to double-stranded nucleic acids, such as double-stranded DNA. In some examples, a double-stranded nucleic acid binding protein is a double-stranded DNA binding protein and minimally contains a domain capable of binding double-stranded DNA. Particular examples of double-stranded DNA binding proteins include proteins that affect the transcription of RNA, such as transcription factors in eukaryotic organism and sigma factors in prokaryotic organism.

### Transcription Factors

A transcription factor is a protein found in eukaryotic organisms that works in concert with other proteins to either promote or suppress the transcription of genes. Transcription factors and are believed to control when and where genes (and the proteins encoded by those genes) are expressed. Transcription factors regulate the binding of RNA polymerase to DNA and control the subsequent translation of DNA into messenger RNA and eventually protein. Transcription factors bind to specific sequences of DNA upstream or downstream to the gene they regulate and then either enhance or repress transcription of these genes by assisting or blocking RNA polymerase binding respectively. A cluster of transcription factors is the preinitiation complex (PIC) that recruits and activates RNA polymerase. Conversely, repressor transcription factors inhibit transcription by blocking the attachment of activator proteins.

Transcription factors contain a double-stranded DNA binding domain which binds to specific DNA sequences, for example gene specific regulatory sites, such as promoter sequences. In some examples, transcription factors contain a second domain that sense external signals and in response transmit these signals to the rest of the transcription complex resulting in up or down regulation of gene expression. In examples, the double-stranded DNA binding domain and signal sensing domains reside on separate proteins that associate within the transcription complex to regulate gene expression. Additional proteins such as coactivators, chromatin remodelers, histone acetylases, deacetylases, kinases, and methylases, while also playing crucial roles in gene regulation, lack DNA binding domains, and therefore are not classified as transcription factors. It is believed that some of the sequence specificity of transcription factors comes from the proteins making multiple contacts to the edges of the DNA bases, effectively allowing them to “read” the DNA sequence.

An activated transcription factor is a transcription factor that has been activated by a stimulus resulting in a measurable change in the state of the transcription factor, for example a post-translational modification, such as phosphorylation, methylation, and the like. Activation of a transcription factor can result in a change in the affinity of or specific binding for a particular DNA sequence or of a particular protein, such as another transcription factor and/or cofactor.

### Sigma Factors

Sigma factors (σ factors) are prokaryotic transcription factors that are part of RNA polymerase (RNAP) for specific binding to promoter sites on DNA. The bacterial core RNA polymerase complex, which consists of five subunits (ββ′α2ω) is sufficient for transcription elongation and termination but is unable to initiate transcription. Transcription initiation from promoter elements requires a sixth, dissociable subunit called a a factor, which reversibly associates with the core RNA polymerase complex to form a holoenzyme. The vast majority of σ factors belong to the so-called σ70 family, reflecting their relationship to the principal σ factor of Escherichia coli (E. coli) σ70.

Different sigma factors are activated in response to different environmental conditions, for example stresses, such as starvation. E. coli has at least eight sigma factors; the number of sigma factors varies between bacterial species. All sigma factors are distinguished by their characteristic molecular weights. For example, σ70 refers to the sigma factor with a molecular weight of 70 kDa. E. coli sigma factors include: σ70 (RpoD)—the “housekeeping” sigma factor, controls the transcription of most genes in growing cells, for example directing the transcription the proteins that are necessary to keep the cell alive. Other E. coli sigma factors include σ54 (RpoN), the nitrogen-limitation sigma factor; σ38 (RpoS), the starvation/stationary phase sigma factor; σ32 (RpoH), the heat shock sigma factor; σ28 (RpoF), the flagellar sigma factor; σ24 (RpoE), the extracytoplasmic/extreme heat stress sigma factor; and σ19 (Fed), the ferric citrate sigma factor, which regulates the fec gene for iron transport. In the regulation of gene expression in prokaryotes, anti-sigma factors bind to sigma factors and inhibit their transcriptional activity.

### Indexing Arrays

An indexing array containing a plurality of heterogeneous index probes for the detection of and identification of partially double-stranded nucleic acid probes is disclosed. Such arrays can be used to rapidly detect and/or identify the sequence to which a double-stranded nucleic acid binding protein binds and/or identify and/or detect a double-stranded nucleic acid binding protein, such as a transcription factor. For example, the arrays can be used to evaluate the sequence requirements for a particular transcription factor or even to identify a plurality of transcription factors bound to the promoter of a gene of interest.

The arrays disclosed herein are arrangements of addressable locations on a substrate, with each address containing a nucleic acid, such as an index probe. In some embodiments, each address corresponds to a single type or class of nucleic acid, such as a single index probe, though a particular index probe may be redundantly contained at multiple addresses. A “microarray” is a miniaturized array requiring microscopic examination for detection of hybridization. Larger “macroarrays” allow each address to be recognizable by the naked human eye and, and in some embodiments, a hybridization signal is detectable without additional magnification. The addresses may be labeled, keyed to a separate guide, or otherwise identified by location.

In some embodiments, with reference to FIG. 3A, indexing array 300 is a collection of separate indexing probes 110 attached to solid support 310 at array addresses, for example array addresses A, B, C, D, E, F, G, H, etc. With reference to FIG. 3B, indexing array 300 is contacted with a sample containing isolated partially double-stranded nucleic acid probes 200 under conditions allowing for the formation of hybridization complex 250 between the indexing probe 110 and partially double-stranded nucleic acid probes 200 in the sample. A hybridization signal from an individual address on the index array indicates that the index probe hybridizes to a partially double-stranded nucleic acid probe within the sample and identifies this partially double-stranded nucleic acid probe as one to which a double-stranded protein is or was bound to. This system permits the simultaneous analysis of a sample by plural partially double-stranded nucleic acid probes and yields information that can be used to identify the sequence requirements and/or double-stranded binding proteins present in the sample. The partially double-stranded nucleic probes may be added to an array substrate in dry or liquid form, although liquid form is typically preferred. Other compounds or substances may be added to the array as well, such as buffers, stabilizers, reagents for detecting hybridization signal, emulsifying agents, or preservatives. In some embodiments, as exemplified by FIG. 3C, a double-stranded nucleic acid protein 260 is bound to the partially double-stranded nucleic acid probe 200, thereby facilitating subsequent analysis of the double-stranded binding protein, for example to identify the double-stranded binding protein.

In certain examples, the indexing array includes one or more molecules or samples occurring on the array a plurality of times (twice or more) to provide an added feature to the indexing array, such as redundant activity or to provide internal controls.

Indexing arrays may vary in structure, composition, and intended functionality, and may be based on either a macroarray or a microarray format, or a combination thereof. Such arrays can include, for example, at least 10, at least 25, at least 50, at least 100, or more addresses, usually with a single type of nucleic acid at each address.

Within an array, each arrayed nucleic acid is addressable, such that its location may be reliably and consistently determined within the at least the two dimensions of the array surface. Thus, ordered arrays allow assignment of the location of each nucleic acid at the time it is placed within the array. Usually, an array map or key is provided to correlate each address with the appropriate nucleic acid. Ordered arrays are often arranged in a symmetrical grid pattern, but indexing probes could be arranged in other patterns (for example, in radially distributed lines, a “spokes and wheel” pattern, or ordered clusters). Addressable arrays can be computer readable; a computer can be programmed to correlate a particular address on the array with information about the sample at that position, such as hybridization or binding data, including signal intensity. In some exemplary computer readable formats, the individual samples or molecules in the array are arranged regularly (for example, in a Cartesian grid pattern), which can be correlated to address information by a computer.

An address within the array may be of any suitable shape and size. In some embodiments, the nucleic acids are suspended in a liquid medium and contained within square or rectangular wells on the array substrate. However, the nucleic acids may be contained in regions that are essentially triangular, oval, circular, or irregular. The overall shape of the array itself also may vary, though in some embodiments it is substantially flat and rectangular, square, or even substantial circular (such as ovoid) in shape.

### Array Substrate

For an indexing array formed on a solid support, the solid support can be formed from an organic polymer. Suitable materials for the solid support include, but are not limited to: polypropylene, polyethylene, polybutylene, polyisobutylene, polybutadiene, polyisoprene, polyvinylpyrrolidine, polytetrafluroethylene, polyvinylidene difluroide, polyfluoroethylene-propylene, polyethylenevinyl alcohol, polymethylpentene, polycholorotrifluoroethylene, polysulfornes, hydroxylated biaxially oriented polypropylene, aminated biaxially oriented polypropylene, thiolated biaxially oriented polypropylene, etyleneacrylic acid, thylene methacrylic acid, and blends of copolymers thereof (see U.S. Pat. No. 5,985,567). Other examples of suitable substrates for the arrays disclosed herein include glass (such as functionalized glass), Si, Ge, GaAs, GaP, SiO₂, SiN₄, modified silicon nitrocellulose, polystyrene, polycarbonate, nylon, fiber, or combinations thereof. Array substrates can be stiff and relatively inflexible (for example glass or a supported membrane) or flexible (such as a polymer membrane). One commercially available product line suitable for probe arrays described herein is the Microlite line of MICROTITER® plates available from Dynex Technologies UK (Middlesex, United Kingdom), such as the Microlite 1+96-well plate, or the 384 Microlite+384-well plate.

In general, suitable characteristics of the material that can be used to form the solid support surface include: being amenable to surface activation such that upon activation, the surface of the support is capable of covalently attaching a biomolecule, such as an oligonucleotide thereto; amenability to “in situ” synthesis of biomolecules; being chemically inert such that at the areas on the support not occupied by the oligonucleotides are not amenable to non-specific binding, or when non-specific binding occurs, such materials can be readily removed from the surface without removing the oligonucleotides.

In one example, the solid support surface is polypropylene. Polypropylene is chemically inert and hydrophobic. Non-specific binding is generally avoidable, and detection sensitivity is improved. Polypropylene has good chemical resistance to a variety of organic acids (such as formic acid), organic agents (such as acetone or ethanol), bases (such as sodium hydroxide), salts (such as sodium chloride), oxidizing agents (such as peracetic acid), and mineral acids (such as hydrochloric acid). Polypropylene also provides a low fluorescence background, which minimizes background interference and increases the sensitivity of the signal of interest.

In another example, a surface activated organic polymer is used as the solid support surface. One example of a surface activated organic polymer is a polypropylene material aminated via radio frequency plasma discharge. Such materials are easily utilized for the attachment of nucleotide molecules. The amine groups on the activated organic polymers are reactive with nucleotide molecules such that the nucleotide molecules can be bound to the polymers. Other reactive groups can also be used, such as carboxylated, hydroxylated, thiolated, or active ester groups.

### Array Formats

A wide variety of array formats can be employed in accordance with the present disclosure. One example includes a linear array of indexing probe bands, generally referred to in the art as a dipstick. Another suitable format includes a two-dimensional pattern of discrete cells (such as 4096 squares in a 64 by 64 array). As is appreciated by those skilled in the art, other array formats including, but not limited to slot (rectangular) and circular arrays are equally suitable for use (see for example U.S. Pat. No. 5,981,185). In one example, the array is formed on a polymer medium, which is a thread, membrane or film. An example of an organic polymer medium is a polypropylene sheet having a thickness on the order of about 1 mil. (0.001 inch) to about 20 mil., although the thickness of the film is not critical and can be varied over a fairly broad range.

The array formats of the present disclosure can be included in a variety of different types of formats. A “format” includes any format to which the solid support can be affixed, such as microtiter plates, test tubes, inorganic sheets, dipsticks, and the like. For example, when the solid support is a polypropylene thread, one or more polypropylene threads can be affixed to a plastic dipstick-type device; polypropylene membranes can be affixed to glass slides. The particular format is, in and of itself, unimportant. All that is necessary is that the solid support can be affixed thereto without affecting the functional behavior of the solid support or any biopolymer absorbed thereon, and that the format (such as the dipstick or slide) is stable to any materials into which the device is introduced (such as clinical samples and hybridization solutions).

The arrays of the present disclosure can be prepared by a variety of approaches. In one example, indexing probes are synthesized separately and then attached to a solid support (see for example U.S. Pat. No. 6,013,789). In another example, sequences are synthesized directly onto the support to provide the desired array (see for example U.S. Pat. No. 5,554,501). Suitable methods for covalently coupling indexing probes to a solid support and for directly synthesizing the oligonucleotides on the support are known to those working in the field; a summary of suitable methods can be found in Matson et al., Anal. Biochem. 217:306-10, 1994. In one example, the indexing probes are synthesized onto the support using conventional chemical techniques for preparing oligonucleotides on solid supports (such as PCT applications WO 85/01051 and WO 89/10977, or U.S. Pat. No. 5,554,501).

A suitable array can be produced using automated means to synthesize indexing probes in the cells of the array by laying down the precursors for the four bases in a predetermined pattern. Briefly, a multiple-channel automated chemical delivery system is employed to create indexing probe populations in parallel rows (corresponding in number to the number of channels in the delivery system) across the substrate. Following completion of oligonucleotide synthesis in a first direction, the substrate can then be rotated by 90° to permit synthesis to proceed within a second (2°) set of rows that are now perpendicular to the first set. This process creates a multiple-channel array whose intersection generates a plurality of discrete cells.

The indexing probes can be bound to the polypropylene support by either the 3′ end of the oligonucleotide or by the 5′ end of the oligonucleotide. In one example, the indexing probes are bound to the solid support by the 3′ end. However, one of skill in the art can determine whether the use of the 3′ end or the 5′ end of the indexing probe is suitable for bonding to the solid support. In general, the internal complementarity of an indexing probe in the region of the 3′ end and the 5′ end determines binding to the support.

In particular examples, the indexing probes on the array include one or more labels that permit detection of indexing probe:partially double-stranded nucleic acid probe hybridization complexes. Addresses in an array can be of a relatively large size, such as large enough to permit detection of a hybridization signal without the assistance of a microscope or other equipment. Thus, addresses can be as small as about 0.1 mm across, with a separation of about the same distance. Alternatively, addresses can be about 0.5, 1, 2, 3, 5, 7, or 10 mm across, with a separation of a similar or different distance. Larger addresses (larger than 10 mm across) are employed in certain embodiments. The overall size of the array is generally correlated with size of the addresses (for example, larger addresses will usually be found on larger arrays, while smaller addresses can be found on smaller arrays). Such a correlation is not necessary, however.

The arrays herein can be described by their densities (the number of addresses in a certain specified surface area). For macroarrays, array density can be about one address per square decimeter (or one address in a 10 cm by 10 cm region of the array substrate) to about 50 addresses per square centimeter (50 targets within a 1 cm by 1 cm region of the substrate). For microarrays, array density will usually be one or more addresses per square centimeter, for instance, about 50, about 100, about 200, about 300, about 400, about 500, about 1000, about 1500, about 2,500, or more addresses per square centimeter.

The use of the term “array” includes the arrays found in DNA microchip technology. As one, non-limiting example, the probes could be contained on a DNA microchip similar to the GENECHIP® products and related products commercially available from Affymetrix, Inc. (Santa Clara, Calif.). Briefly, a DNA microchip includes a miniaturized, high-density array of probes on a glass wafer substrate.

Particular probes are selected, and photolithographic masks are designed for use in a process based on solid-phase chemical synthesis and photolithographic fabrication techniques similar to those used in the semiconductor industry. The masks are used to isolate chip exposure sites, and probes are chemically synthesized at these sites, with each probe in an identified location within the array. After fabrication, the array is ready for hybridization. The probe or the nucleic acid within the sample can be labeled, such as with a fluorescent label and, after hybridization, the hybridization signals can be detected and analyzed.

Methods for labeling nucleic acid molecules and proteins so that they can be detected are well known. Examples of such labels include non-radiolabels and radiolabels. Non-radiolabels include, but are not limited to enzymes, chemiluminescent compounds, fluorophores, metal complexes, haptens, colorimetric agents, dyes, or combinations thereof. Radiolabels include, but are not limited to, ¹²⁵I and ³⁵S. Radioactive and fluorescent labeling methods, as well as other methods known in the art, are suitable for use with the present disclosure.

The hybridization conditions are selected to permit discrimination between matched and mismatched oligonucleotides. Hybridization conditions can be chosen to correspond to those known to be suitable in standard procedures for hybridization to filters and then optimized for use with the arrays of the disclosure. For example, conditions suitable for hybridization of one type of target would be adjusted for the use of other targets for the array. In particular, temperature is controlled to substantially eliminate formation of duplexes between sequences other than exactly complementary to indexing probe sequences. A variety of known hybridization solvents can be employed, the choice being dependent on considerations known to one of skill in the art (see U.S. Pat. No. 5,981,185).

Once the partially double-stranded nucleic acid probes have been hybridized with the indexing probes present in the indexing array, the presence of the hybridization complex can be analyzed, for example by detecting the complexes.

Detecting a hybridized complex in an array of oligonucleotide probes has been previously described (see U.S. Pat. No. 5,985,567). In one example, detection includes detecting one or more labels present on the indexing probes, the partially double-stranded nucleic acid probes sequences, or both. In particular examples, developing includes applying a buffer. In one example, the buffer is sodium saline citrate, sodium saline phosphate, tetramethylammonium chloride, sodium saline citrate in ethylenediaminetetra-acetic, sodium saline citrate in sodium dodecyl sulfate, sodium saline phosphate in ethylenediaminetetra-acetic, sodium saline phosphate in sodium dodecyl sulfate, tetramethylammonium chloride in ethylenediaminetetra-acetic, tetramethylammonium chloride in sodium dodecyl sulfate, or combinations thereof. However, other suitable buffer solutions can also be used.

Detection can further include treating the hybridized complex with a conjugating solution to effect conjugation or coupling of the hybridized complex with the detection label, and treating the conjugated, hybridized complex with a detection reagent. In one example, the conjugating solution includes streptavidin alkaline phosphatase, avidin alkaline phosphatase, or horseradish peroxidase. Specific, non-limiting examples of conjugating solutions include streptavidin alkaline phosphatase, avidin alkaline phosphatase, or horseradish peroxidase. The conjugated, hybridized complex can be treated with a detection reagent. In one example, the detection reagent includes enzyme-labeled fluorescence reagents or calorimetric reagents. In one specific non-limiting example, the detection reagent is enzyme-labeled fluorescence reagent (ELF) from Molecular Probes, Inc. (Eugene, Oreg.). The hybridized complex can then be placed on a detection device, such as an ultraviolet (UV) transilluminator. The signal is developed and the increased signal intensity can be recorded with a recording device, such as a charge coupled device (CCD) camera (manufactured by Photometrics, Inc. of Tucson, Ariz.). In particular examples, these steps are not performed when fluorophores or radiolabels are used.

### Kits

The nucleic acid probes (such as the partially double-stranded probes and indexing probes) disclosed herein can be supplied in the form of a kit for use in the identification of double-stranded binding proteins, binding sites for such proteins and for the screening of agents that modulate such binding amongst other uses, including kits for any of the arrays described above. In such a kit, an appropriate amount of one or more of the nucleic acid probes is provided in one or more containers or held on a substrate. In such a kit, an appropriate amount of one or more of the nucleic acid probes is provided in one or more containers or held on a substrate. A nucleic acid probe and/or primer can be provided suspended in an aqueous solution or as a freeze-dried or lyophilized powder, for instance. The container(s) in which the nucleic acid(s) are supplied can be any conventional container that is capable of holding the supplied form, for instance, microfuge tubes, ampoules, or bottles. The kits can include either labeled or unlabeled nucleic acid probes.

The disclosed kits include at least one partially double-stranded nucleic acid probe and an indexing probe with a single-stranded nucleic acid sequence complementary to the unique index sequence present in single-stranded region of the partially double-stranded nucleic acid probe. In particular examples, the indexing probes are immobilized on solid support for example attached to an array, such as a microarray.

The kit can further include one or more of a buffer solution, a conjugating solution for developing the signal of interest, or a detection reagent for detecting the signal of interest, each in separate packaging, such as a container. In another example, the kit includes a plurality of different partially double-stranded nucleic acids probes each with a unique indexing sequence and a plurality of indexing probes capable of hybridizing to the unique indexing sequence. A kit can contain more than one different probe, such as at least 2, 3, 4, 5, 6, 7, 8, 9, 10, 11, 12, 13, 14, 15, 20, 25, 50, 100, or more probes.

Kits also are provided that contain reagents to detect hybridization complexes formed between partially double-stranded nucleic acid probes and the indexing probe, for example when the indexing probe is arrayed in an indexing array. These kits can each include instructions, for instance instructions that provide calibration curves or charts to compare with the determined (such as experimentally measured) values. The probes provided with the kits can be labeled, for example, with a radioactive isotope, enzyme substrate, co-factor, ligand, chemiluminescent or fluorescent agent, hapten, or enzyme.

The container(s) in which the oligonucleotide(s) are supplied can be any conventional container that is capable of holding the supplied form, for instance, microfuge tubes, ampoules, or bottles. In some applications, the probes are provided in pre-measured single use amounts in individual, typically disposable, tubes, or equivalent containers.

Additional components in some kits include instructions for carrying out the assay. Instructions permit the tester to determine whether expression levels are elevated, reduced, or unchanged in comparison to a control sample. Reaction vessels and auxiliary reagents, such as chromogens, buffers, enzymes, etc., can also be included in the kits.

The instructions can include directions for obtaining a sample, processing the sample, preparing the probes, and/or contacting each probe with an aliquot of the sample. In certain embodiments, the kit includes an apparatus for separating the different probes, such as individual containers (for example, microtubules) or an array substrate (such as, a 96-well or 384-well microtiter plate). In particular embodiments, the kit includes prepackaged probes, such as probes suspended in suitable medium in individual containers (for example, individually sealed EPPENDORF® tubes) or the wells of an array substrate (for example, a 96-well microtiter plate sealed with a protective plastic film). In other particular embodiments, the kit includes equipment, reagents, and instructions for extracting and/or purifying nucleotides from a sample. Kits can also include the reagent for making a nuclear extract

### Synthesis of Oligonucleotide Primers and Probes

Methods for the synthesis of oligonucleotides are well known to those of ordinary skill in the art; such methods can be used to produce probes for the disclosed methods. The most common method for in vitro oligonucleotide synthesis is the phosphoramidite method, formulated by Letsinger and further developed by Caruthers (Caruthers et al., Chemical synthesis of deoxyoligonucleotides, in Methods Enzymol. 154:287-313, 1987). This is a non-aqueous, solid phase reaction carried out in a stepwise manner, wherein a single nucleotide (or modified nucleotide) is added to a growing oligonucleotide. The individual nucleotides are added in the form of reactive 3′-phosphoramidite derivatives. See also, Gait (Ed.), Oligonucleotide Synthesis. A practical approach, IRL Press, 1984.

In general, the synthesis reactions proceed as follows: A dimethoxytrityl or equivalent protecting group at the 5′ end of the growing oligonucleotide chain is removed by acid treatment. (The growing chain is anchored by its 3′ end to a solid support, such as a silicon bead.) The newly liberated 5′ end of the oligonucleotide chain is coupled to the 3′-phosphoramidite derivative of the next deoxynucleoside to be added to the chain, using the coupling agent tetrazole. The coupling reaction usually proceeds at an efficiency of approximately 99%; any remaining unreacted 5′ ends are capped by acetylation so as to block extension in subsequent couplings. Finally, the phosphite triester group produced by the coupling step is oxidized to the phosphotriester, yielding a chain that has been lengthened by one nucleotide residue. This process is repeated, adding one residue per cycle. See, for example, U.S. Pat. Nos. 4,415,732, 4,458,066, 4,500,707, 4,973,679, and 5,132,418. Oligonucleotide synthesizers that employ this or similar methods are available commercially (for example, the PolyPlex oligonucleotide synthesizer from Gene Machines, San Carlos, Calif.). In addition, many companies will perform such synthesis (for example, Sigma-Genosys, The Woodlands, Tex.; Qiagen Operon, Alameda, Calif.; Integrated DNA Technologies, Coralville, Iowa; and TriLink BioTechnologies, San Diego, Calif.).

The following examples are provided to illustrate particular features of certain embodiments. However, the particular features described below should not be construed as limitations on the scope of the disclosure, but rather as examples from which equivalents will be recognized by those of ordinary skill in the art.

### Examples

### Example 1

### Design of Exemplary Partially Double-Stranded Probes

Oligos can be synthesized from Integrated DNA Technologies, Inc. or other commercial services. With reference to FIG. 1A, partially double-stranded nucleic acid probe 200 can be constructed from two oligos 220, 215, which are hybridized together to form a partially double-stranded probe. The first oligo 220 includes two sequences 115, 120. The second oligo 215 includes sequence 125, which is complimentary to the first sequence 115 on the first oligo 220. A third oligo 110, the indexing probe, includes a sequence 130, which is complimentary to the second sequence 120 of the first oligo 220. The first sequence 115 of the first oligo 220 can contain any number of double-stranded DNA protein binding sites, from none to many (such as at least 1, at least 2, at least 3, at least 4, at least 5, at least 6, at least 7, at least 8, at least 9, at least 10, or more binding sites, for example 1-10, 1-5, 1-3, 1-2 or even 1 binding site). These can be mutated (for example disabled) form. Hybridizing first oligo 220 to second oligo 215 creates partially double-stranded nucleic acid probe 200 to which the nuclear proteins will bind and can be indexed by third oligo 110. Index sequence 120 typically is about 8 to 50 nucleotides in length.

With reference to FIGS. 1B and 1C, a detectable agent can be incorporated into the first oligo 220. The labeling can be at the 5′ end, 3′ end or anywhere in first oligo 220, for example Cy5 labeling on the 5′ end of the first oligo 220. Equal amounts of the first oligo 220 and the second oligo 215 are mixed and hybridized, for example in about 10 mM to about 200 mM NaCl (such as about 100 mM NaCl), for example by heating to about 75° C. to about 95° C. (such as about 95° C.) for a period of time, such as about 1 minute to about 1 hour (such as about 30 minutes), then placing at room temperature for a period of time, such as about 1 minute or longer, for example about 30 minutes.

### Example 2

### Construction of Exemplary Indexing Arrays

With reference to FIG. 3A, indexing probes 110 are printed onto solid support 310 (for example a glass slide), such as indexing array 300. Indexing probes 110 can be amino-modified during synthesis. In addition to the amino-modification, a short linker (for example a nucleotide or other linker, such as a linker greater than about 1 Å in length) can be attached, for example to the end of the probe. Indexing probes 110 can be resuspended at about 50 uM in a 1× solution of commercial spotting buffer (TeleChem, Sunnyvale, Calif.) and are deposited at between about 1 and about 2 nanoliters in a spot onto an aldehyde slide (Schott N A, Elmsford, N.Y.). Indexing probes 110 are printed in 2 ul aliquots onto Nexterion AL Slides (Schott) using a PixSys 5500XL microarray printer (Genomic Solutions). After spotting, indexing array 300 is placed in a dark dessicator overnight to facilitate the covalent attachment of indexing probes 110 to the slide via the amino modifications. The linker is believed to hold indexing probes 110 a short distance away from the surface, which is believed to improve accessibility to indexing probes 110. This methodology is standard protocol for a number of arrays.

### Example 3

### Preparation of Nuclear Extracts

Nuclear extracts from tissue samples are prepared according to the method described by Dignam (Nucleic Acids Res. 11(5):1475-89, 1983). Although the methods are described for tissue samples, one of ordinary skill in the art will recognize that similar methods can be used to generate nuclear extracts form other samples. Briefly, cultured cells are harvested from cell culture media by centrifugation at 4° C. for 10 min at 500 g. Pelleted cells are then suspended in five volumes of 4° C. phosphate buffered saline and collected by centrifugation as above. The cells are suspended in five packed cell pellet volumes of buffer A (10 mM HEPES (pH 7.9 at 4° C.), 1.5 mM MgCl₂, 10 mM KCl and 0.5 mM DTT) and allowed to stand for 10 min. The cells are collected by centrifugation as before and suspended in two packed cell pellet volumes of buffer B (0.3 M HEPES (pH7.9 at 4° C.), 30 mM MgCl₂, 1.4 M KCl) and lysed by 10 strokes of a Kontes all glass Dounce homogenizer (B type pestle). The homogenate is checked microscopically for cell lysis and centrifuged for 10 minutes at 800 g to pellet nuclei. The pellet is subjected to a second centrifugation for 10 min at 25000 g to remove residual cytoplasmic material and this pellet is designated as crude nuclei. These crude nuclei are re-suspended in 3 ml of buffer C (20 mM HEPES (pH7.9 at 4° C.), 25% glycerol, 0.42 M NaCl, 1.5 mM MgCl₂, 0.2 mM EDTA, 0.5 mM PMSF and 0.5 mM DTT) per 10⁹ cells with a Kontes all glass Dounce homogenizer (10 strokes with a type B pestle). The resulting suspension is stirred gently with a magnetic stirring bar for 30 min and then centrifuged for 30 min at 25,000 g. The resulting clear supernatant is dialyze against 50 volumes of buffer D (20 mM HEPES (pH7.9 at 4° C.), 20% glycerol, 0.1 M KCl, 0.2 mM EDTA, 0.5 mM PMSF and 0.5 mM DTT) for five hours. The dialysate is centrifuged at 25,000 g for 20 min and the resulting precipitate discarded. The supernatant (nuclear extract) is recovered for analysis.

### Example 4

### Binding of Partially Double-stranded Nucleic Acid Probes to Nuclear Protein

Double-stranded nucleic acid binding protein and partially double-stranded nucleic acid probe binding is performed according to the protocol of Truter et al. (J. Biol. Chem. 267: 25389-25395) with slight modifications. Briefly, a fluorescent labeled partially double-stranded nucleic acid probe is incubated with 1-10 μg nuclear protein extract at 4° C., 16° C., or 37° C. for 30 minutes in a 25 ul reaction volume containing 0.01 M Tris, pH 7.5, 0.08 M NaC1, 4% glycerol, 0.01 M β-mercaptoethanol, 5 mM MgCl, 20 mM ZnCl₂, and 2.5 mM CaCl₂.

### Example 5

### Separation of DNA/Protein Complex from Unbound Probes

After the incubation as exemplified in Example 4, samples are layered onto a 5-15% polyacrylamide gel in 0.25× TBE buffer, and electrophoresed at 25 mA for 10-30 minutes at 4° C. The double-stranded nucleic acid binding protein/partially double-stranded nucleic acid probe complex is separated from unbound fluorescent labeled DNA. The gel containing double-stranded nucleic acid binding protein/partially double-stranded nucleic acid probe complex is identified and cut and the fluorescent labeled DNA is extracted with QIAQUICK® Gel Extraction Kit.

### Example 6

### Hybridization of the DNA from the DNA/Protein Complex to Indexing Array

Slides containing indexing probes are prehybridized prior to use by incubating in 5×SSC/0.1% SDS/2% RNase-free BSA for 1 hour, followed by sequential washing in 0.5×SSC/0.1% SDS, 0.06×SSC/0.1% SDS and 0.06×SSC. Fluorescently-labeled partially double-stranded nucleic acid probe is suspended in 5×SSC/0.1% SDS. Hybridization is done at a designated temperature—typically 25° C., 40° C., and/or 55° C. in a Boekel InSlide Out Microarray Hybridization chamber. Incubations range from 5 minutes to 18 hours, depending upon the application.

Following hybridization, slides are washed with 0.5×SSC/0.1% SDS, 0.06×SSC/0.1% SDS and 0.06×SSC. Slides are then dried by spinning in a table top centrifuge for 10 minutes at 1000 rpm. Slides are scanned at 100% laser power in a PerkinElmer ScanArray 4000XL microarray scanner. Each slide is scanned at several levels of photomultiplier gain—40%, 45%, 50%, and 75%, followed by a rescan at 40% to give an estimate of photobleaching. Each scan generates a 16-bit TIFF image. Images are quantitated using ImaGene (Biodiscovery), which assigns a mean pixel value to each probe based upon proprietary segmentation algorithms.

### Example 7

### Signal Scanning, Processing and Analysis

Signals are scanned at 5 μm resolution using a ScanArray 4000 (PerkinElmer, Boston, Mass.). The output from imaging is a 16 bit tif image for each dye used in the process, up to three. Image analysis is accomplished with ImaGene (BioDiscovery, El Segundo, Calif.). Briefly, the perimeter of each “spot” is determined by supervised analysis using the built-in algorithms. After the perimeters are determined for all “spots”, the average intensity of the pixels within the perimeter is calculated, along with a measure of the local background.

### Example 8

### Gel Shift Analysis of NF-kB Binding to Partially Double-Stranded Nucleic Acid Probes

Partially double-stranded nucleic acid probes YZ5, YZ6, YZ7, and YZ8 were generated as follows. Partially double-stranded nucleic acid probe YZ5 (CGT GGA ATT TCC TCT GTT GTA TAG TTT GAG GGA TGC TAT GT, SEQ ID NO:3) was selected to contain the canonical binding site of the transcription factor NF-kB taken from the promoter region of IL8, (located −83 to −68 upstream from the transcription start site, of IL8) and was 5′ labeled with fluorescent dye IR Dye 700 (Mori and Oishi, et al. Infect Immun. 67(8):3872-8, 1999). The unique index sequence UT2 (see table 16) was included at the 3′ end of YZ5. Partially double-stranded nucleic acid probe YZ6 (CGT TAA CTT TCC TCT GTT GTA TAG TTT GAG GGA TGC TAT GT, SEQ ID NO:4) was constructed in a similar fashion to YZ5 but contains a mutation in the NF-kB binding site and thus should not bind NF-kB. It was not labeled with fluorescent dye. This non-competitive mutated probe should not bind the NF-kB and thus it should not decrease the signal from NF-kB specific binding. Partially double-stranded nucleic acid probe YZ7 (AGC TTC AGA GGG GAC TTT CCG AGA GGT TTT TTG ACT AGA CCA TTC AAA GCT, SEQ ID NO:5) contained a slightly different but naturally occurring NF-kB binding site. It was also labeled with a fluorescent dye IR Dye 700 at its 5′ end. The unique single strand index sequence UT3 was included at the 3′ end of YZ7. Partially double-stranded nucleic acid probe YZ8 (AGC TTC AGA GGG GAC TAA ACG AGA GGT TTT TTG ACT AGA CCA TTC AAA GCT, SEQ ID NO:6) is similar to YZ7 but contains a mutated core sequence and was not labeled with fluorescent dye.

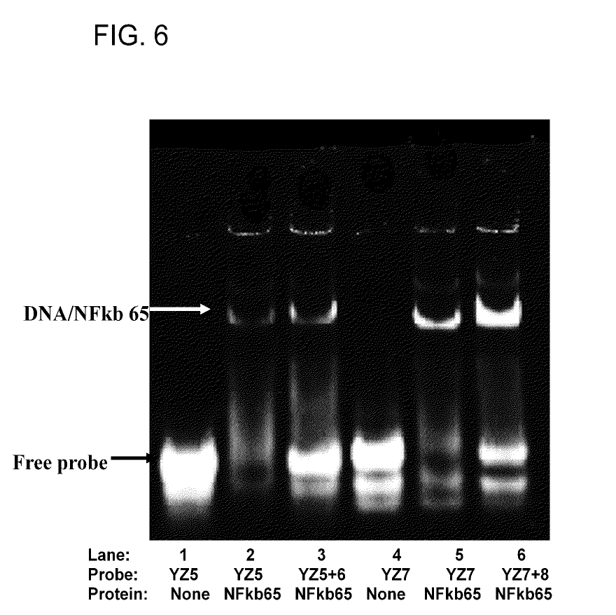

The partially double-stranded nucleic acid probes were mixed with NF-kB (NFkb65 obtained from Panomics) and subjected to polyacrylamide gel electrophoresis. The gels were imaged, the results of which are shown in FIG. 6. With reference to FIG. 6, recombinant NFkb65 binds to the YZ5 and YZ7 partially double-stranded nucleic acid probes that contain the NFkb binding sequence, see lanes 2 and 5. In addition, the addition of unlabeled mutated partially double-stranded nucleic acid probe (100:1) had no impact on the binding, see lanes 3 and 6. This result demonstrates that the transcription factor bound partially double-stranded nucleic acid probes can be separated by gel electrophoresis. This further demonstrates the sequence discrimination of transcription factors.

### Example 9

### Gel Shift Analysis of ER Alpha Binding to Partially Double-Stranded Nucleic Acid Probes

Partially double-stranded nucleic acid probes YZ11, YZ12, and YZ13 were generated as follows. Partially double-stranded nucleic acid probe YZ11 (GTC CAA AGT CAG GTC ACA GTG ACC TGA TCA AAG TTA TGC CTT AGG

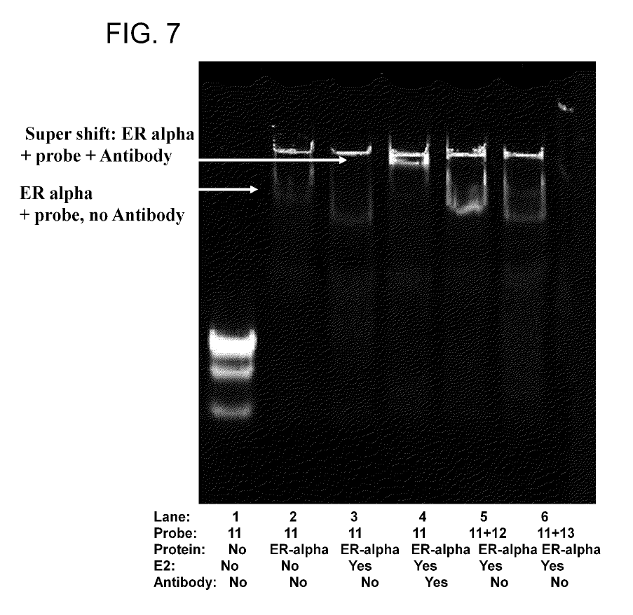

AGA ATT GTT TTG TTT, SEQ ID NO:7) was selected to contain the canonical binding site of the transcription factor Estrogen Receptor Alpha (ER Alpha) and was 5′ labeled with fluorescent dye IR Dye 700. The unique index sequence UT5 (see table 16) was included at the 3′ end of YZ11. Partially double-stranded nucleic acid probe YZ12 (GTC CAA AGT CAG AAC ACA GTG ATT TGA TCAA TGC CTT AGG AGA ATT GTT TTG TTT, SEQ ID NO:8) was constructed in a similar fashion to YZ11 but contains a mutation in the ER Alpha binding. It was not labeled with fluorescent dye. Partially double-stranded nucleic acid probe YZ13 (GTC CAA AGT CAG GTC ACA GTG ACC TGA TCAA TGC CTT AGG AGA ATT GTT TTG TTT, SEQ ID NO:9) is the same as YZ11 except it is unlabeled and the core sequence has been deleted. The partially double-stranded nucleic acid probe were mixed with ER Alpha (Invitrogen) and E2 and subjected to polyacrylamide gel electrophoresis. The gels were imaged, the results of which are shown in FIG. 7. With reference to FIG. 7 recombinant ER Alpha (Invitrogen) is able to bind to the YZ11 partially double-stranded nucleic acid probe that included an ER Alpha binding sequence, see lane 2 and lane 3. In addition, the addition of unlabeled mutated partially double-stranded nucleic acid probes (100:1) (lane 5) or deleted motif partially double-stranded nucleic acid probe (lane 6) had no impact on the binding. Adding antibody increased mass and resulted in a supershift (lane 4). This result demonstrates that the transcription factor bound partially double-stranded nucleic acid probes can be separated by gel electrophoresis. This further demonstrates the sequence discrimination of transcription factors.

### Example 10

### Gel Shift Analysis of Sp-1 Protein Binding to Partially Double-Stranded Nucleic Acid Probes

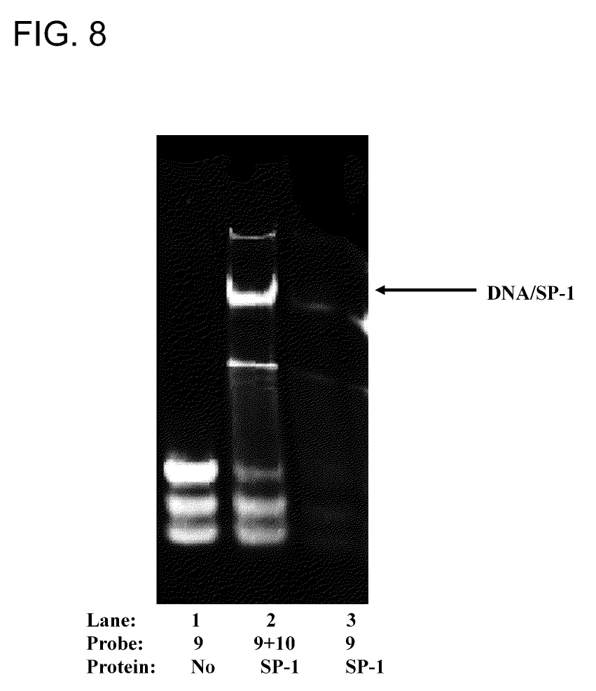

Partially double-stranded nucleic acid probes YZ9 and YZ10 were generated as follows. Partially double-stranded nucleic acid probe YZ9 (ATT CGA TCG GGG CGG GGC GAG CGT TAT CCC AAC TTC GAA TCT CAT TT, SEQ ID NO:10) includes a Sp-1 binding site. It was labeled with fluorescence dye IR Dye 700 at its 5′ end. A unique tag (UT4, see table 16) was included at the 3′ end of YZ9. Partially double-stranded nucleic acid probe YZ10 (ATTCGATCGGGaaaGGGCGAGCGT TAT CCC AAC TTC GAA TCT CAT TT, SEQ ID NO:11) is similar to YZ10 but contained a mutated Sp-1 binding motif. It was not labeled with fluorescent dye. The partially double-stranded nucleic acid probe were mixed with SP-1 (Promega) and subjected to polyacrylamide gel electrophoresis. The gels were imaged, the results of which are shown in FIG. 8. With reference to FIG. 8 recombinant SP-1 is able to bind to the YZ9 partially double-stranded nucleic acid probe that included the SP-1 binding sequence, see lane 3. In addition the addition of unlabeled mutated partially double-stranded nucleic acid probes (100:1) (lane 2) had no impact on the binding. This result demonstrates that the transcription factor bound partially double-stranded nucleic acid probes can be separated by gel electrophoresis. This further demonstrates the sequence discrimination of transcription factors.

### Example 11

### Determination of Transcription Factor Binding Sites in the Epidermal Growth Factor Receptor Promoter

This example describes the determination of transcription factor binding sites present in the promoter region of the Homo sapiens epidermal growth factor receptor (EGFR) gene.

The EGFR gene promoter region (GENBANK® accession no. NM_{—}005228 Promoter Database 37724) location from −190 to 169 relative to transcription start site (TSS) was selected. The following sequence was retrieved from the Transcriptional Regulatory Element Database maintained by the Michael Zhang Laboratory, Cold Spring Harbor Laboratory.

(SEQ ID NO: 12)

CCTCGCATTCTCCTCCTCCTCTGCTCCTCCCGATCCCTCCTCCGCCGCCT
GGTCCCTCCTCCTCCCGCCCTGCCTCCCCGCGCCTCGGCCCGCGCGAGCT
AGACGTCCGGGCAGCCCCCGGCGCAGCGCGGCCGCAGCAGCCTCCGCCCC
CCGCACGGTGTGAGCGCCCGACGCGGCCGAGGCGGCCGGAGTCCCGAGCT
AGCCCCGGCGGCCGCCGCCGCCCAGACCGGACGACAGGCCACCTCGTCGG
CGTCCGCCCGAGTCCCCGCCTCGCCGCCAACGCCACAACCACCGCGCACG
GCCCCCTGACTCCGTCCAGTATTGATCGGGAGAGCCGGAGCGAGCTCTTC
GGGGAGCAGC

The sequence is analyzed with Match program of TRANSFAC® database to identify putative transcription factor binding sites in promoter region. The predicted sites for transcription factor binding are shown in Table 1.

TABLE 1
TRANSFAC ® identified putative transcription factor binding sites

| | | | | Sequence | SEQ | |
|---|---|---|---|---|---|---|
| | Position | core | Matrix | (always the (+)- | ID | factor |
| matrix identifier | (strand | Match | match | strand is shown) | NO: | name |
| V$SPZ1_01 | 29 (−) | 1.000 | 0.965 | cccgatcCCTCCtcc | 13 | Spz1 |
| V$ETF_Q6 | 42 (−) | 1.000 | 1.000 | CCGCCgc | 14 | ETF |
| V$ZF5_B | 89 (+) | 0.888 | 0.849 | cccgcgCGAGCta | 15 | ZF5 |
| V$CETS1P54_01 | 102 (−) | 1.000 | 0.968 | gacgTCCGGg | 16 | c-Ets- |
| | | | | | | 1(p54) |
| V$ZF5_B | 124 (−) | 1.000 | 0.918 | caGCGCGgccgca | 17 | ZF5 |
| V$ETF_Q6 | 212 (−) | 1.000 | 1.000 | CCGCCgc | 18 | ETF |
| V$ETF_Q6 | 215 (−) | 1.000 | 1.000 | CCGCCgc | 19 | ETF |
| V$EGR1_01 | 274 (−) | 0.900 | 0.874 | ccgCCAACgcca | 20 | Egr-1 |
| V$CDPCR1_01 | 320 (+) | 0.929 | 0.946 | tATTGAtcgg | 21 | CDPCR1 |
| V$ZF5_B | 335 (+) | 0.888 | 0.855 | ccggagCGAGCtc | 22 | ZF5 |
| V$ZF5_B | 338 (−) | 0.864 | 0.855 | gaGCGAGctcttc | 23 | ZF5 |

Multiple partially double-stranded probes with 40 base pair double-stranded portions (20 base pair overlap between probes) are created by hybridizing two synthetic oligos to cover this promoter area both in the forward and reverse direction, where OF=forward reading direction (relative to the gene) and OB=backward reading direction. A single strand of the double-stranded portion of the probe is shown in Table 2 and Table 3.

TABLE 2
Sequence of the forward reading double-stranded
portion of the probe.

| | | SEQ |
|---|---|---|
| | | ID |
| | | NO: |
| OF_EGFR1 | CCTCGCATTCTCCTCCTCCTCTGCTCCTCCCGATCCC | 24 |
| | TCC | |
| OF_EGFR2 | CTGCTCCTCCCGATCCCTCCTCCGCCGCCTGGTCCCT | 25 |
| | CCT | |
| OF_EGFR3 | TCCGCCGCCTGGTCCCTCCTCCTCCCGCCCTGCCTCC | 26 |
| | CCG | |
| OF_EGFR4 | CCTCCCGCCCTGCCTCCCCGCGCCTCGGCCCGCGCG | 27 |
| | AGCT | |
| OF_EGFR5 | CGCCTCGGCCCGCGCGAGCTAGACGTCCGGGCAGCC | 28 |
| | CCCG | |
| OF_EGFR6 | AGACGTCCGGGCAGCCCCCGGCGCAGCGCGGCCGC | 29 |
| | AGCAG | |
| OF_EGFR7 | GCGCAGCGCGGCCGCAGCAGCCTCCGCCCCCCGCAC | 30 |
| | GGTG | |
| OF_EGFR8 | CCTCCGCCCCCCGCACGGTGTGAGCGCCCGACGCGG | 31 |
| | CCGA | |
| OF_EGFR9 | TGAGCGCCCGACGCGGCCGAGGCGGCCGGAGTCCC | 32 |
| | GAGCT | |
| OF_EGFR10 | GGCGGCCGGAGTCCCGAGCTAGCCCCGGCGGCCGC | 33 |
| | CGCCG | |
| OF_EGFR11 | AGCCCCGGCGGCCGCCGCCGCCCAGACCGGACGAC | 34 |
| | AGGCC | |
| OF_EGFR12 | CCCAGACCGGACGACAGGCCACCTCGTCGGCGTCCG | 35 |
| | CCCG | |
| OF_EGFR13 | ACCTCGTCGGCGTCCGCCCGAGTCCCCGCCTCGCCG | 36 |
| | CCAA | |
| OF_EGFR14 | AGTCCCCGCCTCGCCGCCAACGCCACAACCACCGCG | 37 |
| | CACG | |
| OF_EGFR15 | CGCCACAACCACCGCGCACGGCCCCCTGACTCCGTC | 38 |
| | CAGT | |
| OF_EGFR16 | GCCCCCTGACTCCGTCCAGTATTGATCGGGAGAGCC | 39 |
| | GGAG | |
| OF_EGFR17 | ATTGATCGGGAGAGCCGGAGCGAGCTCTTCGGGGA | 40 |
| | GCAGC | |

TABLE 3
Sequence of the reverse reading double-stranded
portion of the probe.

| | | SEQ |
|---|---|---|
| | | ID |
| | | NO |
| OB_EGFR1 | GGAGGGATCGGGAGGAGCAGAGGAGGAGGAGAAT | 41 |
| | GCGAGG | |
| OB_EGFR2 | AGGAGGGACCAGGCGGCGGAGGAGGGATCGGGAG | 42 |
| | GAGCAG | |
| OB_EGFR3 | CGGGGAGGCAGGGCGGGAGGAGGAGGGACCAGGC | 43 |
| | GGCGGA | |
| OB_EGFR4 | AGCTCGCGCGGGCCGAGGCGCGGGGAGGCAGGGCG | 44 |
| | GGAGG | |
| OB_EGFR5 | CGGGGGCTGCCCGGACGTCTAGCTCGCGCGGGCCG | 45 |
| | AGGCG | |
| OB_EGFR6 | CTGCTGCGGCCGCGCTGCGCCGGGGGCTGCCCGGA | 46 |
| | CGTCT | |
| OB_EGFR7 | CACCGTGCGGGGGGCGGAGGCTGCTGCGGCCGCGC | 47 |
| | TGCGC | |
| OB_EGFR8 | TCGGCCGCGTCGGGCGCTCACACCGTGCGGGGGGC | 48 |
| | GGAGG | |
| OB_EGFR9 | AGCTCGGGACTCCGGCCGCCTCGGCCGCGTCGGGC | 49 |
| | GCTCA | |
| OB_EGFR10 | CGGCGGCGGCCGCCGGGGCTAGCTCGGGACTCCGG | 50 |
| | CCGCC | |
| OB_EGFR11 | GGCCTGTCGTCCGGTCTGGGCGGCGGCGGCCGCCG | 51 |
| | GGGCT | |
| OB_EGFR12 | CGGGCGGACGCCGACGAGGTGGCCTGTCGTCCGGT | 52 |
| | CTGGG | |
| OB_EGFR13 | TTGGCGGCGAGGCGGGGACTCGGGCGGACGCCGAC | 53 |
| | GAGGT | |
| OB_EGFR14 | CGTGCGCGGTGGTTGTGGCGTTGGCGGCGAGGCGG | 54 |
| | GGACT | |
| OB_EGFR15 | ACTGGACGGAGTCAGGGGGCCGTGCGCGGTGGTTG | 55 |
| | TGGCG | |
| OB_EGFR16 | CTCCGGCTCTCCCGATCAATACTGGACGGAGTCAGG | 56 |
| | GGGC | |
| OB_EGFR17 | GCTGCTCCCCGAAGAGCTCGCTCCGGCTCTCCCGAT | 57 |
| | CAAT | |

Transcription factor binding is determined as described in Examples 1-7.

### Example 12

### Determination of Transcription Factor Binding Sites in the ER Beta Promoter

This example describes the determination of transcription factor binding sites present in the promoter region of the ER beta Promoter.

The ER beta gene promoter region (GENBANK® accession no. NM_{—}001437 location from −200 to −41 relative to transcription start site (TSS) was selected for study. The following sequence was retrieved from the Transcriptional Regulatory Element Database maintained by the Michael Zhang Laboratory, Cold Spring Harbor Laboratory.

(SEQ ID NO: 58)

TCTGTGCGCCACTATCCTTGTGGGTGGACCAGGAGTCGGTTCGAGGGTGC
TCCCACTTAGAGGTCACGCGCGGCGTCGGGCGTTCCTGAGACCGTCGGGC
TCCCTGGCTCGGTCACGTGGGCTCAGGCACTACTCCCCTCTACCCTCCTC
TCGGTCTTTA

The sequence is analyzed with Match program of TRANSFAC® database to identify putative transcription factor binding sites in promoter region. The predicted sites for transcription factor binding are shown in Table 4.

TABLE 4
TRANSFAC ® identified putative transcription factor binding sites

| | | | | | SEQ | |
|---|---|---|---|---|---|---|
| | Position | core | Matrix | Sequence | ID | |
| matrix identifier | strand | Match | match | (always the (+)-strand is shown) | NO: | factor name |
| V$CDPCR3_01 | 12(−) | 0.766 | 0.827 | CTATCcttgtgggtg | 59 | CDP CR3 |
| V$PAX5_02 | 65(+) | 0.873 | 0.739 | CacgcgcggcgtcGGGCGttcctgagac | 60 | Pax-5 |
| V$CP2_02 | 103(+) | 0.941 | 0.918 | CCTGGctcggtcacg | 61 | CP2/LBP-1c/LSF |
| V$EBOX_Q6_01 | 111(−) | 1.000 | 1.000 | ggtcACGTGg | 62 | Ebox |
| V$USF_Q6_01 | 111(−) | 1.000 | 0.984 | ggtCACGTgggc | 63 | USF |
| V$SPZ1_01 | 137(−) | 1.000 | 0.974 | cctctacCCTCCtct | 64 | Spz1 |

Multiple partially double-stranded probes with 40 base pair double-stranded portions (20 base pair overlap between probes) are created by hybridizing two synthetic oligos to cover this promoter area both in the forward and reverse direction, where OF=forward reading direction (relative to the gene) and OB=backward reading direction. A single strand of the double-stranded portion of the probe is shown in Table 5 and Table 6.

TABLE 5
Sequence of the forward reading double-stranded
portion of the probe

| | | SEQ |
|---|---|---|
| | | ID NO: |
| OF_ERB1 | TCTGTGCGCCACTATCCTTGTGGGTGGACCAGGAG | 65 |
| | TCGGT | |
| OF_ERB2 | TGGGTGGACCAGGAGTCGGTTCGAGGGTGCTCCC | 66 |
| | ACTTAG | |
| OF_ERB3 | TCGAGGGTGCTCCCACTTAGAGGTCACGCGCGGCG | 67 |
| | TCGGG | |
| OF_ERB4 | AGGTCACGCGCGGCGTCGGGCGTTCCTGAGACCGT | 68 |
| | CGGGC | |
| OF_ERB5 | CGTTCCTGAGACCGTCGGGCTCCCTGGCTCGGTCA | 69 |
| | CGTGG | |
| OF_ERB6 | TCCCTGGCTCGGTCACGTGGGCTCAGGCACTACTC | 70 |
| | CCCTC | |
| OF_ERB7 | GCTCAGGCACTACTCCCCTCTACCCTCCTCTCGGTC | 71 |
| | TTTA | |

TABLE 6
Sequence of the reverse reading
double-stranded portion of the probe

| | | SEQ |
|---|---|---|
| | | ID |
| | | NO: |
| OB_ERB1 | ACCGACTCCTGGTCCACCCACAAGGATAGTGGCG | 72 |
| | CACAGA | |
| OB_ERB2 | CTAAGTGGGAGCACCCTCGAACCGACTCCTGGTCC | 73 |
| | ACCCA | |
| OB_ERB3 | CCCGACGCCGCGCGTGACCTCTAAGTGGGAGCAC | 74 |
| | CCTCGA | |
| OB_ERB4 | GCCCGACGGTCTCAGGAACGCCCGACGCCGCGCG | 75 |
| | TGACCT | |
| OB_ERB5 | CCACGTGACCGAGCCAGGGAGCCCGACGGTCTCA | 76 |
| | GGAACG | |
| OB_ERB6 | GAGGGGAGTAGTGCCTGAGCCCACGTGACCGAGC | 77 |
| | CAGGGA | |
| OB_ERB7 | TAAAGACCGAGAGGAGGGTAGAGGGGAGTAGTG | 78 |
| | CCTGAGC | |

Transcription factor binding is determined as described in Examples 1-7.

### Example 13

### Determination of Transcription Factor Binding Sites in the Promoter of CYP1B1

This example describes the determination of transcription factor binding sites present in the promoter region of the promoter of CYP1B1.

The CYP1B1 gene promoter region (GENBANK® accession no. NM_{—}000104 location from −130 to −31, −570 to −491 relative to transcription start site (TSS) was selected. The following sequences were retrieved Database of Transcriptional Start Sites: DBTSS:NM_{—}000104, DBTSS

−130 to −31

(SEQ ID NO: 79)

GGACGGGAGTCCGGGTCAAAGCGGCCTGGTGTGCGGCGCGCCCCGCCCC
CCGCAGGCCCCGCCCTGCCAGGTCGCGCTGCCCTCCTTCTACCCAGTCCT
T
−570 to −491

(SEQ ID NO: 80)

TGTGTGCCCAAGCACTGTCGGGGCCCCGGGGCGGGGGAGCGGCTACTTT
TAGGGATTCCTGATCTCGCCGCAAGAACTGG

The sequences are analyzed with Match program of TRANSFAC® database to identify putative transcription factor binding sites in promoter region. The predicted sites for transcription factor binding are shown in Table 7 and 8.

TABLE 7
TRANSFAC ® identified putative transcription factor binding sites,
−130 to −31

| | | | | Sequence | SEQ | |
|---|---|---|---|---|---|---|
| matrix | Position | core | Matrix | (always the (+)-strand is | ID | factor |
| identifier | strand | Match | match | shown) | NO: | name |
| V$ER_Q6 | 11(−) | 1.000 | 0.970 | ccgGGTCAaagcggcctgg | 81 | ER |
| V$ZF5_B | 34(−) | 1.000 | 0.847 | cgGCGCGccccgc | 82 | ZF5 |
| V$SP1_Q2_01 | 41(+) | 1.000 | 1.000 | ccCCGCCccc | 83 | Sp1 |
| V$AP2_Q6_01 | 46(+) | 1.000 | 0.995 | ccccccgCAGGCc | 84 | AP-2 |
| V$AP2_Q6 | 47(+) | 1.000 | 0.945 | ccCCCGCaggcc | 85 | AP-2 |
| V$PPARG_02 | 65(+) | 0.751 | 0.690 | tgccaGGTCGcgctgccctcctt | 86 | PPARG |
| V$PPARG_02 | 65(−) | 0.853 | 0.670 | tgccaggtcgcgcTGCCCtcctt | 87 | PPARG |
| V$ZF5_B | 67 | (+)1.00 | 0.872 | ccaggtCGCGCtg | 88 | ZF5 |

TABLE 8
TRANSFAC ® identified putative
transcription factor binding sites, −570 to −491

| | | | | Sequence | SEQ | |
|---|---|---|---|---|---|---|
| | Postion | core | Matrix | (always the (+)- | ID | factor |
| matrix identifier | (strand | Match | match | strand is shown) | NO: | name |
| V$AP2_Q6 | 22(+) | 0.944 | 0.945 | ggCCCCGgggcg | 89 | AP-2 |
| V$AP2_Q6 | 22(−) | 0.944 | 0.933 | ggcccCGGGGcg | 90 | AP-2 |
| V$AP2ALPHA_01 | 23(+) | 1.000 | 1.000 | GCCCCgggg | 91 | AP-2alpha |
| V$AP2ALPHA_01 | 24(−) | 1.000 | 1.000 | ccccGGGGC | 92 | AP-2alpha |
| V$SP1_Q2_01 | 27(−) | 1.000 | 0.993 | cggGGCGGgg | 93 | Sp1 |

Multiple partially double-stranded probes with 40 base pair double-stranded portions (20 base pair overlap between probes) are created by hybridizing two synthetic oligos to cover this promoter area both in the forward and reverse direction, where OF=forward reading direction (relative to the gene) and OB=backward reading direction. A single strand of the double-stranded portion of the probe is shown in Table 9 and Table 10.

TABLE 9
Sequence of double-stranded portion
of the probe for 130 to −31

| | | SEQ |
|---|---|---|
| | | ID |
| | | NO: |
| OF_CYP1B1 | GGACGGGAGTCCGGGTCAAAGCGGCCTGGTGTGC | 94 |
| | GGCGCG | |
| OF_CYP1B2 | GCGGCCTGGTGTGCGGCGCGCCCCGCCCCCCGCA | 95 |
| | GGCCCC | |
| OF_CYP1B3 | CCCCGCCCCCCGCAGGCCCCGCCCTGCCAGGTCGC | 96 |
| | GCTGC | |
| OF_CYP1B4 | GCCCTGCCAGGTCGCGCTGCCCTCCTTCTACCCAG | 97 |
| | TCCTT | |
| OB_CYP1B1 | CGCGCCGCACACCAGGCCGCTTTGACCCGGACTCC | 98 |
| | CGTCC | |
| OB_CYP1B2 | GGGGCCTGCGGGGGGCGGGGCGCGCCGCACACCA | 99 |
| | GGCCGC | |
| OB_CYP1B3 | GCAGCGCGACCTGGCAGGGCGGGGCCTGCGGGGG | 100 |
| | GCGGGG | |
| OB_CYP1B4 | AAGGACTGGGTAGAAGGAGGGCAGCGCGACCTGG | 101 |
| | CAGGGC | |

TABLE 10
Sequence of double-stranded portion
of the probe for −570 to −491

| | | SEQ |
|---|---|---|
| | | ID |
| | | NO: |
| OF_CYP1B8 | TGTGTGCCCAAGCACTGTCGGGGCCCCGGGGCGG | 102 |
| | GGGAGC | |
| OF_CYP1B9 | GGGCCCCGGGGCGGGGGAGCGGCTACTTTTAGG | 103 |
| | GATTCCT | |
| OF_CYP1B10 | GGCTACTTTTAGGGATTCCTGATCTCGCCGCAAG | 104 |
| | AACTGG | |
| OB_CYP1B8 | GCTCCCCCGCCCCGGGGCCCCGACAGTGCTTGGG | 105 |
| | CACACA | |
| OB_CYP1B9 | AGGAATCCCTAAAAGTAGCCGCTCCCCCGCCCCG | 106 |
| | GGGCCC | |
| OB_CYP1B10 | CCAGTTCTTGCGGCGAGATCAGGAATCCCTAAAA | 107 |
| | GTAGCC | |

Transcription factor binding is monitored as described in Examples 1-7.

### Example 14

### Determination of Transcription Factor Binding Sites for Selected Promoters and Transcription Factor Binding Sites

The double strand DNA part of the partially double strand DNA probes is composed of the binding sites of estrogen receptor (estrogen response element, ERE) from the EGFR gene promoter (table 11), vitellogenin gene promoter (table 12), estrogen receptor beta gene promoter (table 13), or CYP1B1 gene promoter (table 14) or their mutated form. A breast cancer cell line (for example, MCF-7) will be cultured with or without 17β-Estradiol. The cell nuclear extracts will be separated and incubated with the above mixed probes. The formed protein/DNA complex will be separated by Electrophoretic Mobility Shift Assay and the DNA in protein/DNA complex will be purified with QIAGEN® gel purification kit and hybridized to a microarray slide that has been printed with the complement sequence of the indexed unique tags. The signal change before and after the addition of 17β-Estradiol represents change in the activated estrogen receptor. The signal intensity will represent the binding strength between different ERE sequences and the activated estrogen receptor. The microarray results will be compared to the gel shift results to assess the consistency of two experiments.

TABLE 11
Sequence of double-stranded portion of the probe
for 36-bp region of EGFR promoter

| | | SEQ |
|---|---|---|
| | | ID |
| | | NO: |
| OF_EGFR18 | GTCGGCGTCCGCCCGAGTCCCCGCCTCGCCGC | 108 |
| 36-bp EGFR | CAACGCCA | |
| promoter | | |
| OB_EGFR18 | TGGCGTTGGCGGCGAGGCGGGGACTCGGGCG | 109 |
| 36-bp EGFR | GACGCCGAC | |
| promoter | | |
| OF_EGFR19 | GTCGGCGTCCGCCCGAGTCTTTGTCTCGCCGC | 110 |
| mutated core | CAACGCCA | |
| sequence 36- | | |
| bp EGFR | | |
| promoter | | |
| OB_EGFR19 | TGGCGTTGGCGGCGAGACAAAGACTCGGGCG | 111 |
| mutated core | GACGCCGAC | |
| sequence 36- | | |
| bp EGFR | | |
| promoter | | |

TABLE 12
Sequence of double-stranded portion of the
probe for the vitellogenin-ERE

| | | SEQ ID |
|---|---|---|
| | | NO: |
| OF_EGFR20 | GTCCAAAGTCAGGTCACAGTGACCTG | 112 |
| vitellogenin-ERE | ATCAAAGTT | |
| OB_EGFR20 | AACTTTGATCAGGTCACTGTGACCTG | 113 |
| vitellogenin-ERE | ACTTTGGAC | |
| OF_EGFR20 Mutated | GTCCAAAGTCAGAACACAGTGATTTG | 114 |
| vitellogenin-ERE | ATCA | |
| OB_EGFR20 Mutated | TGATCAAATCACTGTGTTCTGACTTT | 115 |
| vitellogenin-ERE | GGAC | |
| OF_EGFR21 deleted | GTCCAAAGTCAGGTCACAGTGACCTG | 116 |
| vitellogenin-ERE | ATCA | |
| OB_EGFR21 deleted | TGATCAGGTCACTGTGACCTGACTTT | 117 |
| vitellogenin-ERE | GGAC | |

TABLE 13
Sequence of double-stranded portion of the probe
for ER beta gene −148 to −123

| | | SEQ ID NO: |
|---|---|---|
| OF_ERB8 half | CCACTTAGAGGTCACGCGCGGCGTCG | 118 |
| ERE/XRE | | |
| OB_ERB8 half | CGACGCCGCGCGTGACCTCTAAGTGG | 119 |
| ERE/XRE | | |
| OF_ERB9 | CCACTTAGttGTtACGCGCGGCGTCG | 120 |
| mutated half | | |
| ERE/XRE | | |
| OB_ERB9 | CGACGCCGCGCGTAACAACTAAGTGG | 121 |
| mutated half | | |
| ERE/XRE | | |

TABLE 14
Sequence of double-stranded portion of the
probe for CYP1B1 1B1/ERE −62 to −48

| | | SEQ ID |
|---|---|---|
| | | NO: |
| OF_1B1 | CCTGCCAGGTCGCGCTGCCCTCCTTCTACC | 122 |
| 1B1/ERE −69 | | |
| to −39 | | |
| OB_1B1 | GGTAGAAGGAGGGCAGCGCGACCTGGCAGG | 123 |
| 1B1/ERE −69 | | |
| to −39 | | |
| 1B1/ERE | CCTGCttGTTCGaGCTGCACTCCTTCTACC | 124 |
| Mutated | | |
| 1B1/ERE | GGTAGAAGGAGTGCAGCTCGAACAAGCAGG | 125 |
| Mutated | | |

TABLE 15
Sequence of double-stranded portion of the
probe for EGFR22 Sp-1

| | | SEQ |
|---|---|---|
| | | ID NO: |
| OF_EGFR22 | AGCTTATTCGATCGGGGCGGGGCGAGCG | 126 |
| Sp1 | | |
| OB_EGFR22 | CGCTCGCCCCGCCCCGATCGAATAAGCT | 127 |
| Sp1 | | |
| OF_EGFR23 | CGATCGGGGCGGGGCGAGC | 128 |
| Sp1 + ER | AGTCAGGTCACAGTGACCTGA | |
| OB_EGFR23 | TCAGGTCACTGTGACCTGACTGCTCGCCCCG | 129 |
| Sp1 + ER | CCCCGATCG | |
| OF_EGFR24- | CGATCTtttAGGGACGAGC | 130 |
| Sp1 + ER | AGTCAGGTCACAGTGACCTGA | |
| OB_EGFR24- | TCAGGTCACTGTGACCTGACTGCTCGTCCCT | 131 |
| Sp1 + ER | AAAAGATCG | |
| OF_EGFR25 | CGATCGGGGCGGGGCGAGC | 132 |
| Sp1 − ER | AGTCActTCACAGTctCCTGA | |
| OB_EGFR25 | TCAGGAGACTGTGAAGTGACTGCTCGCCCC | 133 |
| Sp1 − ER | GCCCCGATCG | |
| OF_EGFR26- | CGATCTtttAGGGACGAGC | 134 |
| Sp1 − ER | AGTCActTCACAGTctCCTGA | |
| OB_EGFR26- | TCAGGAGACTGTGAAGTGACTGCTCGTCCC | 135 |
| Sp1 − ER | TAAAAGATCG | |

### Example 15

### Exemplary Index Sequences and Indexing Probes

TABLE 16
Exemplary indexing sequences and
indexing probes.

| | Uinique | SEQ | | |
|---|---|---|---|---|
| | tage | ID | | |
| Index sequence | labeling | NO: | Indexing probe | |
| TTG TAT AGT TTG | ut2 | 136 | ACA TAG CAT CCC | 231 |
| AGG GAT GCT ATG T | (unique | | TCA AAC TAT ACA A | |
| | tag1) | | | |
| TTT TTT GAC TAG | ut3 | 137 | AGC TTT GAA TGG | 232 |
| ACC ATT CAA AGC T | | | TCT AGT CAA AAA A | |
| GTT ATC CCA ACT | ut4 | 138 | AAA TGA GAT TCG | 233 |
| TCG AAT CTC ATT T | | | AAG TTG GGA TAA C | |
| ATG CCT TAG GAG | ut5 | 139 | AAA CAA AAC AAT | 234 |
| AAT TGT TTT GTT T | | | TCT CCT AAG GCA T | |
| AGC CAA ATC TTA | ut6 | 140 | TCT ACA TTC AGG | 235 |
| TCC TGA ATG TAG A | | | ATA AGA TTT GGC T | |
| ATA ATT GTG TAG | Ut7 | 141 | CAA AGA AAA GGG | 236 |
| CCC CTT TTC TTT G | | | GCT ACA CAA TTA T | |
| ATG ATT CAA AAC | Ut8 | 142 | ACC TGA AGA AAT | 237 |
| CAT TTC TTC AGG T | | | GGT TTT GAA TCA T | |
| TTA AAC ATT GTG | Ut9 | 143 | ACA GGT GTT AAC | 238 |
| TGT TAA CAC CTG T | | | ACA CAA TGT TTA A | |
| GGT TCA TAG ATG | Ut10 | 144 | GTA CAA AAC TGA | 239 |
| GTC AGT TTT GTA C | | | CCA TCT ATG AAC C | |
| AGT GTT CCC AAT | Ut11 | 145 | TTT TGA ATT TCA | 240 |
| CTG AAA TTC AAA A | | | GAT TGG GAA CAC T | |
| GTC CTG TTA TTC | Ut12 | 146 | AGA ACT GTA GTC | 241 |
| TGA CTA CAG TTC T | | | AGA ATA ACA GGA C | |
| CTG GAG TTA CAG | Ut13 | 147 | GAC AGA TTG AAA | 242 |
| TTT TCA ATC TGT C | | | ACT GTA ACT CCA G | |
| AAG CTA CGG TAC | Ut14 | 148 | CAT CTA ATT ACT | 243 |
| CAG TAA TTA GAT G | | | GGT ACC GTA GCT T | |
| TTG GAC ACT ATC | Ut15 | 149 | CTC TTC TGA TCA | 244 |
| TTG ATC AGA AGA G | | | AGA TAG TGT CCA A | |
| TCC ATG CAC ATT | Ut16 | 150 | CCT CAA TAT TGT | 245 |
| TAC AAT ATT GAG G | | | AAA TGT GCA TGG A | |
| GTT TTA GTT CCG | Ut17 | 151 | AAG AAA ACG AGA | 246 |
| TTC TCG TTT TCT T | | | ACG GAA CTA AAA C | |
| GCT AGA AAA ATA | Ut18 | 152 | TAA GAT CCA GCC | 247 |
| GGG CTG GAT CTT A | | | CTA TTT TTC TAG C | |
| CAT ATT GAT TGG | Ut19 | 153 | ACC ACC AAT TTC | 248 |
| TGA AAT TGG TGG T | | | ACC AAT CAA TAT G | |
| AAG TTG TTT GAG | Ut20 | 154 | ACA GTT AAT TTG | 249 |
| GCA AAT TAA CTG T | | | CCT CAA ACA ACT T | |
| TCT ATT GAA TTC | Ut21 | 155 | AAA GGA CAG TTC | 250 |
| GGA ACT GTC CTT T | | | CGA ATT CAA TAG A | |
| AAA GCC TCT TTT | Ut22 | 156 | TTT GCT TTA TTC | 251 |
| CGA ATA AAG CAA A | | | GAA AAG AGG CTT T | |
| AAT TGT TTT GTT | Ut23 | 157 | CCA GCT TTT GTG | 252 |
| TCA CAA AAG CTG G | | | AAA CAA AAC AAT T | |
| CGA TCT TTT GAT | Ut24 | 158 | TGT GAA ACA GCA | 253 |
| ATG CTG TTT CAC A | | | TAT CAA AAG ATC G | |
| GTT GGT TGT CAG | Ut25 | 159 | AAG TTA TTG TTC | 254 |
| TGA ACA ATA ACT T | | | ACT GAC AAC CAA C | |
| TTA TTT TTG TAC | Ut26 | 160 | CAC ACC CGA ACA | 255 |
| ATG TTC GGG TGT G | | | TGT ACA AAA ATA A | |
| AAT ATA TTG ACA | Ut27 | 161 | TTG AGG GCT CCA | 256 |
| TTG GAG CCC TCA A | | | ATG TCA ATA TAT T | |
| ATA AGA AGC TGG | Ut28 | 162 | TAT CAA AAG ATC | 257 |
| CGA TCT TTT GAT A | | | GCC AGC TTC TTA T | |
| GCT TAG GTC CTT | Ut29 | 163 | TTA TGG ACT ACA | 258 |
| TTG TAG TCC ATA A | | | AAA GGA CCT AAG C | |
| CCT TCT CAA TCC | Ut30 | 164 | ATT ACC CAT AAT | 259 |
| CAT TAT GGG TAA T | | | GGG ATT GAG AAG G | |
| GTG CAT TAA GTC | Ut31 | 165 | CTA GGG ATT TGT | 260 |
| AAC AAA TCC CTA G | | | TGA CTT AAT GCA C | |
| TCC ACT TCT GGT | Ut32 | 166 | GCT ACA CAA TTA | 261 |
| ATA ATT GTG TAG C | | | TAC CAG AAG TGG A | |
| TTT TTC CCC CAT | Ut33 | 167 | ATG AAA GGT ATA | 262 |
| GTA TAC CTT TCA T | | | CAT GGG GGA AAA A | |
| CTA CTT TTT AAG | Ut34 | 168 | TCA GAC TTC CTC | 263 |
| CGA GGA AGT CTG A | | | GCT TAA AAA GTA G | |
| CCT CTT ACA ATT | Ut35 | 169 | ACA GAG CTA ATG | 264 |
| CCA TTA GCT CTG T | | | GAA TTG TAA GAG G | |
| TGT GTT ATA AGC | Ut36 | 170 | AGG GAT TCT CCT | 265 |
| TAG GAG AAT CCC T | | | AGC TTA TAA CAC A | |
| TTT TTC CTA ATT | Ut37 | 171 | AAG AGA AAC CCC | 266 |
| GGG GGT TTC TCT T | | | CAA TTA GGA AAA A | |
| TAA CCT CAA GGA | Ut38 | 172 | AAG CTT TAT GGT | 267 |
| AAC CAT AAA GCT T | | | TTC CTT GAG GTT A | |
| TTG TAG TCC ATA | Ut39 | 173 | AAA TCA CCA TGC | 268 |
| AGC ATG GTG ATT T | | | TTA TGG ACT ACA A | |
| ACA TTT TCC CAA | Ut40 | 174 | ATA GGA TAT GTG | 269 |
| GCA CAT ATC CTA T | | | CTT GGG AAA ATG T | |
| AAC GCT TCA ACT | Ut41 | 175 | AAA ATC TAG ACT | 270 |
| CAG TCT AGA TTT T | | | GAG TTG AAG CGT T | |
| GTG CCA AAT GTA | Ut42 | 176 | TCT TAT TCA CTC | 271 |
| GGA GTG AAT AAG A | | | CTA CAT TTG GCA C | |
| GTG TAC TAT AAG | Ut43 | 177 | AGC AGG TAC TAG | 272 |
| GCT AGT ACC TGC T | | | CCT TAT AGT ACA C | |
| AAG AAA CAA GCG | Ut44 | 178 | TTA TTG CTT TTG | 273 |
| ACA AAA GCA ATA A | | | TCG CTT GTT TCT T | |
| AGC AGT TTA CAC | Ut45 | 179 | ATA AAA CAG TCC | 274 |
| AGG ACT GTT TTA T | | | TGT GTA AAC TGC T | |
| GTA CGC CAG TTC | Ut46 | 180 | TCT TTA TTT CTG | 275 |
| TCA GAA ATA AAG A | | | AGA ACT GGC GTA C | |
| AAT CCT TCA GCT | Ut47 | 181 | GCT CTG TTA CTT | 276 |
| AAA GTA ACA GAG C | | | TAG CTG AAG GAT T | |
| CTG AGG TCT AGG | Ut48 | 182 | TGT ACT TAT TGT | 277 |
| GAC AAT AAG TAC A | | | CCC TAG ACC TCA G | |
| GGA AAC ATC AGT | Ut49 | 183 | CCG TGT TTT ATT | 278 |
| GAA TAA AAC ACG G | | | CAC TGA TGT TTC C | |
| GTT GTA GAA ATC | Ut50 | 184 | GGG TGG TTA CTC | 279 |
| TGA GTA ACC ACC C | | | AGA TTT CTA CAA C | |
| TTT CAA TAA CAG | Ut51 | 185 | TTA GCA GCA CCA | 280 |
| ATG GTG CTG CTA A | | | TCT GTT ATT GAA A | |
| CTG GAT CCA CCA | Ut52 | 186 | ATA AAA CAA GTC | 281 |
| AGA CTT GTT TTA T | | | TTG GTG GAT CCA G | |
| CAG CAT GTT ACA | Ut53 | 187 | AAA AGC AGT CAT | 282 |
| AAT GAC TGC TTT T | | | TTG TAA CAT GCT G | |
| CCA GCC TTA GAA | Ut54 | 188 | GAG TAC ATG GAT | 283 |
| AAT CCA TGT ACT C | | | TTT CTA AGG CTG G | |
| GGA ATG GAT CAC | Ut55 | 189 | GTT ACA TGT CTA | 284 |
| GTA GAC ATG TAA C | | | CGT GAT CCA TTC C | |
| AGA AAC AAG CGA | Ut56 | 190 | GTT ATT GCT TTT | 285 |
| CAA AAG CAA TAA C | | | GTC GCT TGT TTC T | |
| GAA ACA AGC GAC | Ut57 | 191 | AGT TAT TGC TTT | 286 |
| AAA AGC AAT AAC T | | | TGT CGC TTG TTT C | |
| ATG AGC TTG TAT | Ut58 | 192 | GCT GTT TGG AAG | 287 |
| ACT TCC AAA CAG C | | | TAT ACA AGC TCA T | |
| GAC TTC ATT AGC | Ut59 | 193 | AGT GAA TCT GTG | 288 |
| ACA CAG ATT CAC T | | | TGC TAA TGA AGT C | |
| TGA AAT TGG TGG | Ut60 | 194 | CTC TTC TGC ATT | 289 |
| TAA TGC AGA AGA G | | | ACC ACC AAT TTC A | |
| CTC TGG AAT GTT | Ut61 | 195 | CTG AAC CAC CAT | 290 |
| TAT GGT GGT TCA G | | | AAA CAT TCC AGA G | |
| AAG AAA AGT CCA | Ut62 | 196 | CAA TCC ATG ACA | 291 |
| CTG TCA TGG ATT G | | | GTG GAC TTT TCT T | |
| TTT CTG TAT CAT | Ut63 | 197 | ATG ATG GGG AGA | 292 |
| GTC TCC CCA TCA T | | | CAT GAT ACA GAA A | |
| GCT GTG TAA ATG | Ut64 | 198 | GGT TTA TTG TGC | 293 |
| TGC ACA ATA AAC C | | | ACA TTT ACA CAG C | |
| GTC AGT TTT GTA | Ut65 | 199 | TGT TCA GTC TGT | 294 |
| CAC AGA CTG AAC A | | | GTA CAA AAC TGA C | |
| TTA AGC TTC AGT | Ut66 | 200 | CAG AAG ACA AGC | 295 |
| TGC TTG TCT TCT G | | | AAC TGA AGC TTA A | |
| ATA TCC ACA AGG | Ut67 | 201 | CAT GCA TTT ACG | 296 |
| TCG TAA ATG CAT G | | | ACC TTG TGG ATA T | |
| CAT CCT CTG TGT | Ut68 | 202 | AGG TTG ATT TTG | 297 |
| TCA AAA TCA ACC T | | | AAC ACA GAG GAT G | |
| AAC CTT GTT ACA | Ut69 | 203 | AAT GTG ATG ATG | 298 |
| GCA TCA TCA CAT T | | | CTG TAA CAA GGT T | |
| GCC TTA TTG GAG | Ut70 | 204 | CTT GAG AAC ATG | 299 |
| TCA TGT TCT CAA G | | | ACT CCA ATA AGG C | |
| CTT CAA GGT TTG | Ut71 | 205 | CAT TTG CAG TTT | 300 |
| GAA ACT GCA AAT G | | | CCA AAC CTT GAA G | |
| GGT ACT TTC TGT | Ut72 | 206 | CCA AAA GCC CAT | 301 |
| TAT GGG CTT TTG G | | | AAC AGA AAG TAC C | |
| GAG TCG CAT TTG | Ut73 | 207 | CTA AGC ATG TCT | 302 |
| TAG ACA TGC TTA G | | | ACA AAT GCG ACT C | |
| GCA GTC AGG TAC | Ut74 | 208 | TTC ACC TAA CTA | 303 |
| ATA GTT AGG TGA A | | | TGT ACC TGA CTG C | |
| CTG TTA GAT CTG | Ut75 | 209 | TTT TCC TGA GAG | 304 |
| CCT CTC AGG AAA A | | | GCA GAT CTA ACA G | |
| ATC TTC ATT AAG | Ut76 | 210 | TAT TGC GGT AGG | 305 |
| CCC TAC CGC AAT A | | | GCT TAA TGA AGA T | |
| GCC TCG TCA GTT | Ut77 | 211 | AAT CCT GTT AAA | 306 |
| TTT TAA CAG GAT T | | | AAA CTG ACG AGG C | |
| AGA GTA AAC AGA | Ut78 | 212 | CCA CCA CCT GTT | 307 |
| TAA CAG GTG GTG G | | | ATC TGT TTA CTC T | |
| CAC AGA CTG AAC | Ut79 | 213 | AAA GTG CTG TAT | 308 |
| AAT ACA GCA CTT T | | | TGT TCA GTC TGT G | |
| AGC CTT ATT GGA | Ut80 | 214 | TTG AGA ACA TGA | 309 |
| GTC ATG TTC TCA A | | | CTC CAA TAA GGC T | |
| TGT CTT GTG CAT | Ut81 | 215 | GGA AAC ACA AGT | 310 |
| TAC TTG TGT TTC C | | | AAT GCA CAA GAC A | |
| TGC TTG TCT TCT | Ut82 | 216 | AAC AGA AAG TAC | 311 |
| GGT ACT TTC TGT T | | | CAG AAG ACA AGC A | |
| AAC CTA ATG ATC | Ut83 | 217 | CCG GGA TTC AGA | 312 |
| ATC TGA ATC CCG G | | | TGA TCA TTA GGT T | |
| TTA TTT GGG CAA | Ut84 | 218 | GAA ACA TTC GGA | 313 |
| CTC CGA ATG TTT C | | | GTT GCC CAA ATA A | |
| TGC CAA AAA TGA | Ut85 | 219 | AAC AAT GCT ACA | 314 |
| GTG TAG CAT TGT T | | | CTC ATT TTT GGC A | |
| TAG ACA TGC TTA | Ut86 | 220 | GAC CCA CAG TTT | 315 |
| GAA ACT GTG GGT C | | | CTA AGC ATG TCT A | |
| CAC TGA CTG TAC | Ut87 | 221 | TTC ACC ACA CTA | 316 |
| ATA GTG TGG TGA A | | | TGT ACA GTC AGT G | |
| TGA GCC TTA TTG | Ut88 | 222 | GAG AAC ATG ACT | 317 |
| GAG TCA TGT TCT C | | | CCA ATA AGG CTC A | |
| TTT CAC ACA TAT | Ut89 | 223 | GAA GGC GGC AAT | 318 |
| AAT TGC CGC CTT C | | | TAT ATG TGT GAA A | |
| AGA TTC ACA ATA | Ut90 | 224 | TTC TTG GCC TGT | 319 |
| GAC AGG CCA AGA A | | | CTA TTG TGA ATC T | |
| ATT TCA TGG CTC | Ut91 | 225 | AAA ACT AGG GTG | 320 |
| TCA CCC TAG TTT T | | | AGA GCC ATG AAA T | |
| CTG CAT CAG TTG | Ut92 | 226 | CAA TTC CCC TTT | 321 |
| TAA AGG GGA ATT G | | | ACA ACT GAT GCA G | |
| ACA CAC GCA GCG | Ut93 | 227 | TAA TTT ATC AAA | 322 |
| TTT TGA TAA ATT A | | | ACG CTG CGT GTG T | |
| GAG CCT TAT TGG | Ut94 | 228 | TGA GAA CAT GAC | 323 |
| AGT CAT GTT CTC A | | | TCC AAT AAG GCT C | |
| TCA CTG AGG TGT | Ut95 | 229 | GTA CGT ACA ATT | 324 |
| GAA TTG TAC GTA C | | | CAC ACC TCA GTG A | |
| TAA AAG TAA TCC | Ut96 | 230 | TGG TTG TCA TCT | 325 |
| CAG ATG ACA ACC A | | | GGG ATT ACT TTT A | |

### Example 16

### Gel Shift Analysis of Sp-1 Protein Binding to Partially Double-Stranded Nucleic Acid Probes

IRDye 700 labeled oligos (YZ-7f, YZ-9f, YZ-11f, YZ-7b, YZ-9b and YZ-11b, see Table 17) were synthesized at Li-cor, Inc and annealed to be IRDye 700 labeled double strand DNA probes (YZ-7, YZ-9 and YZ-11). The double-stranded nucleic acid probes were mixed with SP-1 protein (Promega) under conditions that permit the protein to bind to the double-stranded nucleic acid and subjected to polyacrylamide gel electrophoresis.

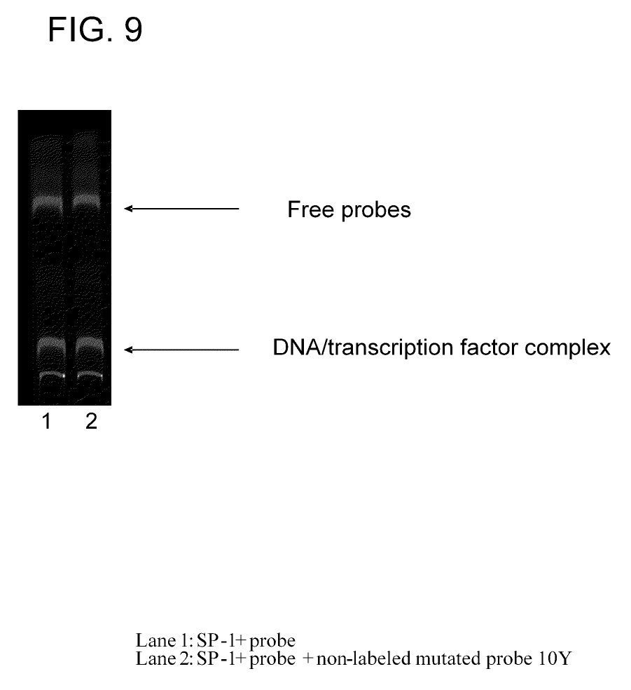

The gels were imaged, the results of which are shown in FIG. 9. With reference to FIG. 9 recombinant SP-1 is able to bind to the YZ9 partially double-stranded nucleic acid probe that included the SP-1 binding sequence. This result demonstrates that the SP-1 transcription factor bound double-stranded nucleic acid probes can be separated by gel electrophoresis.

TABLE 17
Probes for NF-kb

| | | SEQ |
|---|---|---|
| | | ID |
| Name | Sequence | NO: |
| YZ-7f | TCC TAG CTT CAG AGG GGA CTT TCC GAG AGG | 326 |
| | ACC TGA AGA AAT GGT TTT GAA TCA T | |
| YZ-7b | CCT CTC GGA AAG TCC CCT CTG AAG CTA GGA | 327 |

Probes for Sp1

| | | SEQ |
|---|---|---|
| | | ID |
| Name | Sequence | NO: |
| YZ-9f | AGC TTA TTC GAT CGG GGC GGG GCG AGC GAA | 328 |
| | GTT ATC CCA ACT TCG AAT CTC ATT T | |
| YZ-9b | TTC GCT CGC CCC GCC CCG ATC GAA TAA GCT | 329 |

Probes for ER-alpha

| | | SEQ |
|---|---|---|
| | | ID |
| Name | Sequence | NO: |
| YZ- | CCT GCC AGG TCG CGC TGC CCT CCT TCT ACC | 330 |
| 11f | ATG CCT TAG GAG AAT TGT TTT GTT T | |
| YZ- | GGT AGA AGG AGG GCA GCG CGA CCT GGC AGG | 331 |
| 11b | | |

### Example 17

### Microarray Analysis of Partially Double-Stranded Nucleic Acid Probes Selected as Sp-1 Binding Sites

For microarray analysis, 5′-end cyanine (Cy3) labeled oligonucleotides (YZ-7f, YZ-9f and YZ-110 and unlabeled oligonucleotides (YZ-7b, YZ-9b and YZ-11b) were synthesized at Integrated DNA Technologies, Inc. and annealed to yield Cy3-labeled double strand DNA probes. The probes include a double-stranded transcription factor binding motif and a unique single strand tag that can hybridize to a specific oligonucleotide printed on a microarray slide.

The Spl protein was mixed with a group of Cy3 labeled probes (YZ-7, YZ-9 and YZ-11) at room temperature for 30 minutes and then the protein/DNA complex was separated on the polyacrylamide column using the separation method described in Example 1. The collected protein/DNA complex was concentrated, the buffer changed to 5×SSC, 0.1% SDS, and the DNA hybridized to a microarray slide containing oligonucleotide DNA sequences shown in Table 18. Small amounts of YZ-2 and YZ-4 were added (shown in Table 19 and complementary to the sequences of YZ-1 and YZ-3). These sequences, shown in Table 19, serve as a positive control and reference signal. Only the Spl and control probes yielded positive signals (see table 20). This demonstrates that Sp1/DNA complexes can be separated and collected by the method and apparatus described, and then identified using microarray technology. The microarray result (shown in Table 20) was consistent with the result from the gel shift assay.

TABLE 18
Oligonucleotide sequences printed
on slide for microarray analysis

| | | SEQ |
|---|---|---|
| Name | Sequence | ID NO: |
| YZ1 | TGG TTG TCA TCT GGG ATT ACT TTT A | 332 |
| YZ3 | GGG TTT TTT TTT TCC CGT TTT TTT TGG G | 333 |
| Y-5t | ACA TAG CAT CCC TCA AAC TAT ACA A | 334 |
| Y-7t | AGC TTT GAA TGG TCT AGT CAA AAA A | 335 |
| Y-8t | TCT ACA TTC AGG ATA AGA TTT GGC T | 336 |
| Y-9t | AAA TGA GAT TCG AAG TTG GGA TAA C | 337 |
| Y-11t | AAA CAA AAC AAT TCT CCT AAG GCA T | 338 |
| Y-12t | CAA AGA AAA GGG GCT ACA CAA TTA T | 339 |
| Y-14 | ATG ATT CAA AAC CAT TTC TTC AGG T | 340 |
| Y-15 | TTA AAC ATT GTG TGT TAA CAC CTG T | 341 |
| y-16 | GGT TCA TAG ATG GTC AGT TTT GTA C | 342 |
| y-17 | AGT GTT CCC AAT CTG AAA TTC AAA A | 343 |
| y-18 | GTC CTG TTA TTC TGA CTA CAG TTC T | 344 |
| y-19 | CTG GAG TTA CAG TTT TCA ATC TGT C | 345 |
| y-20 | AAG CTA CGG TAC CAG TAA TTA GAT G | 346 |
| y-21 | TTG GAC ACT ATC TTG ATC AGA AGA G | 347 |
| y-22 | TCC ATG CAC ATT TAC AAT ATT GAG G | 348 |
| y-23 | GTT TTA GTT CCG TTC TCG TTT TCT T | 349 |
| y-24 | GCT AGA AAA ATA GGG CTG GAT CTT A | 350 |
| y-25 | CAT ATT GAT TGG TGA AAT TGG TGG T | 351 |
| y-26 | AAG TTG TTT GAG GCA AAT TAA CTG T | 352 |
| y-27 | TCT ATT GAA TTC GGA ACT GTC CTT T | 353 |
| y-28 | AAA GCC TCT TTT CGA ATA AAG CAA A | 354 |
| y-29 | AAT TGT TTT GTT TCA CAA AAG CTG G | 355 |

TABLE 19
Oligonucleotide sequences functioning as
positive control and reference signal

| | | SEQ |
|---|---|---|
| name | Sequence | ID NO: |
| YZ2 | TAA AAG TAA TCC CAG ATG ACA ACC A | 356 |
| YZ4 | CCC AAA AAA AAC GGG AAA AAA AAA ACC | 357 |

TABLE 20
Identification of Sp1/DNA complex by microarray

| Probe | Signal |
|---|---|
| Y-5t | 0 |
| Y-7t | 0 |
| Y-8t | 0 |
| Y-9t | 936.1735 |
| YZ2 | 2051.364 |
| YZ4 | 498.5943 |
| Y-11t | 0 |
| Y-12t | 0 |
| Y-14 | 0 |
| Y-15 | 0 |
| Y-16 | 0 |
| Y-17 | 0 |
| Y-18 | 0 |
| Y-19 | 0 |
| Y-20 | 0 |
| Y-21 | 0 |
| Y-22 | 0 |
| Y-23 | 0 |
| Y-24 | 0.4779 |
| Y-25 | 0 |
| Y-26 | 0 |
| Y-27 | 0 |
| Y-28 | 0 |
| Y-29 | 0 |

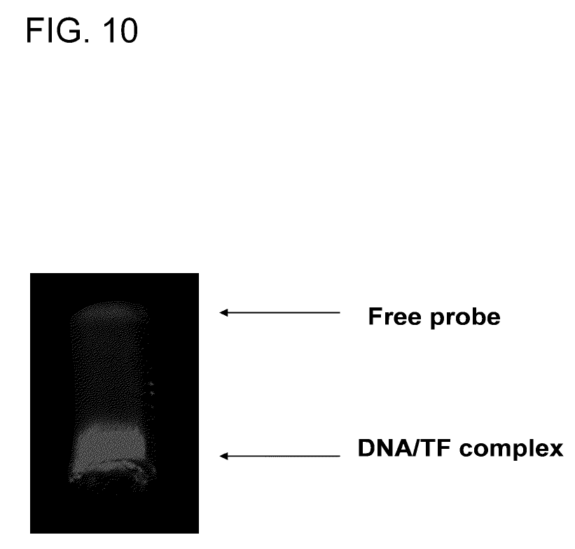

A similar result is obtained using recombinant estrogen receptor alpha (ER-alpha) protein. ER-alpha is obtained from INVITROGEN® and mixed with YZ11 (its specific probe) labeled with IR Dye 700. The mixture was then loaded on the column gel and run for 30 minutes (FIG. 10).

### Example 18

### Microarray Analysis of Partially Double-Stranded Nucleic acid Probes Selected as Sp-1 Binding Site and Concentrated with Reversed Electrophoresis

5′-end cyanine (Cy3) labeled oligonucleotides (YZ-7f, YZ-9f and YZ-11f) and unlabeled oligonucleotides (YZ-7b, YZ-9b and YZ-11b) are synthesized at Integrated DNA Technologies, Inc. and are annealed to yield Cy3-labeled double strand DNA probes. The probes include a double-stranded transcription factor binding motif and a unique single strand tag that can hybridize to a specific oligonucleotide printed on a microarray slide.

The Sp1 protein is mixed with a group of Cy3 labeled probes (YZ-7, YZ-9 and YZ-11) at room temperature for 30 minutes and then the protein/DNA complex is separated from unbound probes on the polyacrylamide column using for a period of time sufficient for the unbound probes to elute from the distal end of the electrophoresis gel. The orientation of the column is reversed and the sample is electrophoreses for a period of time sufficient for the protein/DNA to elute from the proximal end of the electrophoresis gel. The protein/DNA complexes are collected. The buffer is changed to 5×SSC, 0.1% SDS, and the DNA is hybridized to a microarray slide containing oligonucleotide DNA sequences shown in Table 18. Small amounts of YZ-2 and YZ-4 are added (shown in Table 19 and complementary to the sequences of YZ-1 and YZ-3) as a positive control and reference signal.

### Example 19

### Identification of Transcription Factor Modulators

This example describes the methods that can be used used to identify agents that act as modulators of transcription factor double-stranded DNA binding.

A library of chemical compounds is obtained, for example from the Developmental Therapeutics Program NCl/NIH, and screened for their effect transcription factor binding to partially double-stranded nucleic acid probes.

Mammalian cell suspensions in multiwell plates, such as Baf3 cells or other primary cell-lines available from ATCC (Manassas, Va.), are contacted with test agent in serial dilution, for example 1nM to 1mM of test agent. The nuclear extract is obtained from the cell using the method of Dignam (Nucleic Acids Res. 11(5):1475-89, 1983). The nuclear extracts are contacted with a library of partially double-stranded nucleic acid probes, for example 10-1000 partially double-stranded nucleic acid probes each containing a double-stranded region of DNA corresponding to the binding site for a specific transcription factor and a single-stranded region corresponding to a index sequence that hybridizes to an indexing probe. The double-stranded nucleic acid binding protein/partially double-stranded nucleic acid probe binding is performed according to a modified protocol of Truter et al. (J. Biol. Chem. 267: 25389-25395) with slight modifications (see example 4) for a time period sufficient to permit binding, for example between 10 seconds and 10 hours. The protein bound partially double-stranded nucleic acid probes are separated from the unbound probes using gel electrophoresis. The isolated probes are contacted to an indexing array to determine which transcription factors bound to the double-stranded nucleic acid probe. Agents identified as modulator of transcription factor binding, for example by comparison to the transcription factors in a cellular sample not contacted with a test agent, are used as lead compounds to identify other agents having even greater modulatory effects transcription factor binding. For example, chemical analogs of identified chemical entities, or variant, fragments of fusions of peptide agents, are tested for their activity methods described herein. Candidate agents also can be tested in cell lines and animal models to determine their therapeutic value. The agents also can be tested for safety in animals, and then used for clinical trials in animals or humans.

### Example 20

### Profiling of Disease States

This example describes the methods that can be used used to correlate a disease state to transcription factor double-stranded DNA binding.

Nuclear extract is obtained from cells obtained from a diseases tissue, such as a cancerous tissue, or a tissue with an infection. The nuclear extracts are contacted with a library of partially double-stranded nucleic acid probes, for example 10-1000 partially double-stranded nucleic acid probes each containing a double-stranded region of DNA corresponding to the binding site for a specific transcription factor and a single-stranded region corresponding to a index sequence that hybridizes to an indexing probe. The double-stranded nucleic acid binding protein/partially double-stranded nucleic acid probe binding is performed according to a modified protocol of Truter et al. (see example 4) for a time period sufficient to permit binding, for example between 10 seconds and 10 hours. The protein bound partially double-stranded nucleic acid probes are separated from the unbound probes using gel electrophoresis. The isolated probes are contacted to an indexing array to determine which transcription factors bound to the double-stranded nucleic acid probes. The transcription factors identified are then correlated to the disease state of the tissue. In this way, a transcription factor profile, such as a transcription factor profile for a cancer, is generated. Transcription factors correlated to a particular disease state represent potential therapeutic targets.

While this disclosure has been described with an emphasis upon particular embodiments, it will be obvious to those of ordinary skill in the art that variations of the particular embodiments can be used, and it is intended that the disclosure may be practiced otherwise than as specifically described herein. Features, characteristics, compounds, chemical moieties, or examples described in conjunction with a particular aspect, embodiment, or example of the disclosure are to be understood to be applicable to any other aspect, embodiment, or example of the disclosure. Accordingly, this disclosure includes all modifications encompassed within the spirit and scope of the disclosure as defined by the following claims.

1. A method for identifying a double-stranded nucleic acid protein binding site, comprising:
(a) contacting a sample comprising double-stranded nucleic acid binding proteins with at least one partially double-stranded nucleic acid probe under conditions that permit binding of the double-stranded binding proteins and the partially double-stranded nucleic acid probe, wherein the partially double-stranded nucleic acid probe comprises:
(i) a first portion, comprising a single-stranded nucleic acid region of at least about 15 nucleotides in length, wherein the single-stranded nucleic acid region comprises a unique index sequence; and
(ii) a second portion covalently linked to the first portion, wherein the second portion comprises a double-stranded nucleic acid region of at least about 8 base pairs in length, and wherein the double-stranded region comprises at least one binding site for at least one double-stranded nucleic acid binding protein;
(b) isolating the partially double-stranded nucleic acid probe bound by at least one double-stranded nucleic acid binding protein using gel electrophoresis;
(c) hybridizing the partially double-stranded nucleic acid probe to a nucleic acid indexing probe, wherein the indexing probe comprises a single-stranded nucleic acid sequence complementary to the unique index sequence present in the single-stranded region of the partially double-stranded nucleic acid probe; and
(d) detecting hybridization between the indexing probe and the partially double-stranded nucleic acid probe, wherein detection of hybridization identifies the double-stranded nucleic acid protein binding site.

2. The method of claim 1, comprising identifying a double-stranded nucleic acid binding protein modulator, the method further comprising:
contacting the sample with a test agent; and
comparing the identified nucleic acid sequence that binds double-stranded nucleic acid binding proteins in the sample with a control, wherein a difference between the identified nucleic acid sequence that binds double-stranded nucleic acid and the control identifies the test agent as a double-stranded nucleic acid binding protein modulator.

3. (canceled)

4. (canceled)

5. The method of claim 1, wherein isolating the partially double-stranded nucleic acid probe bound by at least one double-stranded nucleic acid binding protein comprises isolating an antibody double-stranded binding protein complex.

6. (canceled)

7. (canceled)

8. (canceled)

9. (canceled)

10. The method of claim 1, wherein the double-stranded portion of the partially double-stranded nucleic acid probe comprises at least one transcription factor binding site or a mutation thereof.

11. The method of claim 1, wherein the double-stranded region of the partially double-stranded nucleic acid probe comprises a nucleic acid sequence corresponding to a region of a promoter of a gene of interest.

12. (canceled)

13. (canceled)

14. (canceled)

15. (canceled)

16. (canceled)

17. The method of claim 1, wherein the single-stranded nucleic acid region of the partially double-stranded nucleic acid probe comprises from about 30% to about 70% guanine and cytosine.

18. (canceled)

19. (canceled)

20. (canceled)

21. The method of claim 1, further comprising isolating the double-stranded DNA binding protein bound to the double-stranded nucleic acid probe and determining the identity of the isolated double-stranded binding protein.

22. (canceled)

23. (canceled)

24. The method of claim 1, wherein contacting the sample with at least one partially double-stranded nucleic acid probe comprises:
contacting the sample with a plurality of partially double-stranded nucleic acid probes with different index sequences, wherein the different index sequences are complementary to different indexing probes; and
detecting hybridization between the different indexing probes and the different partially double-stranded nucleic acid probes, wherein detection of hybridization identifies nucleic acid sequences that bind double-stranded nucleic acid binding proteins.

25. (canceled)

26. The method of claim 1, further comprising correlating the identified nucleic acid sequence that binds double-stranded nucleic acid binding proteins to a disease or condition.

27. (canceled)

28. (canceled)

29. (canceled)

30. A method for diagnosing a disease or condition, the method comprising:
identifying a double-stranded nucleic acid binding sites according to claim 1;
comparing the identified nucleic acid sequence that binds double-stranded nucleic acid binding proteins with a control indicative of a disease or condition, wherein a similarity between the identified nucleic acid sequence that binds double-stranded nucleic acid and the control diagnoses the disease or condition.

31. (canceled)

32. (canceled)

33. The method of claim 30, wherein the nucleic acid sequence that binds double-stranded nucleic acid correlated to a disease or condition is identified by correlating the identified nucleic acid sequence that binds double-stranded nucleic acid binding proteins to an environmental condition.

34. A method for identifying double-stranded nucleic acid binding proteins affected by an environmental condition, the method comprising:
exposing a sample to an environmental condition;
identifying a double-stranded nucleic acid binding sites according to claim 1; and
comparing the identified nucleic acid sequence that binds double-stranded nucleic acid binding proteins in the sample with a control, wherein a difference between the identified nucleic acid sequence that binds double-stranded nucleic acid and the control identifies double-stranded nucleic acid binding proteins affected by the environmental condition.

35. The method of claim 34, wherein the environmental condition is an environmental stress.

36. A kit, comprising:
(a) a partially double-stranded nucleic acid probe comprising:
(i) a first portion, comprising a single-stranded nucleic acid region of at least about 15 nucleotides in length, wherein the single-stranded nucleic acid region comprises a unique index sequence; and
(ii) a second portion covalently linked to the first portion, wherein the second portion comprises a double-stranded nucleic acid region of greater than about nucleotide base pairs in length, and wherein the double-stranded region comprises at least one binding site for at least one double-stranded nucleic acid binding protein; and
(b) a nucleic acid indexing probe, wherein the indexing probe comprises a single-stranded nucleic acid complementary to the unique index sequence present in single-stranded region of the partially double-stranded nucleic acid probe.

37. (canceled)

38. (canceled)

39. (canceled)

40. (canceled)

41. (canceled)

42. The kit of claim 36, wherein the single-stranded nucleic acid region of the partially double-stranded nucleic acid probe comprises from about 30% to about 70% guanine and cytosine.

43. The kit of claim 36, wherein the partially double-stranded nucleic acid probe comprises a detectable label.

44. The kit of claim 36, wherein the indexing probe comprises a detectable label.

45. The kit of claim 36, wherein the indexing probe is immobilized on solid support.

46. The kit of claim 45, wherein the solid support comprises a nucleic acid microarray.


SEQUENCE LISTING (357 sequences)

SEQ ID NO: 1 - DNA, 20 bp, Artificial sequence
  Hypothetical oligonucleotide illustrating percent identity.
atggtggacccggtgggctt

SEQ ID NO: 2 - DNA, 20 bp, Artificial sequence
  Hypothetical oligonucleotide illustrating percent identity.
acgggggatccggcgggcct

SEQ ID NO: 3 - DNA, 41 bp, Artificial sequence
  Synthetic oligonucleotide probe.
cgtggaatttcctctgttgtatagtttgagggatgctatgt

SEQ ID NO: 4 - DNA, 41 bp, Artificial sequence
  Synthetic oligonucleotide probe.
cgttaactttcctctgttgtatagtttgagggatgctatgt

SEQ ID NO: 5 - DNA, 51 bp, Artificial sequence
  Synthetic oligonucleotide probe.
agcttcagaggggactttccgagaggttttttgactagaccattcaaagct

SEQ ID NO: 6 - DNA, 51 bp, Artificial sequence
  Synthetic oligonucleotide probe.
agcttcagaggggactaaacgagaggttttttgactagaccattcaaagct

SEQ ID NO: 7 - DNA, 60 bp, Artificial sequence
  Synthetic oligonucleotide probe.
gtccaaagtcaggtcacagtgacctgatcaaagttatgccttaggagaattgttttgttt

SEQ ID NO: 8 - DNA, 55 bp, Artificial sequence
  Synthetic oligonucleotide probe.
gtccaaagtcagaacacagtgatttgatcaatgccttaggagaattgttttgttt

SEQ ID NO: 9 - DNA, 55 bp, Artificial sequence
  Synthetic oligonucleotide probe.
gtccaaagtcaggtcacagtgacctgatcaatgccttaggagaattgttttgttt

SEQ ID NO: 10 - DNA, 47 bp, Artificial sequence
  Synthetic oligonucleotide probe.
attcgatcggggcggggcgagcgttatcccaacttcgaatctcattt

SEQ ID NO: 11 - DNA, 47 bp, Artificial sequence
  Synthetic oligonucleotide probe.
attcgatcgggaaagggcgagcgttatcccaacttcgaatctcattt

SEQ ID NO: 12 - DNA, 360 bp, Homo sapiens
cctcgcattctcctcctcctctgctcctcccgatccctcctccgccgcctggtccctcctcctcccgccctgcctccccgcgcctcggcccgcgcgagctagacgtccgggcagcccccggcgcagcgcggccgcagcagcctccgccccccgcacggtgtgagcgcccgacgcggccgaggcggccggagtcccgagctagccccggcggccgccgccgcccagaccggacgacaggccacctcgtcggcgtccgcccgagtccccgcctcgccgccaacgccacaaccaccgcgcacggccccctgactccgtccagtattgatcgggagagccggagcgagctcttcggggagcagc

SEQ ID NO: 13 - DNA, 15 bp, Homo sapiens
cccgatccctcctcc

SEQ ID NO: 14 - DNA, 7 bp, Homo sapiens
ccgccgc

SEQ ID NO: 15 - DNA, 13 bp, Homo sapiens
cccgcgcgagcta

SEQ ID NO: 16 - DNA, 10 bp, Homo sapiens
gacgtccggg

SEQ ID NO: 17 - DNA, 13 bp, Homo sapiens
cagcgcggccgca

SEQ ID NO: 18 - DNA, 7 bp, Homo sapiens
ccgccgc

SEQ ID NO: 19 - DNA, 7 bp, Homo sapiens
ccgccgc

SEQ ID NO: 20 - DNA, 12 bp, Homo sapiens
ccgccaacgcca

SEQ ID NO: 21 - DNA, 10 bp, Homo sapiens
tattgatcgg

SEQ ID NO: 22 - DNA, 13 bp, Homo sapiens
ccggagcgagctc

SEQ ID NO: 23 - DNA, 13 bp, Homo sapiens
gagcgagctcttc

SEQ ID NO: 24 - DNA, 40 bp, Artificial sequence
  Synthetic oligonucleotide probe.
cctcgcattctcctcctcctctgctcctcccgatccctcc

SEQ ID NO: 25 - DNA, 40 bp, Artificial sequence
  Synthetic oligonucleotide probe.
ctgctcctcccgatccctcctccgccgcctggtccctcct

SEQ ID NO: 26 - DNA, 40 bp, Artificial sequence
  Synthetic oligonucleotide probe.
tccgccgcctggtccctcctcctcccgccctgcctccccg

SEQ ID NO: 27 - DNA, 40 bp, Artificial sequence
  Synthetic oligonucleotide probe.
cctcccgccctgcctccccgcgcctcggcccgcgcgagct

SEQ ID NO: 28 - DNA, 40 bp, Artificial sequence
  Synthetic oligonucleotide probe.
cgcctcggcccgcgcgagctagacgtccgggcagcccccg

SEQ ID NO: 29 - DNA, 40 bp, Artificial sequence
  Synthetic oligonucleotide probe.
agacgtccgggcagcccccggcgcagcgcggccgcagcag

SEQ ID NO: 30 - DNA, 40 bp, Artificial sequence
  Synthetic oligonucleotide probe.
gcgcagcgcggccgcagcagcctccgccccccgcacggtg

SEQ ID NO: 31 - DNA, 40 bp, Artificial sequence
  Synthetic oligonucleotide probe.
cctccgccccccgcacggtgtgagcgcccgacgcggccga

SEQ ID NO: 32 - DNA, 40 bp, Artificial sequence
  Synthetic oligonucleotide probe.
tgagcgcccgacgcggccgaggcggccggagtcccgagct

SEQ ID NO: 33 - DNA, 40 bp, Artificial sequence
  Synthetic oligonucleotide probe.
ggcggccggagtcccgagctagccccggcggccgccgccg

SEQ ID NO: 34 - DNA, 40 bp, Artificial sequence
  Synthetic oligonucleotide probe.
agccccggcggccgccgccgcccagaccggacgacaggcc

SEQ ID NO: 35 - DNA, 40 bp, Artificial sequence
  Synthetic oligonucleotide probe.
cccagaccggacgacaggccacctcgtcggcgtccgcccg

SEQ ID NO: 36 - DNA, 40 bp, Artificial sequence
  Synthetic oligonucleotide probe.
acctcgtcggcgtccgcccgagtccccgcctcgccgccaa

SEQ ID NO: 37 - DNA, 40 bp, Artificial sequence
  Synthetic oligonucleotide probe.
agtccccgcctcgccgccaacgccacaaccaccgcgcacg

SEQ ID NO: 38 - DNA, 40 bp, Artificial sequence
  Synthetic oligonucleotide probe.
cgccacaaccaccgcgcacggccccctgactccgtccagt

SEQ ID NO: 39 - DNA, 40 bp, Artificial sequence
  Synthetic oligonucleotide probe.
gccccctgactccgtccagtattgatcgggagagccggag

SEQ ID NO: 40 - DNA, 40 bp, Artificial sequence
  Synthetic oligonucleotide probe.
attgatcgggagagccggagcgagctcttcggggagcagc

SEQ ID NO: 41 - DNA, 40 bp, Artificial sequence
  Synthetic oligonucleotide probe.
ggagggatcgggaggagcagaggaggaggagaatgcgagg

SEQ ID NO: 42 - DNA, 40 bp, Artificial sequence
  Synthetic oligonucleotide probe.
aggagggaccaggcggcggaggagggatcgggaggagcag

SEQ ID NO: 43 - DNA, 40 bp, Artificial sequence
  Synthetic oligonucleotide probe.
cggggaggcagggcgggaggaggagggaccaggcggcgga

SEQ ID NO: 44 - DNA, 40 bp, Artificial sequence
  Synthetic oligonucleotide probe.
agctcgcgcgggccgaggcgcggggaggcagggcgggagg

SEQ ID NO: 45 - DNA, 40 bp, Artificial sequence
  Synthetic oligonucleotide probe.
cgggggctgcccggacgtctagctcgcgcgggccgaggcg

SEQ ID NO: 46 - DNA, 40 bp, Artificial sequence
  Synthetic oligonucleotide probe.
ctgctgcggccgcgctgcgccgggggctgcccggacgtct

SEQ ID NO: 47 - DNA, 40 bp, Artificial sequence
  Synthetic oligonucleotide probe.
caccgtgcggggggcggaggctgctgcggccgcgctgcgc

SEQ ID NO: 48 - DNA, 40 bp, Artificial sequence
  Synthetic oligonucleotide probe.
tcggccgcgtcgggcgctcacaccgtgcggggggcggagg

SEQ ID NO: 49 - DNA, 40 bp, Artificial sequence
  Synthetic oligonucleotide probe.
agctcgggactccggccgcctcggccgcgtcgggcgctca

SEQ ID NO: 50 - DNA, 40 bp, Artificial sequence
  Synthetic oligonucleotide probe.
cggcggcggccgccggggctagctcgggactccggccgcc

SEQ ID NO: 51 - DNA, 40 bp, Artificial sequence
  Synthetic oligonucleotide probe.
ggcctgtcgtccggtctgggcggcggcggccgccggggct

SEQ ID NO: 52 - DNA, 40 bp, Artificial sequence
  Synthetic oligonucleotide probe.
cgggcggacgccgacgaggtggcctgtcgtccggtctggg

SEQ ID NO: 53 - DNA, 40 bp, Artificial sequence
  Synthetic oligonucleotide probe.
ttggcggcgaggcggggactcgggcggacgccgacgaggt

SEQ ID NO: 54 - DNA, 40 bp, Artificial sequence
  Synthetic oligonucleotide probe.
cgtgcgcggtggttgtggcgttggcggcgaggcggggact

SEQ ID NO: 55 - DNA, 40 bp, Artificial sequence
  Synthetic oligonucleotide probe.
actggacggagtcagggggccgtgcgcggtggttgtggcg

SEQ ID NO: 56 - DNA, 40 bp, Artificial sequence
  Synthetic oligonucleotide probe.
ctccggctctcccgatcaatactggacggagtcagggggc

SEQ ID NO: 57 - DNA, 40 bp, Artificial sequence
  Synthetic oligonucleotide probe.
gctgctccccgaagagctcgctccggctctcccgatcaat

SEQ ID NO: 58 - DNA, 160 bp, Homo sapiens
tctgtgcgccactatccttgtgggtggaccaggagtcggttcgagggtgctcccacttagaggtcacgcgcggcgtcgggcgttcctgagaccgtcgggctccctggctcggtcacgtgggctcaggcactactcccctctaccctcctctcggtcttta

SEQ ID NO: 59 - DNA, 28 bp, Homo sapiens
ctatccttgtgggtgcacgcgcggcgtc

SEQ ID NO: 60 - DNA, 15 bp, Homo sapiens
gggcgttcctgagac

SEQ ID NO: 61 - DNA, 15 bp, Homo sapiens
cctggctcggtcacg

SEQ ID NO: 62 - DNA, 10 bp, Homo sapiens
ggtcacgtgg

SEQ ID NO: 63 - DNA, 12 bp, Homo sapiens
ggtcacgtgggc

SEQ ID NO: 64 - DNA, 15 bp, Homo sapiens
cctctaccctcctct

SEQ ID NO: 65 - DNA, 40 bp, Artificial sequence
  Synthetic oligonucleotide probe.
tctgtgcgccactatccttgtgggtggaccaggagtcggt

SEQ ID NO: 66 - DNA, 40 bp, Artificial sequence
  Synthetic oligonucleotide probe.
tgggtggaccaggagtcggttcgagggtgctcccacttag

SEQ ID NO: 67 - DNA, 40 bp, Artificial sequence
  Synthetic oligonucleotide probe.
tcgagggtgctcccacttagaggtcacgcgcggcgtcggg

SEQ ID NO: 68 - DNA, 40 bp, Artificial sequence
  Synthetic oligonucleotide probe.
aggtcacgcgcggcgtcgggcgttcctgagaccgtcgggc

SEQ ID NO: 69 - DNA, 40 bp, Artificial sequence
  Synthetic oligonucleotide probe.
cgttcctgagaccgtcgggctccctggctcggtcacgtgg

SEQ ID NO: 70 - DNA, 40 bp, Artificial sequence
  Synthetic oligonucleotide probe.
tccctggctcggtcacgtgggctcaggcactactcccctc

SEQ ID NO: 71 - DNA, 40 bp, Artificial sequence
  Synthetic oligonucleotide probe.
gctcaggcactactcccctctaccctcctctcggtcttta

SEQ ID NO: 72 - DNA, 40 bp, Artificial sequence
  Synthetic oligonucleotide probe.
accgactcctggtccacccacaaggatagtggcgcacaga

SEQ ID NO: 73 - DNA, 40 bp, Artificial sequence
  Synthetic oligonucleotide probe.
ctaagtgggagcaccctcgaaccgactcctggtccaccca

SEQ ID NO: 74 - DNA, 40 bp, Artificial sequence
  Synthetic oligonucleotide probe.
cccgacgccgcgcgtgacctctaagtgggagcaccctcga

SEQ ID NO: 75 - DNA, 40 bp, Artificial sequence
  Synthetic oligonucleotide probe.
gcccgacggtctcaggaacgcccgacgccgcgcgtgacct

SEQ ID NO: 76 - DNA, 40 bp, Artificial sequence
  Synthetic oligonucleotide probe.
ccacgtgaccgagccagggagcccgacggtctcaggaacg

SEQ ID NO: 77 - DNA, 40 bp, Artificial sequence
  Synthetic oligonucleotide probe.
gaggggagtagtgcctgagcccacgtgaccgagccaggga

SEQ ID NO: 78 - DNA, 40 bp, Artificial sequence
  Synthetic oligonucleotide probe.
taaagaccgagaggagggtagaggggagtagtgcctgagc

SEQ ID NO: 79 - DNA, 100 bp, Homo sapiens
ggacgggagtccgggtcaaagcggcctggtgtgcggcgcgccccgccccccgcaggccccgccctgccaggtcgcgctgccctccttctacccagtcctt

SEQ ID NO: 80 - DNA, 80 bp, Homo sapiens
tgtgtgcccaagcactgtcggggccccggggcgggggagcggctacttttagggattcctgatctcgccgcaagaactgg

SEQ ID NO: 81 - DNA, 19 bp, Homo sapiens
ccgggtcaaagcggcctgg

SEQ ID NO: 82 - DNA, 13 bp, Homo sapiens
cggcgcgccccgc

SEQ ID NO: 83 - DNA, 10 bp, Homo sapiens
ccccgccccc

SEQ ID NO: 84 - DNA, 13 bp, Homo sapiens
ccccccgcaggcc

SEQ ID NO: 85 - DNA, 12 bp, Homo sapiens
cccccgcaggcc

SEQ ID NO: 86 - DNA, 23 bp, Homo sapiens
tgccaggtcgcgctgccctcctt

SEQ ID NO: 87 - DNA, 23 bp, Homo sapiens
tgccaggtcgcgctgccctcctt

SEQ ID NO: 88 - DNA, 13 bp, Homo sapiens
ccaggtcgcgctg

SEQ ID NO: 89 - DNA, 12 bp, Homo sapiens
ggccccggggcg

SEQ ID NO: 90 - DNA, 12 bp, Homo sapiens
ggccccggggcg

SEQ ID NO: 91 - DNA, 9 bp, Homo sapiens
gccccgggg

SEQ ID NO: 92 - DNA, 9 bp, Homo sapiens
ccccggggc

SEQ ID NO: 93 - DNA, 10 bp, Homo sapiens
cggggcgggg

SEQ ID NO: 94 - DNA, 40 bp, Artificial sequence
  Synthetic oligonucleotide probe.
ggacgggagtccgggtcaaagcggcctggtgtgcggcgcg

SEQ ID NO: 95 - DNA, 40 bp, Artificial sequence
  Synthetic oligonucleotide probe.
gcggcctggtgtgcggcgcgccccgccccccgcaggcccc

SEQ ID NO: 96 - DNA, 40 bp, Artificial sequence
  Synthetic oligonucleotide probe.
ccccgccccccgcaggccccgccctgccaggtcgcgctgc

SEQ ID NO: 97 - DNA, 40 bp, Artificial sequence
  Synthetic oligonucleotide probe.
gccctgccaggtcgcgctgccctccttctacccagtcctt

SEQ ID NO: 98 - DNA, 40 bp, Artificial sequence
  Synthetic oligonucleotide probe.
cgcgccgcacaccaggccgctttgacccggactcccgtcc

SEQ ID NO: 99 - DNA, 40 bp, Artificial sequence
  Synthetic oligonucleotide probe.
ggggcctgcggggggcggggcgcgccgcacaccaggccgc

SEQ ID NO: 100 - DNA, 40 bp, Artificial sequence
  Synthetic oligonucleotide probe.
gcagcgcgacctggcagggcggggcctgcggggggcgggg

SEQ ID NO: 101 - DNA, 40 bp, Artificial sequence
  Synthetic oligonucleotide probe.
aaggactgggtagaaggagggcagcgcgacctggcagggc

SEQ ID NO: 102 - DNA, 40 bp, Artificial sequence
  Synthetic oligonucleotide probe.
tgtgtgcccaagcactgtcggggccccggggcgggggagc

SEQ ID NO: 103 - DNA, 40 bp, Artificial sequence
  Synthetic oligonucleotide probe.
gggccccggggcgggggagcggctacttttagggattcct

SEQ ID NO: 104 - DNA, 40 bp, Artificial sequence
  Synthetic oligonucleotide probe.
ggctacttttagggattcctgatctcgccgcaagaactgg

SEQ ID NO: 105 - DNA, 40 bp, Artificial sequence
  Synthetic oligonucleotide probe.
gctcccccgccccggggccccgacagtgcttgggcacaca

SEQ ID NO: 106 - DNA, 40 bp, Artificial sequence
  Synthetic oligonucleotide probe.
aggaatccctaaaagtagccgctcccccgccccggggccc

SEQ ID NO: 107 - DNA, 40 bp, Artificial sequence
  Synthetic oligonucleotide probe.
ccagttcttgcggcgagatcaggaatccctaaaagtagcc

SEQ ID NO: 108 - DNA, 40 bp, Artificial sequence
  Synthetic oligonucleotide probe.
gtcggcgtccgcccgagtccccgcctcgccgccaacgcca

SEQ ID NO: 109 - DNA, 40 bp, Artificial sequence
  Synthetic oligonucleotide probe.
tggcgttggcggcgaggcggggactcgggcggacgccgac

SEQ ID NO: 110 - DNA, 40 bp, Artificial sequence
  Synthetic oligonucleotide probe.
gtcggcgtccgcccgagtctttgtctcgccgccaacgcca

SEQ ID NO: 111 - DNA, 40 bp, Artificial sequence
  Synthetic oligonucleotide probe.
tggcgttggcggcgagacaaagactcgggcggacgccgac

SEQ ID NO: 112 - DNA, 35 bp, Artificial sequence
  Synthetic oligonucleotide probe.
gtccaaagtcaggtcacagtgacctgatcaaagtt

SEQ ID NO: 113 - DNA, 35 bp, Artificial sequence
  Synthetic oligonucleotide probe.
aactttgatcaggtcactgtgacctgactttggac

SEQ ID NO: 114 - DNA, 30 bp, Artificial sequence
  Synthetic oligonucleotide probe.
gtccaaagtcagaacacagtgatttgatca

SEQ ID NO: 115 - DNA, 30 bp, Artificial sequence
  Synthetic oligonucleotide probe.
tgatcaaatcactgtgttctgactttggac

SEQ ID NO: 116 - DNA, 30 bp, Artificial sequence
  Synthetic oligonucleotide probe.
gtccaaagtcaggtcacagtgacctgatca

SEQ ID NO: 117 - DNA, 30 bp, Artificial sequence
  Synthetic oligonucleotide probe.
tgatcaggtcactgtgacctgactttggac

SEQ ID NO: 118 - DNA, 26 bp, Artificial sequence
  Synthetic oligonucleotide probe.
ccacttagaggtcacgcgcggcgtcg

SEQ ID NO: 119 - DNA, 26 bp, Artificial sequence
  Synthetic oligonucleotide probe.
cgacgccgcgcgtgacctctaagtgg

SEQ ID NO: 120 - DNA, 26 bp, Artificial sequence
  Synthetic oligonucleotide probe.
ccacttagttgttacgcgcggcgtcg

SEQ ID NO: 121 - DNA, 26 bp, Artificial sequence
  Synthetic oligonucleotide probe.
cgacgccgcgcgtaacaactaagtgg

SEQ ID NO: 122 - DNA, 30 bp, Artificial sequence
  Synthetic oligonucleotide probe.
cctgccaggtcgcgctgccctccttctacc

SEQ ID NO: 123 - DNA, 30 bp, Artificial sequence
  Synthetic oligonucleotide probe.
ggtagaaggagggcagcgcgacctggcagg

SEQ ID NO: 124 - DNA, 30 bp, Artificial sequence
  Synthetic oligonucleotide probe.
cctgcttgttcgagctgcactccttctacc

SEQ ID NO: 125 - DNA, 30 bp, Artificial sequence
  Synthetic oligonucleotide probe.
ggtagaaggagtgcagctcgaacaagcagg

SEQ ID NO: 126 - DNA, 28 bp, Artificial sequence
  Synthetic oligonucleotide probe.
agcttattcgatcggggcggggcgagcg

SEQ ID NO: 127 - DNA, 28 bp, Artificial sequence
  Synthetic oligonucleotide probe.
cgctcgccccgccccgatcgaataagct

SEQ ID NO: 128 - DNA, 40 bp, Artificial sequence
  Synthetic oligonucleotide probe.
cgatcggggcggggcgagcagtcaggtcacagtgacctga

SEQ ID NO: 129 - DNA, 40 bp, Artificial sequence
  Synthetic oligonucleotide probe.
tcaggtcactgtgacctgactgctcgccccgccccgatcg

SEQ ID NO: 130 - DNA, 40 bp, Artificial sequence
  Synthetic oligonucleotide probe.
cgatcttttagggacgagcagtcaggtcacagtgacctga

SEQ ID NO: 131 - DNA, 40 bp, Artificial sequence
  Synthetic oligonucleotide probe.
tcaggtcactgtgacctgactgctcgtccctaaaagatcg

SEQ ID NO: 132 - DNA, 40 bp, Artificial sequence
  Synthetic oligonucleotide probe.
cgatcggggcggggcgagcagtcacttcacagtctcctga

SEQ ID NO: 133 - DNA, 40 bp, Artificial sequence
  Synthetic oligonucleotide probe.
tcaggagactgtgaagtgactgctcgccccgccccgatcg

SEQ ID NO: 134 - DNA, 40 bp, Artificial sequence
  Synthetic oligonucleotide probe.
cgatcttttagggacgagcagtcacttcacagtctcctga

SEQ ID NO: 135 - DNA, 40 bp, Artificial sequence
  Synthetic oligonucleotide probe.
tcaggagactgtgaagtgactgctcgtccctaaaagatcg

SEQ ID NO: 136 - DNA, 25 bp, Artificial sequence
  Synthetic oligonucleotide indexing sequence.
ttgtatagtttgagggatgctatgt

SEQ ID NO: 137 - DNA, 25 bp, Artificial sequence
  Synthetic oligonucleotide indexing sequence.
ttttttgactagaccattcaaagct

SEQ ID NO: 138 - DNA, 25 bp, Artificial sequence
  Synthetic oligonucleotide indexing sequence.
gttatcccaacttcgaatctcattt

SEQ ID NO: 139 - DNA, 25 bp, Artificial sequence
  Synthetic oligonucleotide indexing sequence.
atgccttaggagaattgttttgttt

SEQ ID NO: 140 - DNA, 25 bp, Artificial sequence
  Synthetic oligonucleotide indexing sequence.
agccaaatcttatcctgaatgtaga

SEQ ID NO: 141 - DNA, 25 bp, Artificial sequence
  Synthetic oligonucleotide indexing sequence.
ataattgtgtagccccttttctttg

SEQ ID NO: 142 - DNA, 25 bp, Artificial sequence
  Synthetic oligonucleotide indexing sequence.
atgattcaaaaccatttcttcaggt

SEQ ID NO: 143 - DNA, 25 bp, Artificial sequence
  Synthetic oligonucleotide indexing sequence.
ttaaacattgtgtgttaacacctgt

SEQ ID NO: 144 - DNA, 25 bp, Artificial sequence
  Synthetic oligonucleotide indexing sequence.
ggttcatagatggtcagttttgtac

SEQ ID NO: 145 - DNA, 25 bp, Artificial sequence
  Synthetic oligonucleotide indexing sequence.
agtgttcccaatctgaaattcaaaa

SEQ ID NO: 146 - DNA, 25 bp, Artificial sequence
  Synthetic oligonucleotide indexing sequence.
gtcctgttattctgactacagttct

SEQ ID NO: 147 - DNA, 25 bp, Artificial sequence
  Synthetic oligonucleotide indexing sequence.
ctggagttacagttttcaatctgtc

SEQ ID NO: 148 - DNA, 25 bp, Artificial sequence
  Synthetic oligonucleotide indexing sequence.
aagctacggtaccagtaattagatg

SEQ ID NO: 149 - DNA, 25 bp, Artificial sequence
  Synthetic oligonucleotide indexing sequence.
ttggacactatcttgatcagaagag

SEQ ID NO: 150 - DNA, 25 bp, Artificial sequence
  Synthetic oligonucleotide indexing sequence.
tccatgcacatttacaatattgagg

SEQ ID NO: 151 - DNA, 25 bp, Artificial sequence
  Synthetic oligonucleotide indexing sequence.
gttttagttccgttctcgttttctt

SEQ ID NO: 152 - DNA, 25 bp, Artificial sequence
  Synthetic oligonucleotide indexing sequence.
gctagaaaaatagggctggatctta

SEQ ID NO: 153 - DNA, 25 bp, Artificial sequence
  Synthetic oligonucleotide indexing sequence.
catattgattggtgaaattggtggt

SEQ ID NO: 154 - DNA, 25 bp, Artificial sequence
  Synthetic oligonucleotide indexing sequence.
aagttgtttgaggcaaattaactgt

SEQ ID NO: 155 - DNA, 25 bp, Artificial sequence
  Synthetic oligonucleotide indexing sequence.
tctattgaattcggaactgtccttt

SEQ ID NO: 156 - DNA, 25 bp, Artificial sequence
  Synthetic oligonucleotide indexing sequence.
aaagcctcttttcgaataaagcaaa

SEQ ID NO: 157 - DNA, 25 bp, Artificial sequence
  Synthetic oligonucleotide indexing sequence.
aattgttttgtttcacaaaagctgg

SEQ ID NO: 158 - DNA, 25 bp, Artificial sequence
  Synthetic oligonucleotide indexing sequence.
cgatcttttgatatgctgtttcaca

SEQ ID NO: 159 - DNA, 25 bp, Artificial sequence
  Synthetic oligonucleotide indexing sequence.
gttggttgtcagtgaacaataactt

SEQ ID NO: 160 - DNA, 25 bp, Artificial sequence
  Synthetic oligonucleotide indexing sequence.
ttatttttgtacatgttcgggtgtg

SEQ ID NO: 161 - DNA, 25 bp, Artificial sequence
  Synthetic oligonucleotide indexing sequence.
aatatattgacattggagccctcaa

SEQ ID NO: 162 - DNA, 25 bp, Artificial sequence
  Synthetic oligonucleotide indexing sequence.
ataagaagctggcgatcttttgata

SEQ ID NO: 163 - DNA, 25 bp, Artificial sequence
  Synthetic oligonucleotide indexing sequence.
gcttaggtccttttgtagtccataa

SEQ ID NO: 164 - DNA, 25 bp, Artificial sequence
  Synthetic oligonucleotide indexing sequence.
ccttctcaatcccattatgggtaat

SEQ ID NO: 165 - DNA, 25 bp, Artificial sequence
  Synthetic oligonucleotide indexing sequence.
gtgcattaagtcaacaaatccctag

SEQ ID NO: 166 - DNA, 25 bp, Artificial sequence
  Synthetic oligonucleotide indexing sequence.
tccacttctggtataattgtgtagc

SEQ ID NO: 167 - DNA, 25 bp, Artificial sequence
  Synthetic oligonucleotide indexing sequence.
tttttcccccatgtatacctttcat

SEQ ID NO: 168 - DNA, 25 bp, Artificial sequence
  Synthetic oligonucleotide indexing sequence.
ctactttttaagcgaggaagtctga

SEQ ID NO: 169 - DNA, 25 bp, Artificial sequence
  Synthetic oligonucleotide indexing sequence.
cctcttacaattccattagctctgt

SEQ ID NO: 170 - DNA, 25 bp, Artificial sequence
  Synthetic oligonucleotide indexing sequence.
tgtgttataagctaggagaatccct

SEQ ID NO: 171 - DNA, 25 bp, Artificial sequence
  Synthetic oligonucleotide indexing sequence.
tttttcctaattgggggtttctctt

SEQ ID NO: 172 - DNA, 25 bp, Artificial sequence
  Synthetic oligonucleotide indexing sequence.
taacctcaaggaaaccataaagctt

SEQ ID NO: 173 - DNA, 25 bp, Artificial sequence
  Synthetic oligonucleotide indexing sequence.
ttgtagtccataagcatggtgattt

SEQ ID NO: 174 - DNA, 25 bp, Artificial sequence
  Synthetic oligonucleotide indexing sequence.
acattttcccaagcacatatcctat

SEQ ID NO: 175 - DNA, 25 bp, Artificial sequence
  Synthetic oligonucleotide indexing sequence.
aacgcttcaactcagtctagatttt

SEQ ID NO: 176 - DNA, 25 bp, Artificial sequence
  Synthetic oligonucleotide indexing sequence.
gtgccaaatgtaggagtgaataaga

SEQ ID NO: 177 - DNA, 25 bp, Artificial sequence
  Synthetic oligonucleotide indexing sequence.
gtgtactataaggctagtacctgct

SEQ ID NO: 178 - DNA, 25 bp, Artificial sequence
  Synthetic oligonucleotide indexing sequence.
aagaaacaagcgacaaaagcaataa

SEQ ID NO: 179 - DNA, 25 bp, Artificial sequence
  Synthetic oligonucleotide indexing sequence.
agcagtttacacaggactgttttat

SEQ ID NO: 180 - DNA, 25 bp, Artificial sequence
  Synthetic oligonucleotide indexing sequence.
gtacgccagttctcagaaataaaga

SEQ ID NO: 181 - DNA, 25 bp, Artificial sequence
  Synthetic oligonucleotide indexing sequence.
aatccttcagctaaagtaacagagc

SEQ ID NO: 182 - DNA, 25 bp, Artificial sequence
  Synthetic oligonucleotide indexing sequence.
ctgaggtctagggacaataagtaca

SEQ ID NO: 183 - DNA, 25 bp, Artificial sequence
  Synthetic oligonucleotide indexing sequence.
ggaaacatcagtgaataaaacacgg

SEQ ID NO: 184 - DNA, 25 bp, Artificial sequence
  Synthetic oligonucleotide indexing sequence.
gttgtagaaatctgagtaaccaccc

SEQ ID NO: 185 - DNA, 25 bp, Artificial sequence
  Synthetic oligonucleotide indexing sequence.
tttcaataacagatggtgctgctaa

SEQ ID NO: 186 - DNA, 25 bp, Artificial sequence
  Synthetic oligonucleotide indexing sequence.
ctggatccaccaagacttgttttat

SEQ ID NO: 187 - DNA, 25 bp, Artificial sequence
  Synthetic oligonucleotide indexing sequence.
cagcatgttacaaatgactgctttt

SEQ ID NO: 188 - DNA, 25 bp, Artificial sequence
  Synthetic oligonucleotide indexing sequence.
ccagccttagaaaatccatgtactc

SEQ ID NO: 189 - DNA, 25 bp, Artificial sequence
  Synthetic oligonucleotide indexing sequence.
ggaatggatcacgtagacatgtaac

SEQ ID NO: 190 - DNA, 25 bp, Artificial sequence
  Synthetic oligonucleotide indexing sequence.
agaaacaagcgacaaaagcaataac

SEQ ID NO: 191 - DNA, 25 bp, Artificial sequence
  Synthetic oligonucleotide indexing sequence.
gaaacaagcgacaaaagcaataact

SEQ ID NO: 192 - DNA, 25 bp, Artificial sequence
  Synthetic oligonucleotide indexing sequence.
atgagcttgtatacttccaaacagc

SEQ ID NO: 193 - DNA, 25 bp, Artificial sequence
  Synthetic oligonucleotide indexing sequence.
gacttcattagcacacagattcact

SEQ ID NO: 194 - DNA, 25 bp, Artificial sequence
  Synthetic oligonucleotide indexing sequence.
tgaaattggtggtaatgcagaagag

SEQ ID NO: 195 - DNA, 25 bp, Artificial sequence
  Synthetic oligonucleotide indexing sequence.
ctctggaatgtttatggtggttcag

SEQ ID NO: 196 - DNA, 25 bp, Artificial sequence
  Synthetic oligonucleotide indexing sequence.
aagaaaagtccactgtcatggattg

SEQ ID NO: 197 - DNA, 25 bp, Artificial sequence
  Synthetic oligonucleotide indexing sequence.
tttctgtatcatgtctccccatcat

SEQ ID NO: 198 - DNA, 25 bp, Artificial sequence
  Synthetic oligonucleotide indexing sequence.
gctgtgtaaatgtgcacaataaacc

SEQ ID NO: 199 - DNA, 25 bp, Artificial sequence
  Synthetic oligonucleotide indexing sequence.
gtcagttttgtacacagactgaaca

SEQ ID NO: 200 - DNA, 25 bp, Artificial sequence
  Synthetic oligonucleotide indexing sequence.
ttaagcttcagttgcttgtcttctg

SEQ ID NO: 201 - DNA, 25 bp, Artificial sequence
  Synthetic oligonucleotide indexing sequence.
atatccacaaggtcgtaaatgcatg

SEQ ID NO: 202 - DNA, 25 bp, Artificial sequence
  Synthetic oligonucleotide indexing sequence.
catcctctgtgttcaaaatcaacct

SEQ ID NO: 203 - DNA, 25 bp, Artificial sequence
  Synthetic oligonucleotide indexing sequence.
aaccttgttacagcatcatcacatt

SEQ ID NO: 204 - DNA, 25 bp, Artificial sequence
  Synthetic oligonucleotide indexing sequence.
gccttattggagtcatgttctcaag

SEQ ID NO: 205 - DNA, 25 bp, Artificial sequence
  Synthetic oligonucleotide indexing sequence.
cttcaaggtttggaaactgcaaatg

SEQ ID NO: 206 - DNA, 25 bp, Artificial sequence
  Synthetic oligonucleotide indexing sequence.
ggtactttctgttatgggcttttgg

SEQ ID NO: 207 - DNA, 25 bp, Artificial sequence
  Synthetic oligonucleotide indexing sequence.
gagtcgcatttgtagacatgcttag

SEQ ID NO: 208 - DNA, 25 bp, Artificial sequence
  Synthetic oligonucleotide indexing sequence.
gcagtcaggtacatagttaggtgaa

SEQ ID NO: 209 - DNA, 25 bp, Artificial sequence
  Synthetic oligonucleotide indexing sequence.
ctgttagatctgcctctcaggaaaa

SEQ ID NO: 210 - DNA, 25 bp, Artificial sequence
  Synthetic oligonucleotide indexing sequence.
atcttcattaagccctaccgcaata

SEQ ID NO: 211 - DNA, 25 bp, Artificial sequence
  Synthetic oligonucleotide indexing sequence.
gcctcgtcagttttttaacaggatt

SEQ ID NO: 212 - DNA, 25 bp, Artificial sequence
  Synthetic oligonucleotide indexing sequence.
agagtaaacagataacaggtggtgg

SEQ ID NO: 213 - DNA, 25 bp, Artificial sequence
  Synthetic oligonucleotide indexing sequence.
cacagactgaacaatacagcacttt

SEQ ID NO: 214 - DNA, 25 bp, Artificial sequence
  Synthetic oligonucleotide indexing sequence.
agccttattggagtcatgttctcaa

SEQ ID NO: 215 - DNA, 25 bp, Artificial sequence
  Synthetic oligonucleotide indexing sequence.
tgtcttgtgcattacttgtgtttcc

SEQ ID NO: 216 - DNA, 25 bp, Artificial sequence
  Synthetic oligonucleotide indexing sequence.
tgcttgtcttctggtactttctgtt

SEQ ID NO: 217 - DNA, 25 bp, Artificial sequence
  Synthetic oligonucleotide indexing sequence.
aacctaatgatcatctgaatcccgg

SEQ ID NO: 218 - DNA, 25 bp, Artificial sequence
  Synthetic oligonucleotide indexing sequence.
ttatttgggcaactccgaatgtttc

SEQ ID NO: 219 - DNA, 25 bp, Artificial sequence
  Synthetic oligonucleotide indexing sequence.
tgccaaaaatgagtgtagcattgtt

SEQ ID NO: 220 - DNA, 25 bp, Artificial sequence
  Synthetic oligonucleotide indexing sequence.
tagacatgcttagaaactgtgggtc

SEQ ID NO: 221 - DNA, 25 bp, Artificial sequence
  Synthetic oligonucleotide indexing sequence.
cactgactgtacatagtgtggtgaa

SEQ ID NO: 222 - DNA, 25 bp, Artificial sequence
  Synthetic oligonucleotide indexing sequence.
tgagccttattggagtcatgttctc

SEQ ID NO: 223 - DNA, 25 bp, Artificial sequence
  Synthetic oligonucleotide indexing sequence.
tttcacacatataattgccgccttc

SEQ ID NO: 224 - DNA, 25 bp, Artificial sequence
  Synthetic oligonucleotide indexing sequence.
agattcacaatagacaggccaagaa

SEQ ID NO: 225 - DNA, 25 bp, Artificial sequence
  Synthetic oligonucleotide indexing sequence.
atttcatggctctcaccctagtttt

SEQ ID NO: 226 - DNA, 25 bp, Artificial sequence
  Synthetic oligonucleotide indexing sequence.
ctgcatcagttgtaaaggggaattg

SEQ ID NO: 227 - DNA, 25 bp, Artificial sequence
  Synthetic oligonucleotide indexing sequence.
acacacgcagcgttttgataaatta

SEQ ID NO: 228 - DNA, 25 bp, Artificial sequence
  Synthetic oligonucleotide indexing sequence.
gagccttattggagtcatgttctca

SEQ ID NO: 229 - DNA, 25 bp, Artificial sequence
  Synthetic oligonucleotide indexing sequence.
tcactgaggtgtgaattgtacgtac

SEQ ID NO: 230 - DNA, 25 bp, Artificial sequence
  Synthetic oligonucleotide indexing sequence.
taaaagtaatcccagatgacaacca

SEQ ID NO: 231 - DNA, 25 bp, Artificial sequence
  Synthetic oligonucleotide indexing probe.
acatagcatccctcaaactatacaa

SEQ ID NO: 232 - DNA, 25 bp, Artificial sequence
  Synthetic oligonucleotide indexing probe.
agctttgaatggtctagtcaaaaaa

SEQ ID NO: 233 - DNA, 25 bp, Artificial sequence
  Synthetic oligonucleotide indexing probe.
aaatgagattcgaagttgggataac

SEQ ID NO: 234 - DNA, 25 bp, Artificial sequence
  Synthetic oligonucleotide indexing probe.
aaacaaaacaattctcctaaggcat

SEQ ID NO: 235 - DNA, 25 bp, Artificial sequence
  Synthetic oligonucleotide indexing probe.
tctacattcaggataagatttggct

SEQ ID NO: 236 - DNA, 25 bp, Artificial sequence
  Synthetic oligonucleotide indexing probe.
caaagaaaaggggctacacaattat

SEQ ID NO: 237 - DNA, 25 bp, Artificial sequence
  Synthetic oligonucleotide indexing probe.
acctgaagaaatggttttgaatcat

SEQ ID NO: 238 - DNA, 25 bp, Artificial sequence
  Synthetic oligonucleotide indexing probe.
acaggtgttaacacacaatgtttaa

SEQ ID NO: 239 - DNA, 25 bp, Artificial sequence
  Synthetic oligonucleotide indexing probe.
gtacaaaactgaccatctatgaacc

SEQ ID NO: 240 - DNA, 25 bp, Artificial sequence
  Synthetic oligonucleotide indexing probe.
ttttgaatttcagattgggaacact

SEQ ID NO: 241 - DNA, 25 bp, Artificial sequence
  Synthetic oligonucleotide indexing probe.
agaactgtagtcagaataacaggac

SEQ ID NO: 242 - DNA, 25 bp, Artificial sequence
  Synthetic oligonucleotide indexing probe.
gacagattgaaaactgtaactccag

SEQ ID NO: 243 - DNA, 25 bp, Artificial sequence
  Synthetic oligonucleotide indexing probe.
catctaattactggtaccgtagctt

SEQ ID NO: 244 - DNA, 25 bp, Artificial sequence
  Synthetic oligonucleotide indexing probe.
ctcttctgatcaagatagtgtccaa

SEQ ID NO: 245 - DNA, 25 bp, Artificial sequence
  Synthetic oligonucleotide indexing probe.
cctcaatattgtaaatgtgcatgga

SEQ ID NO: 246 - DNA, 25 bp, Artificial sequence
  Synthetic oligonucleotide indexing probe.
aagaaaacgagaacggaactaaaac

SEQ ID NO: 247 - DNA, 25 bp, Artificial sequence
  Synthetic oligonucleotide indexing probe.
taagatccagccctatttttctagc

SEQ ID NO: 248 - DNA, 25 bp, Artificial sequence
  Synthetic oligonucleotide indexing probe.
accaccaatttcaccaatcaatatg

SEQ ID NO: 249 - DNA, 25 bp, Artificial sequence
  Synthetic oligonucleotide indexing probe.
acagttaatttgcctcaaacaactt

SEQ ID NO: 250 - DNA, 25 bp, Artificial sequence
  Synthetic oligonucleotide indexing probe.
aaaggacagttccgaattcaataga

SEQ ID NO: 251 - DNA, 25 bp, Artificial sequence
  Synthetic oligonucleotide indexing probe.
tttgctttattcgaaaagaggcttt

SEQ ID NO: 252 - DNA, 25 bp, Artificial sequence
  Synthetic oligonucleotide indexing probe.
ccagcttttgtgaaacaaaacaatt

SEQ ID NO: 253 - DNA, 25 bp, Artificial sequence
  Synthetic oligonucleotide indexing probe.
tgtgaaacagcatatcaaaagatcg

SEQ ID NO: 254 - DNA, 25 bp, Artificial sequence
  Synthetic oligonucleotide indexing probe.
aagttattgttcactgacaaccaac

SEQ ID NO: 255 - DNA, 25 bp, Artificial sequence
  Synthetic oligonucleotide indexing probe.
cacacccgaacatgtacaaaaataa

SEQ ID NO: 256 - DNA, 25 bp, Artificial sequence
  Synthetic oligonucleotide indexing probe.
ttgagggctccaatgtcaatatatt

SEQ ID NO: 257 - DNA, 25 bp, Artificial sequence
  Synthetic oligonucleotide indexing probe.
tatcaaaagatcgccagcttcttat

SEQ ID NO: 258 - DNA, 25 bp, Artificial sequence
  Synthetic oligonucleotide indexing probe.
ttatggactacaaaaggacctaagc

SEQ ID NO: 259 - DNA, 25 bp, Artificial sequence
  Synthetic oligonucleotide indexing probe.
attacccataatgggattgagaagg

SEQ ID NO: 260 - DNA, 25 bp, Artificial sequence
  Synthetic oligonucleotide indexing probe.
ctagggatttgttgacttaatgcac

SEQ ID NO: 261 - DNA, 25 bp, Artificial sequence
  Synthetic oligonucleotide indexing probe.
gctacacaattataccagaagtgga

SEQ ID NO: 262 - DNA, 25 bp, Artificial sequence
  Synthetic oligonucleotide indexing probe.
atgaaaggtatacatgggggaaaaa

SEQ ID NO: 263 - DNA, 25 bp, Artificial sequence
  Synthetic oligonucleotide indexing probe.
tcagacttcctcgcttaaaaagtag

SEQ ID NO: 264 - DNA, 25 bp, Artificial sequence
  Synthetic oligonucleotide indexing probe.
acagagctaatggaattgtaagagg

SEQ ID NO: 265 - DNA, 25 bp, Artificial sequence
  Synthetic oligonucleotide indexing probe.
agggattctcctagcttataacaca

SEQ ID NO: 266 - DNA, 25 bp, Artificial sequence
  Synthetic oligonucleotide indexing probe.
aagagaaacccccaattaggaaaaa

SEQ ID NO: 267 - DNA, 25 bp, Artificial sequence
  Synthetic oligonucleotide indexing probe.
aagctttatggtttccttgaggtta

SEQ ID NO: 268 - DNA, 25 bp, Artificial sequence
  Synthetic oligonucleotide indexing probe.
aaatcaccatgcttatggactacaa

SEQ ID NO: 269 - DNA, 25 bp, Artificial sequence
  Synthetic oligonucleotide indexing probe.
ataggatatgtgcttgggaaaatgt

SEQ ID NO: 270 - DNA, 25 bp, Artificial sequence
  Synthetic oligonucleotide indexing probe.
aaaatctagactgagttgaagcgtt

SEQ ID NO: 271 - DNA, 25 bp, Artificial sequence
  Synthetic oligonucleotide indexing probe.
tcttattcactcctacatttggcac

SEQ ID NO: 272 - DNA, 25 bp, Artificial sequence
  Synthetic oligonucleotide indexing probe.
agcaggtactagccttatagtacac

SEQ ID NO: 273 - DNA, 25 bp, Artificial sequence
  Synthetic oligonucleotide indexing probe.
ttattgcttttgtcgcttgtttctt

SEQ ID NO: 274 - DNA, 25 bp, Artificial sequence
  Synthetic oligonucleotide indexing probe.
ataaaacagtcctgtgtaaactgct

SEQ ID NO: 275 - DNA, 25 bp, Artificial sequence
  Synthetic oligonucleotide indexing probe.
tctttatttctgagaactggcgtac

SEQ ID NO: 276 - DNA, 25 bp, Artificial sequence
  Synthetic oligonucleotide indexing probe.
gctctgttactttagctgaaggatt

SEQ ID NO: 277 - DNA, 25 bp, Artificial sequence
  Synthetic oligonucleotide indexing probe.
tgtacttattgtccctagacctcag

SEQ ID NO: 278 - DNA, 25 bp, Artificial sequence
  Synthetic oligonucleotide indexing probe.
ccgtgttttattcactgatgtttcc

SEQ ID NO: 279 - DNA, 25 bp, Artificial sequence
  Synthetic oligonucleotide indexing probe.
gggtggttactcagatttctacaac

SEQ ID NO: 280 - DNA, 25 bp, Artificial sequence
  Synthetic oligonucleotide indexing probe.
ttagcagcaccatctgttattgaaa

SEQ ID NO: 281 - DNA, 25 bp, Artificial sequence
  Synthetic oligonucleotide indexing probe.
ataaaacaagtcttggtggatccag

SEQ ID NO: 282 - DNA, 25 bp, Artificial sequence
  Synthetic oligonucleotide indexing probe.
aaaagcagtcatttgtaacatgctg

SEQ ID NO: 283 - DNA, 25 bp, Artificial sequence
  Synthetic oligonucleotide indexing probe.
gagtacatggattttctaaggctgg

SEQ ID NO: 284 - DNA, 25 bp, Artificial sequence
  Synthetic oligonucleotide indexing probe.
gttacatgtctacgtgatccattcc

SEQ ID NO: 285 - DNA, 25 bp, Artificial sequence
  Synthetic oligonucleotide indexing probe.
gttattgcttttgtcgcttgtttct

SEQ ID NO: 286 - DNA, 25 bp, Artificial sequence
  Synthetic oligonucleotide indexing probe.
agttattgcttttgtcgcttgtttc

SEQ ID NO: 287 - DNA, 25 bp, Artificial sequence
  Synthetic oligonucleotide indexing probe.
gctgtttggaagtatacaagctcat

SEQ ID NO: 288 - DNA, 25 bp, Artificial sequence
  Synthetic oligonucleotide indexing probe.
agtgaatctgtgtgctaatgaagtc

SEQ ID NO: 289 - DNA, 25 bp, Artificial sequence
  Synthetic oligonucleotide indexing probe.
ctcttctgcattaccaccaatttca

SEQ ID NO: 290 - DNA, 25 bp, Artificial sequence
  Synthetic oligonucleotide indexing probe.
ctgaaccaccataaacattccagag

SEQ ID NO: 291 - DNA, 25 bp, Artificial sequence
  Synthetic oligonucleotide indexing probe.
caatccatgacagtggacttttctt

SEQ ID NO: 292 - DNA, 25 bp, Artificial sequence
  Synthetic oligonucleotide indexing probe.
atgatggggagacatgatacagaaa

SEQ ID NO: 293 - DNA, 25 bp, Artificial sequence
  Synthetic oligonucleotide indexing probe.
ggtttattgtgcacatttacacagc

SEQ ID NO: 294 - DNA, 25 bp, Artificial sequence
  Synthetic oligonucleotide indexing probe.
tgttcagtctgtgtacaaaactgac

SEQ ID NO: 295 - DNA, 25 bp, Artificial sequence
  Synthetic oligonucleotide indexing probe.
cagaagacaagcaactgaagcttaa

SEQ ID NO: 296 - DNA, 25 bp, Artificial sequence
  Synthetic oligonucleotide indexing probe.
catgcatttacgaccttgtggatat

SEQ ID NO: 297 - DNA, 25 bp, Artificial sequence
  Synthetic oligonucleotide indexing probe.
aggttgattttgaacacagaggatg

SEQ ID NO: 298 - DNA, 25 bp, Artificial sequence
  Synthetic oligonucleotide indexing probe.
aatgtgatgatgctgtaacaaggtt

SEQ ID NO: 299 - DNA, 25 bp, Artificial sequence
  Synthetic oligonucleotide indexing probe.
cttgagaacatgactccaataaggc

SEQ ID NO: 300 - DNA, 25 bp, Artificial sequence
  Synthetic oligonucleotide indexing probe.
catttgcagtttccaaaccttgaag

SEQ ID NO: 301 - DNA, 25 bp, Artificial sequence
  Synthetic oligonucleotide indexing probe.
ccaaaagcccataacagaaagtacc

SEQ ID NO: 302 - DNA, 25 bp, Artificial sequence
  Synthetic oligonucleotide indexing probe.
ctaagcatgtctacaaatgcgactc

SEQ ID NO: 303 - DNA, 25 bp, Artificial sequence
  Synthetic oligonucleotide indexing probe.
ttcacctaactatgtacctgactgc

SEQ ID NO: 304 - DNA, 25 bp, Artificial sequence
  Synthetic oligonucleotide indexing probe.
ttttcctgagaggcagatctaacag

SEQ ID NO: 305 - DNA, 25 bp, Artificial sequence
  Synthetic oligonucleotide indexing probe.
tattgcggtagggcttaatgaagat

SEQ ID NO: 306 - DNA, 25 bp, Artificial sequence
  Synthetic oligonucleotide indexing probe.
aatcctgttaaaaaactgacgaggc

SEQ ID NO: 307 - DNA, 25 bp, Artificial sequence
  Synthetic oligonucleotide indexing probe.
ccaccacctgttatctgtttactct

SEQ ID NO: 308 - DNA, 25 bp, Artificial sequence
  Synthetic oligonucleotide indexing probe.
aaagtgctgtattgttcagtctgtg

SEQ ID NO: 309 - DNA, 25 bp, Artificial sequence
  Synthetic oligonucleotide indexing probe.
ttgagaacatgactccaataaggct

SEQ ID NO: 310 - DNA, 25 bp, Artificial sequence
  Synthetic oligonucleotide indexing probe.
ggaaacacaagtaatgcacaagaca

SEQ ID NO: 311 - DNA, 25 bp, Artificial sequence
  Synthetic oligonucleotide indexing probe.
aacagaaagtaccagaagacaagca

SEQ ID NO: 312 - DNA, 25 bp, Artificial sequence
  Synthetic oligonucleotide indexing probe.
ccgggattcagatgatcattaggtt

SEQ ID NO: 313 - DNA, 25 bp, Artificial sequence
  Synthetic oligonucleotide indexing probe.
gaaacattcggagttgcccaaataa

SEQ ID NO: 314 - DNA, 25 bp, Artificial sequence
  Synthetic oligonucleotide indexing probe.
aacaatgctacactcatttttggca

SEQ ID NO: 315 - DNA, 25 bp, Artificial sequence
  Synthetic oligonucleotide indexing probe.
gacccacagtttctaagcatgtcta

SEQ ID NO: 316 - DNA, 25 bp, Artificial sequence
  Synthetic oligonucleotide indexing probe.
ttcaccacactatgtacagtcagtg

SEQ ID NO: 317 - DNA, 25 bp, Artificial sequence
  Synthetic oligonucleotide indexing probe.
gagaacatgactccaataaggctca

SEQ ID NO: 318 - DNA, 25 bp, Artificial sequence
  Synthetic oligonucleotide indexing probe.
gaaggcggcaattatatgtgtgaaa

SEQ ID NO: 319 - DNA, 25 bp, Artificial sequence
  Synthetic oligonucleotide indexing probe.
ttcttggcctgtctattgtgaatct

SEQ ID NO: 320 - DNA, 25 bp, Artificial sequence
  Synthetic oligonucleotide indexing probe.
aaaactagggtgagagccatgaaat

SEQ ID NO: 321 - DNA, 25 bp, Artificial sequence
  Synthetic oligonucleotide indexing probe.
caattcccctttacaactgatgcag

SEQ ID NO: 322 - DNA, 25 bp, Artificial sequence
  Synthetic oligonucleotide indexing probe.
taatttatcaaaacgctgcgtgtgt

SEQ ID NO: 323 - DNA, 25 bp, Artificial sequence
  Synthetic oligonucleotide indexing probe.
tgagaacatgactccaataaggctc

SEQ ID NO: 324 - DNA, 25 bp, Artificial sequence
  Synthetic oligonucleotide indexing probe.
gtacgtacaattcacacctcagtga

SEQ ID NO: 325 - DNA, 25 bp, Artificial sequence
  Synthetic oligonucleotide indexing probe.
tggttgtcatctgggattactttta

SEQ ID NO: 326 - DNA, 55 bp, Artificial sequence
  Synthetic oligonucleotide probe.
tcctagcttcagaggggactttccgagaggacctgaagaaatggttttgaatcat

SEQ ID NO: 327 - DNA, 30 bp, Artificial sequence
  Synthetic oligonucleotide probe.
cctctcggaaagtcccctctgaagctagga

SEQ ID NO: 328 - DNA, 55 bp, Artificial sequence
  Synthetic oligonucleotide probe.
agcttattcgatcggggcggggcgagcgaagttatcccaacttcgaatctcattt

SEQ ID NO: 329 - DNA, 30 bp, Artificial sequence
  Synthetic oligonucleotide probe.
ttcgctcgccccgccccgatcgaataagct

SEQ ID NO: 330 - DNA, 55 bp, Artificial sequence
  Synthetic oligonucleotide probe.
cctgccaggtcgcgctgccctccttctaccatgccttaggagaattgttttgttt

SEQ ID NO: 331 - DNA, 30 bp, Artificial sequence; identical to SEQ ID NO: 123
  Synthetic oligonucleotide probe.

SEQ ID NO: 332 - DNA, 25 bp, Artificial sequence
  Synthetic oligonucleotide probe.
tggttgtcatctgggattactttta

SEQ ID NO: 333 - DNA, 28 bp, Artificial sequence
  Synthetic oligonucleotide probe.
gggttttttttttcccgttttttttggg

SEQ ID NO: 334 - DNA, 25 bp, Artificial sequence
  Synthetic oligonucleotide probe.
acatagcatccctcaaactatacaa

SEQ ID NO: 335 - DNA, 25 bp, Artificial sequence
  Synthetic oligonucleotide probe.
agctttgaatggtctagtcaaaaaa

SEQ ID NO: 336 - DNA, 25 bp, Artificial sequence
  Synthetic oligonucleotide probe.
tctacattcaggataagatttggct

SEQ ID NO: 337 - DNA, 25 bp, Artificial sequence
  Synthetic oligonucleotide probe.
aaatgagattcgaagttgggataac

SEQ ID NO: 338 - DNA, 25 bp, Artificial sequence
  Synthetic oligonucleotide probe.
aaacaaaacaattctcctaaggcat

SEQ ID NO: 339 - DNA, 25 bp, Artificial sequence
  Synthetic oligonucleotide probe.
caaagaaaaggggctacacaattat

SEQ ID NO: 340 - DNA, 25 bp, Artificial sequence
  Synthetic oligonucleotide probe.
atgattcaaaaccatttcttcaggt

SEQ ID NO: 341 - DNA, 25 bp, Artificial sequence
  Synthetic oligonucleotide probe.
ttaaacattgtgtgttaacacctgt

SEQ ID NO: 342 - DNA, 25 bp, Artificial sequence
  Synthetic oligonucleotide probe.
ggttcatagatggtcagttttgtac

SEQ ID NO: 343 - DNA, 25 bp, Artificial sequence
  Synthetic oligonucleotide probe.
agtgttcccaatctgaaattcaaaa

SEQ ID NO: 344 - DNA, 25 bp, Artificial sequence
  Synthetic oligonucleotide probe.
gtcctgttattctgactacagttct

SEQ ID NO: 345 - DNA, 25 bp, Artificial sequence
  Synthetic oligonucleotide probe.
ctggagttacagttttcaatctgtc

SEQ ID NO: 346 - DNA, 25 bp, Artificial sequence
  Synthetic oligonucleotide probe.
aagctacggtaccagtaattagatg

SEQ ID NO: 347 - DNA, 25 bp, Artificial sequence
  Synthetic oligonucleotide probe.
ttggacactatcttgatcagaagag

SEQ ID NO: 348 - DNA, 25 bp, Artificial sequence
  Synthetic oligonucleotide probe.
tccatgcacatttacaatattgagg

SEQ ID NO: 349 - DNA, 25 bp, Artificial sequence
  Synthetic oligonucleotide probe.
gttttagttccgttctcgttttctt

SEQ ID NO: 350 - DNA, 25 bp, Artificial sequence
  Synthetic oligonucleotide probe.
gctagaaaaatagggctggatctta

SEQ ID NO: 351 - DNA, 25 bp, Artificial sequence
  Synthetic oligonucleotide probe.
catattgattggtgaaattggtggt

SEQ ID NO: 352 - DNA, 25 bp, Artificial sequence
  Synthetic oligonucleotide probe.
aagttgtttgaggcaaattaactgt

SEQ ID NO: 353 - DNA, 25 bp, Artificial sequence
  Synthetic oligonucleotide probe.
tctattgaattcggaactgtccttt

SEQ ID NO: 354 - DNA, 25 bp, Artificial sequence
  Synthetic oligonucleotide probe.
aaagcctcttttcgaataaagcaaa

SEQ ID NO: 355 - DNA, 25 bp, Artificial sequence
  Synthetic oligonucleotide probe.
aattgttttgtttcacaaaagctgg

SEQ ID NO: 356 - DNA, 25 bp, Artificial sequence
  Synthetic oligonucleotide probe.
taaaagtaatcccagatgacaacca

SEQ ID NO: 357 - DNA, 27 bp, Artificial sequence
  Synthetic oligonucleotide probe.
cccaaaaaaaacgggaaaaaaaaaacc